(19) United States
(12) Patent Application Publication
(10) Pub. No.: US 2023/0287272 A1
(43) Pub. Date: Sep. 14, 2023

(54) LIQUID CRYSTAL COMPOSITION AND LIQUID CRYSTAL DEVICE

(71) Applicant: DIC Corporation, Tokyo (JP)

(72) Inventors: Yuichi Inoue, Saitama (JP); Kenta Tojo, Saitama (JP); Naomi Hatano, Saitama (JP); Kento Kawakita, Saitama (JP)

(73) Assignee: DIC Corporation, Tokyo (JP)

(21) Appl. No.: 18/177,762

(22) Filed: Mar. 3, 2023

(30) Foreign Application Priority Data
Mar. 10, 2022 (JP) 2022-037024

(51) Int. Cl. C09K 19/60; G02F 1/00; G02F 1/1343

(52) U.S. Cl. CPC C09K 19/601; G02F 1/0045; G02F 1/1343

(57) ABSTRACT

The disclosure provides a liquid crystal device including a liquid crystal composition containing a dichroic dye (dye-containing liquid crystal composition) that is in a light transmissive state when no voltage is applied to the transparent electrode and in a light scattering state when voltage is applied. The liquid crystal composition exhibits a negative dielectric constant anisotropy. The haze value of the liquid crystal device is 10% or less when no voltage is applied at 25° C., and the haze value is 50% or more when a rectangular wave voltage (AC 50 V, 60 Hz) is applied. The voltage holding ratio of the dye-containing liquid crystal composition is 60% or less at 25° C. The liquid crystal device provided by the disclosure is used as a component to provide a liquid crystal display apparatus, a light control apparatus, or a light transmitting apparatus with a high contrast.

### CROSS-REFERENCE TO RELATED APPLICATION

This application claims the priority benefit of Japanese Application Serial No. 2022-037024, filed on Mar. 10, 2022. The entirety of the above-mentioned patent application is hereby incorporated by reference herein and made a part of this specification.

### BACKGROUND OF THE INVENTION

### 1. Field of the Invention

The disclosure relates to a dye-containing liquid crystal composition and a liquid crystal display device or a light control device using the dye-containing liquid crystal composition.

### 2. Description of the Related Art

Liquid crystal materials are not only used in various display devices that display text, images, and video, as typified by TVs and smartphones, but also expected to be used as light control devices that control the amount of transmission of light, for example, for windows of electric vehicles and structures such as buildings. Such windows are called light control windows (smart windows), which electrically adjust light transmission to maintain a comfortable environment in vehicles or rooms.

Known light control devices that can be applied to smart windows include dichroic dye-containing liquid crystal (guest-host liquid crystal, hereafter GH liquid crystal) systems, liquid crystal systems with a polymer network in a cell (polymer network liquid crystal, hereafter PN liquid crystal), and systems using electrochromism. Among these, the GH liquid crystal systems are expected to realize low-cost light control devices with high transmittance because light transmission and non-transmission can be switched at high speed and polarizers are not required. On the other hand, the PN liquid crystals are characterized in that a transmissive state and a scattering state can be switched using the refractive index difference between the polymer network and the liquid crystal composition.

A large difference in transmittance between a light transmissive state and a non-transmissive state, that is, a high contrast ratio, is one of the performance requirements for light control devices, but conventional GH liquid crystals and PN liquid crystals are unable to achieve a sufficiently high contrast ratio. In this respect, it is known that the contrast ratio can be improved using a GH-PN liquid crystal in which a dichroic dye is added to a PN liquid crystal. However, the GH-PN liquid crystal requires polymerization of monomers in a liquid crystal composition to form a polymer network after addition of a dichroic dye. Thus, the dichroic dye decomposes during the polymerization reaction, resulting in change in color and insufficient contrast ratio.

The dynamic scattering mode is known as one of liquid crystal display modes. In this method, the disruptive effect of ions moved by the applied voltage forms scattering centers in an electro-optical anisotropic medium, allowing switching between a transmissive state and a scattering state. To achieve this phenomenon, it is necessary to add an ionic dopant and adjust the resistivity to an appropriate value. However, if the liquid crystal composition containing the ionic dopant comes into contact with the substrate surface during injection or dropping of the liquid crystal composition in the fabrication process of liquid crystal display devices, the ionic dopant is adsorbed non-uniformly on the substrate surface due to the ion chromatographic phenomenon, which may cause inconvenience in display uniformity. The related technologies are described, for example, in: The Society for Information Display, 2019 Digest P-166; Japanese Unexamined Patent Application Publication (Translation of PCT Application) No. 2016-507784; Japanese Unexamined Patent Application Publication (Translation of PCT Application) No. 2018-510383; and U.S. Ser. No. 10/823,991B2.

An object of the disclosure is to provide a liquid crystal device that uses a liquid crystal composition containing a dye and having a haze adjustment function to exhibit a high contrast ratio and excellent display uniformity in a device plane, without requiring a polymerization process that may cause dye decomposition during its fabrication. In particular, a liquid crystal device using a liquid crystal composition exhibiting a negative dielectric constant anisotropy is provided, which has a high contrast ratio and excellent display uniformity in a normally white mode that is in a transparent state when voltage is off and in a colored scattering state when voltage is on. In addition, a display apparatus, a light control window, or smart glass having the liquid crystal device as a component is provided.

### SUMMARY

The disclosure has the following aspects.
[1] A liquid crystal device including two transparent substrates, at least one of the transparent substrates having a transparent electrode, and a drive layer containing a liquid crystal composition containing a dichroic dye (dye-containing liquid crystal composition) disposed between the transparent substrates, the liquid crystal device being in a light transmissive state when no voltage is applied to the transparent electrode and being in a light scattering state when voltage is applied, wherein
   the liquid crystal composition exhibits a negative dielectric constant anisotropy,
   a haze value of the liquid crystal device is 10% or less when no voltage is applied at 25° C., and the haze value is 50% or more when a rectangular wave voltage (AC 50 V, 60 Hz) is applied, and
   a voltage holding ratio of the dye-containing liquid crystal composition (the liquid crystal composition is injected into a cell with a cell thickness of 10 μm, 10 V is applied with a pulse width of 60 μs, and a ratio between a measurement voltage measured after a frame time of 16.7 ms and an initial applied voltage is expressed by % as the voltage holding ratio) is 60% or less at 25° C.
[2] The liquid crystal device according to [1], wherein the drive layer does not contain a polymer network.
[3] The liquid crystal device according to [1] or [2], wherein a vertical alignment film is installed on a surface of the transparent substrate in contact with the drive layer.
[4] The liquid crystal device according to any one of [1] to [3], wherein the dichroic dye is a compound represented by general formula (1)

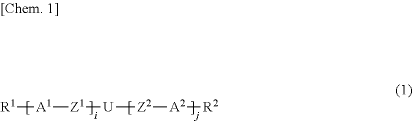

(wherein U is one group selected from groups represented by general formulae (2) to (5)

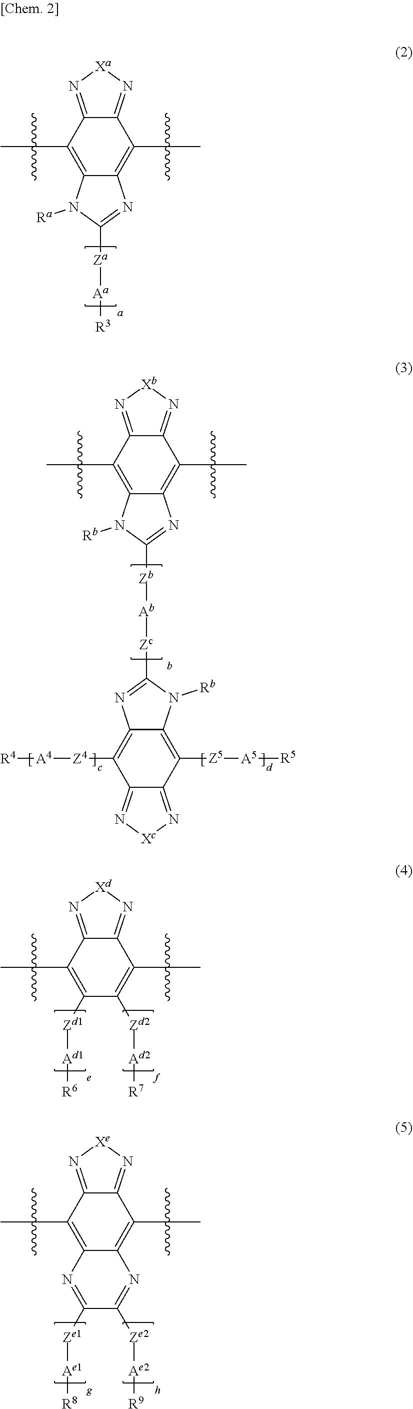

R¹, R², R³, R⁴, R⁵, R⁶, R⁷, R⁸, and R⁹ each independently represent a hydrogen atom, a fluorine atom, a cyano group, an alkyl group having 1 to 20 carbon atoms, or an alkenyl group having 2 to 30 carbon atoms, one —CH₂— or two or more nonadjacent —CH₂—'s present in these groups are optionally substituted with —NR^{N1}—, —O—, —S—, —CO—, —CS—, —COO—, —OCO—, —CO—S—, —S—CO—, —SO—, —SO₂—, —O—CO—O—, —CO—NH—, —NH—CO—, —CH═CH—, —CF═CF—, or —C≡C—, a hydrogen atom present in these groups is optionally substituted with a fluorine atom, wherein R^{N1} represents a hydrogen atom, an alkyl group having 1 to 20 carbon atoms, or an alkenyl group having 2 to 30 carbon atoms, one —CH₂— or two or more nonadjacent —CH₂—'s present in these groups are optionally substituted with —O—, —S—, —COO—, —OCO—, or —CO—, and a hydrogen atom present in these groups is optionally substituted with a fluorine atom,
R^{a}, R^{b}, and R^{c} each independently represent a hydrogen atom, an alkyl group having 1 to 20 carbon atoms, or an alkenyl group having 2 to 30 carbon atoms, one —CH₂— or two or more nonadjacent —CH₂—'s present in these groups are optionally substituted with —NR^{N2}—, —O—, —S—, —CO—, —CS—, —COO—, —OCO—, —CO—S—, —S—CO—, —SO—, —SO₂—, —O—CO—O—, —CO—NH—, —NH—CO—, —CH═CH—, —CF═CF—, or —C≡C—, a hydrogen atom present in these groups is optionally substituted with a fluorine atom, wherein R^{N2} represents a hydrogen atom, an alkyl group having 1 to 20 carbon atoms, or an alkenyl group having 2 to 30 carbon atoms, one —CH₂— or two or more nonadjacent —CH₂—'s present in these groups are optionally substituted with —O—, —S—, —COO—, —OCO—, or —CO—, a hydrogen atom present in these groups is optionally substituted with a fluorine atom,
X^{a}, X^{b}, X^{c}, X^{d}, and X^{e} each independently represent —S— or —O—,
A¹, A², A⁴, A⁵, A^{a}, A^{b}, A^{d1}, A^{d2}, A^{e1} and A^{e2} each independently represent an optionally substituted hydrocarbon ring or heterocyclic ring having 3 to 16 carbon atoms,
Z¹, Z², Z⁴, Z⁵, Z^{a}, Z^{b}, Z^{c}, Z^{d1}, Z^{d2}, Z^{e1}, and Z^{e2} each independently represent —CH₂O—, —OCH₂—, —CF₂O—, —OCF₂—, —COO—, —OCO—, —CH₂CH₂—, —CF₂CF₂—, —CH═CH—, —CF═CF—, —N═CH—, —CH═N—, —N═N—, —C≡C—, or a single bond,
i, j, a, b, c, d, e, f, g, and h each independently represent an integer of 0 to 4, and
pluralities of A¹s, A²s, A⁴s, A⁵s, A^{a}s, A^{b}s, A^{d1}s, A^{d2}s, A^{e1}s, and A^{e2}s, if present, may be the same or different A¹s, A²s, A⁴s, A⁵s, A^{a}s, A^{b}s, A^{d1}s, A^{d2}s, A^{e1}s, and A^{e2}s, pluralities of Z¹s, Z²s, Z⁴s, Z⁵s, Z^{a}s, Z^{b}s, Z^{c}s, Z^{d1}s, Z^{e1}s, and Z^{e2}s, if present, may be the same or different Z¹s, Z²s, Z⁴s, Z⁵s, Z^{a}s, Z^{b}s, Z^{c}s, Z^{d1}s, Z^{d2}s, Z^{e1}s, and Z^{e2}s, and pluralities of R^{N1}s and R^{N2}s, if present, may be the same or different R^{N1}s and R^{N2}s).
[5] The liquid crystal device according to any one of [1] to [4], wherein the dye-containing liquid crystal composition further contains a haze adjuster.
[6] The liquid crystal device according to any one of [1] to [5], wherein the dye-containing liquid crystal composition contains one or two or more compounds represented by general formula (II)

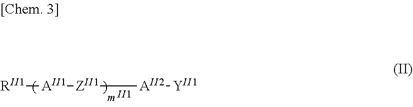

(wherein
   R^{II1} represents an alkyl group having 1 to 10 carbon atoms, one or two or more nonadjacent —CH₂—'s in the alkyl group are each independently optionally substituted with —CH═CH—, —O—, —CO—, —COO—, or —OCO—,
   A^{II1} and A^{II2} each independently represent a group selected from the group consisting of
(a) a 1,4-cyclohexylene group (in which one —CH₂— or two or more nonadjacent —CH₂—'s are optionally substituted with —O—),
(b) a 1,4-phenylene group (in which one —CH═ or two or more nonadjacent —CH═'s are optionally substituted with —N═), and
(c) a naphthalene-2,6-diyl group, a 1,2,3,4-tetrahydronaphthalene-2,6-diyl group, or a decahydronaphthalene-2,6-diyl group (one —CH═ or two or more nonadjacent —CH═'s present in the naphthalene-2,6-diyl group or the 1,2,3,4-tetrahydronaphthalene-2,6-diyl group are optionally substituted with —N═),
   the group (a), the group (b), and the group (c) are each independently optionally substituted with a cyano group, a fluorine atom, or a chlorine atom,
   Z^{II1} represents a single bond, —CH₂CH₂—, —(CH₂)₄—, —OCH₂—, —CH₂O—, —COO—, —OCO—, —OCF₂—, —CF₂O—, —CH═N—N═CH—, —CH═CH—, —CF═CF—, or —C≡C—,
   Y_{II1} represents a hydrogen atom, a fluorine atom, a chlorine atom, a cyano group, or an alkyl group having 1 to 10 carbon atoms, one or two or more nonadjacent —CH₂—'s in the alkyl group are each independently optionally substituted with —CH═CH—, —O—, —CO—, —COO—, or —OCO—, and one or two or more hydrogen atoms in the alkyl group are optionally substituted with a fluorine atom, and
   m_{II1} represents 1, 2, 3, or 4, wherein when mill represents 2, 3, or 4, a plurality of Allis and a plurality of Z^{II1}s may be the same or different).
[7] The liquid crystal device according to any one of [1] to [6], wherein a maximum absorption wavelength of the dichroic dye is 600 nm or more and 750 nm or less.
[8] The liquid crystal device according to any one of [1] to [7], wherein the dye-containing liquid crystal composition contains two or more dichroic dyes.
[9] The liquid crystal device according to any one of [1] to [8], wherein the liquid crystal device is driven by a rectangular wave having a frequency of 30 to 300 Hz.
[10] A liquid crystal display apparatus, a light control apparatus, or a light transmitting apparatus using the liquid crystal device according to any one of [1] to [9].

The liquid crystal device using a liquid crystal composition containing a dye and having a haze adjustment function provided by the disclosure exhibits a high contrast ratio, without requiring a polymerization process that may cause dye decomposition during its fabrication. In addition, since the addition of an ionic dopant is not required, non-uniform adsorption of an ionic dopant on the substrate surface in the device plane does not occur in the production process of the liquid crystal device, resulting in excellent display uniformity in the device plane. In particular, a liquid crystal device having a high contrast ratio and excellent display uniformity in a normally white mode can be provided. A display apparatus, a light control window, or smart glass having the liquid crystal device as a component can also be provided.

### DETAILED DESCRIPTION OF EMBODIMENTS

Dye-Containing Liquid Crystal Composition

A dye-containing liquid crystal composition is a liquid crystal composition containing a dye compound.

As the dye compound, a dichroic dye is preferred. Among those, it is preferable that the dichroic dye has a haze adjustment function and is added to a liquid crystal composition to yield a dye-containing liquid crystal composition.

As the dye compound, a compound represented by general formula (1) is particularly preferred because it lowers the haze value when no voltage is applied and increases the haze value when voltage is applied.

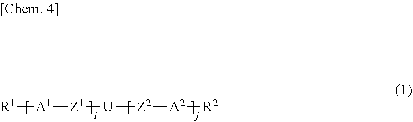

(In the formula, U is one group selected from groups represented by general formulae (2) to (5)

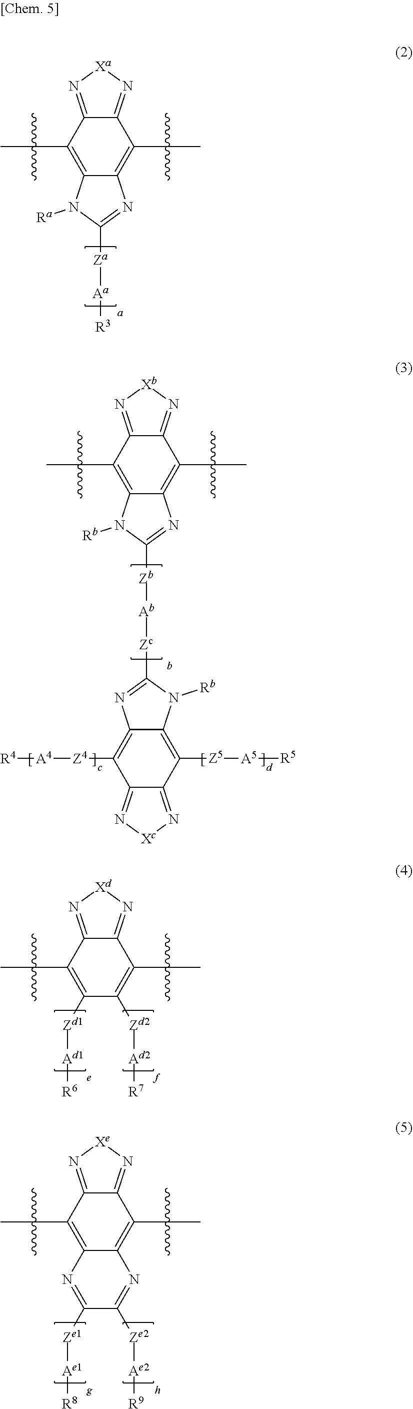

R¹, R², R³, R⁴, R⁵, R⁶, R⁷, R⁸, and R⁹ each independently represent a hydrogen atom, a fluorine atom, a cyano group, an alkyl group having 1 to 20 carbon atoms, or an alkenyl group having 2 to 30 carbon atoms, one —CH₂— or two or more nonadjacent —CH₂—'s present in these groups are optionally substituted with —NR^{N1}—, —O—, —S—, —CO—, —CS—, —COO—, —OCO—, —CO—S—, —S—CO—, —SO—, —SO₂—, —O—CO—O—, —CO—NH—, —NH—CO—, —CH═CH—, —CF═CF—, or —C≡C—, a hydrogen atom present in these groups is optionally substituted with a fluorine atom, wherein R^{N1} represents a hydrogen atom, an alkyl group having 1 to 20 carbon atoms, or an alkenyl group having 2 to 30 carbon atoms, one —CH₂— or two or more nonadjacent —CH₂—'s present in these groups are optionally substituted with —O—, —S—, —COO—, —OCO—, or —CO—, and a hydrogen atom present in these groups is optionally substituted with a fluorine atom,

R^{a}, R^{b}, and R^{c} each independently represent a hydrogen atom, an alkyl group having 1 to 20 carbon atoms, or an alkenyl group having 2 to 30 carbon atoms, one —CH₂— or two or more nonadjacent —CH₂—'s present in these groups are optionally substituted with —NR^{N2}—, —O—, —S—, —CO—, —CS—, —COO—, —OCO—, —CO—S—, —S—CO—, —SO—, —SO₂—, —O—CO—O—, —CO—NH—, —NH—CO—, —CH═CH—, —CF═CF—, or —C≡C—, a hydrogen atom present in these groups is optionally substituted with a fluorine atom, wherein R^{N2} represents a hydrogen atom, an alkyl group having 1 to 20 carbon atoms, or an alkenyl group having 2 to 30 carbon atoms, one —CH₂— or two or more nonadjacent —CH₂—'s present in these groups are optionally substituted with —O—, —S—, —COO—, —OCO—, or —CO—, a hydrogen atom present in these groups is optionally substituted with a fluorine atom,

Xₐ, X_{b}, X^{c}, X^{d}, and X^{e} each independently represent —S— or —O—,

A¹, A², A⁴, A⁵, A^{a}, A^{b}, A^{d1}, A^{d2}, A^{e1} and A^{e2} each independently represent an optionally substituted hydrocarbon ring or heterocyclic ring having 3 to 16 carbon atoms,

Z¹, Z², Z⁴, Z⁵, Z^{a}, Z^{b}, Z^{c}, Z^{d1}, Z^{d2}, Z^{e1}, and Z^{e2} each independently represent —CH₂O—, —OCH₂—, —CF₂O—, —OCF₂—, —COO—, —OCO—, —CH₂CH₂—, —CF₂CF₂—, —CH═CH—, —CF═CF—, —N═CH—, —CH═N—, —N═N—, —C≡C—, or a single bond,

i, j, a, b, c, d, e, f, g, and h each independently represent an integer of 0 to 4, and

pluralities of A¹s, A²s, A⁴s, A⁵s, A^{a}s, A^{b}s, A^{d1}s, A^{d2}s, A^{e1}s, and A^{e2}s, if present, may be the same or different A¹s, A²s, A⁴s, A⁵s, A^{a}s, A^{b}s, A^{d1}s, A^{d2}s, A^{e1}s, and A^{e2}s, pluralities of Z¹s, Z²s, Z⁴s, Z⁵s, Z^{a}s, Z^{b}s, Z^{c}s, Z^{d1}s, Z^{d2}s, Z^{e1}s, and Z^{e2}s, if present, may be the same or different Z¹s, Z²s, Z⁴s, Z⁵s, Z^{a}s, Z^{b}s, Z^{c}s, Z^{d1}s, Z^{d2}s, Z^{e1}s, and Z^{e2}s, and pluralities of R^{N1}s and R^{N2}s, if present, may be the same or different R^{N1}s and R^{N2}s.)

In general formula (1), U is preferably the structure represented by general formula (3) in order to increase the dichroic ratio, while the structure represented by general formula (2), (4), or (5) is preferred when light resistance and solubility in the host liquid crystal are important.

In general formula (1), R¹, R², R³, R⁴, R⁵, R⁶, R⁷, R⁸, and R⁹ preferably each independently represent a fluorine atom, a cyano group, an alkyl group having 2 to 20 carbon atoms, or an alkenyl group having 2 to 20 carbon atoms, and one —CH₂— or two or more nonadjacent —CH₂—'s present in these groups are preferably substituted with —O—, —S—, —CO—, —CS—, —COO—, —OCO—, —CO—S—, —S—CO—, —SO—, or —SO₂—. In order to increase the solubility in the host liquid crystal, an alkyl group or an alkenyl group having 1 to 20 carbon atoms is preferred, an unsubstituted linear or branched alkyl group having 1 to 20 carbon atoms is more preferred, an unsubstituted linear or branched alkyl group having 4 to 20 carbon atoms is even more preferred, and an unsubstituted branched alkyl group having 4 to 20 carbon atoms is particularly preferred. In order to exhibit a high dichroic ratio, R³ is preferably a linear alkyl group or fluorinated alkyl group having 1 to 5 carbon atoms, and one —CH₂— or two or more nonadjacent —CH₂—'s present in these groups are preferably substituted with —CO—, —COO—, or —OCO— and are particularly preferably a methyl group or a trifluoromethyl group. For longer absorption wavelengths, R³ is preferably a fluorine atom, a cyano group, a thioether group, an alkylsulfonyl group, a N,N-dialkylsulfonamide group, an alkylacyl group, an alkylcarbonyloxy group, or an alkyloxycarbonyl group.

In general formula (1), R^{a}, R^{b}, and R^{c} preferably each independently represent a hydrogen atom, an alkyl group having 2 to 20 carbon atoms, or an alkenyl group having 2 to 20 carbon atoms, and one —CH₂— or two or more nonadjacent —CH₂—'s present in these groups are preferably substituted with —O—, —S—, —CO—, —CS—, —COO—, —OCO—, —CO—S—, —S—CO—, —SO—, or —SO₂—. In order to increase the solubility in the host liquid crystal, an alkyl group or an alkenyl group having 1 to 20 carbon atoms is preferred, an unsubstituted linear or branched alkyl group having 1 to 20 carbon atoms is more preferred, an unsubstituted linear or branched alkyl group having 4 to 20 carbon atoms is even more preferred, and an unsubstituted branched alkyl group having 4 to 20 carbon atoms is particularly preferred. On the other hand, a hydrogen atom is preferred for a high dichroic ratio and ease of production. For longer absorption wavelengths, an alkylsulfonyl group, a N,N-dialkylsulfonamide group, or an alkylacyl group is preferred.

In general formula (1), X^{a}, X^{b}, X^{c}, X^{d}, and X^{e} each independently represent —S— or —O—, but —S— is preferable in terms of solubility and longer absorption wavelengths, and —O— is preferable in terms of a dichroic ratio, light resistance, and ease of production.

In general formula (1), A¹, A², A⁴, A⁵, A^{a}, A^{b}, A^{d1}, A^{d2}, A^{e1}, and A^{e2} are preferably each independently an optionally substituted hydrocarbon ring or heterocyclic ring having 3 to 16 carbon atoms. Here, the hydrocarbon ring may be aliphatic or aromatic, and may have a substituent on the ring. The heterocyclic ring may be aliphatic or aromatic, contains at least one heteroelement in the elements that make up the ring structure, and may have a substituent on the ring. Here, A¹, A², A⁴, A⁵, A^{a}, A^{b}, A^{d1}, A^{d2}, A^{e1}, and A^{e2} preferably each independently represent a group selected from the group consisting of
(a) a 1,4-cyclohexylene group (in which one —CH₂— or two or more nonadjacent —CH₂—'s are optionally substituted with —O— or —S—, and one CH or two or more nonadjacent CHs are optionally substituted with N),
(b) a 1,4-phenylene group (in which one —CH═ or two or more nonadjacent —CH═'s are optionally substituted with —N═),
(c) a 1,4-cyclohexenylene group, a bicyclo[2.2.2]octane-1,4-diyl group, a naphthalene-2,6-diyl group, a naphthalene-1,4-diyl group, a 1,2,3,4-tetrahydronaphthalene-2,6-diyl group, a 5,6,7,8-tetrahydronaphthalene-1,4-diyl group, a decahydronaphthalene-2,6-diyl group, an anthracene-2,6-diyl group, an anthracene-1,4-diyl group, an anthracene-9,10-diyl group, a phenanthrene-2,7-diyl group (in which a hydrogen atom is optionally substituted with a fluorine or chlorine atom, and one —CH═ or two or more —CH═'s in the naphthalene-2,6-diyl group, the naphthalene-1,4-diyl group, the 1,2,3,4-tetrahydronaphthalene-2,6-diyl group, the 5,6,7,8-tetrahydronaphthalene-1,4-diyl group, the anthracene-2,6-diyl group, the anthracene-1,4-diyl group, the anthracene-9,10-diyl group, or the phenanthrene-2,7-diyl group are optionally substituted with —N═), and
(d) a thiophene-2,5-diyl group, a thiophene-2,4-diyl group, a benzothiophene-2,5-diyl group, a benzothiophene-2,6-diyl group, a dibenzothiophene-3,7-diyl group, a dibenzothiophene-2,6-diyl group, a thieno[3,2-b]thiophene-2,5-diyl group (in which one —CH═ or two or more nonadjacent —CH═'s are optionally substituted with —N═).

It is also preferable that these groups are unsubstituted or substituted with one or more substituents L²s.

L²s are preferably each independently a hydrogen atom, a fluorine atom, a chlorine atom, a pentafluorosulfanyl group, a nitro group, a cyano group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear alkyl group having 1 to 20 carbon atoms or a branched or cyclic alkyl group having 3 to 20 carbon atoms, in which one —CH₂— or two or more —CH₂—'s are each independently optionally substituted with —O—, —S—, —CO—, —CS—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C. L²s are further preferably each independently a hydrogen atom, a fluorine atom, a chlorine atom, a pentafluorosulfanyl group, a nitro group, a cyano group, an isocyano group, a dimethylamino group, a diethylamino group, a diisopropylamino group, a thioisocyano group, a methyl group, an ethyl group, a propyl group, a methoxy group, an ethoxy group, or an acetyl group.

It is preferable that a preferred structure of A¹, A², A⁴, A⁵, A^{a}, A^{b}, A^{d1}, A^{d2}, A^{e1}, and A^{e2} represents a group selected from the following.

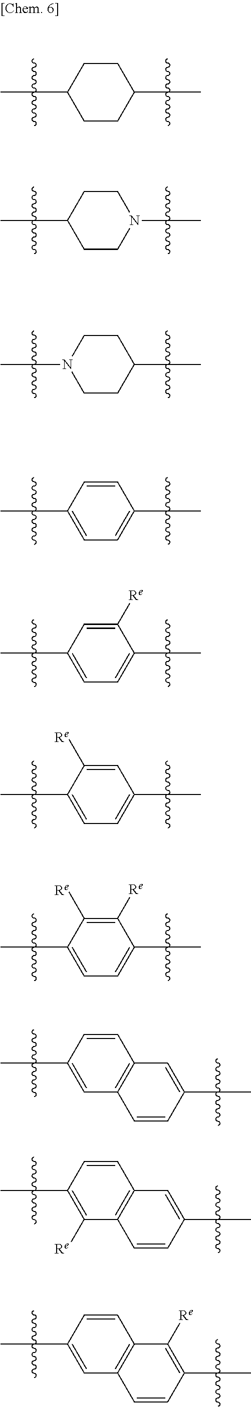

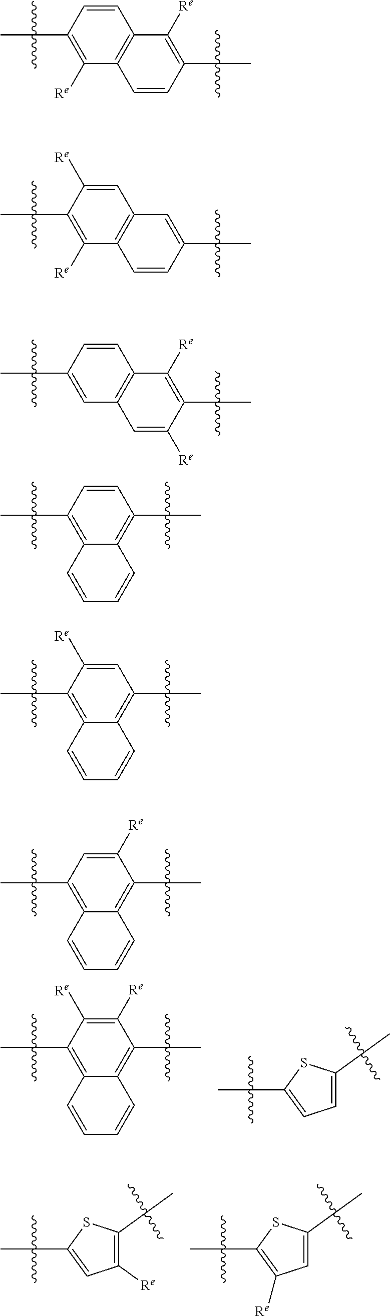

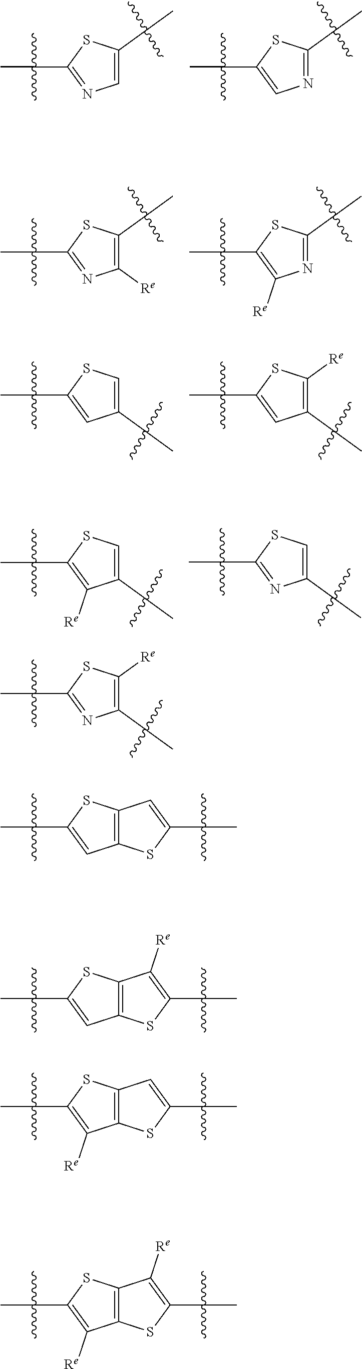

Here, R^{c}s preferably each independently represent a methyl group, an ethyl group, a propyl group, a 2-propyl group, a butyl group, a 2-butyl group, a methoxy group, an ethoxy group, a methylthio group, an ethylthio group, a dimethylamino group, a diethylamino group, a cyano group, a nitro group, a fluorine atom, or a chlorine atom. Specifically, in order to increase the solubility in the host liquid crystal, a trans-1,4-cyclohexylene group, an unsubstituted 1,4-phenylene group, a 2-fluoro-1,4-phenylene group, a 3-fluoro-1,4-phenylene group, a 2-alkyl-1,4-phenylene group, a 3-alkyl-1,4-phenylene group, an unsubstituted thiophene-2,5-diyl group, an unsubstituted thiophene-2,4-diyl group, a 4-alkyl-thiophene-2,5-diyl group, or a 5-alkyl-thiophene-2,4-diyl group is preferred. In this case, pluralities of A¹s and A²s, if present, are preferably A¹s and A²s of different structures. In order to increase the dichroic ratio, an unsubstituted 1,4-phenylene group, a 2-fluoro-1,4-phenylene group, a 3-fluoro-1,4-phenylene group, an unsubstituted thiophene-2,5-diyl group, an unsubstituted thiophene-2,4-diyl group, an unsubstituted naphthalene-2,6-diyl group, an unsubstituted naphthalene-1,4-diyl group, or an unsubstituted thieno[3,2-b]thiophene-2,5-diyl group is preferred. For longer absorption wavelengths, an electron-donating ring is preferred, and particularly a thiophene-2,5-diyl group, a thiophene-2,4-diyl group, a thieno[3,2-b]thiophene-2,5-diyl group, or a piperidine-1,4-diyl group is preferred. In order to increase the solubility in the host liquid crystal, Res preferably represent a methyl group, an ethyl group, a propyl group, a fluorine atom, or a chlorine atom, and more preferably represent a methyl group, an ethyl group, or a fluorine atom. For longer absorption wavelengths, R^{e}s are preferably electron-donating substituents, more preferably a methoxy group, an ethoxy group, a dimethylamino group, or a diethylamino group, and particularly preferably a methoxy group, an ethoxy group, or a dimethylamino group.

In general formula (1), Z¹, Z², Z⁴, Z⁵, Z^{a}, Z^{b}, Z^{c}, Z^{d1}, Z^{d2}, Z^{e1}, and Z^{e2} preferably each independently represent —CH₂CH₂—, —CH═CH—, —CF═CF—, —N═N—, —C≡—, or single bond. In order to increase the solubility in the host liquid crystal, —CH₂O—, —OCH₂—, —CH₂CH₂—, or a single bond is preferred, and —CH₂CH₂— or a single bond is even more preferred. In order to increase the dichroic ratio, —CH═CH—, —CF═CF—, —N═CH—, —CH═N—, —N═N—, —C≡C—, or a single bond is preferred, and —CH═CH—, —N═N—, —C≡C—, or a single bond is even more preferred. A single bond is preferred for high light resistance.

In general formula (1), i, j, a, b, c, d, e, f, g, and h preferably each independently represent an integer of 0 to 3, and more preferably represent an integer of 1 to 2 in terms of solubility. Furthermore, i, j, a, b, c, d, e, f, g, and h preferably each independently represent an integer of 1 to 3 in terms of a high dichroic ratio and longer absorption wavelengths. In order to increase the dichroic ratio, a and b are preferably each independently 0 or 1, particularly preferably 0.

In general formula (1), it is preferable that there is no direct bonding between oxygen atoms and/or between an oxygen atom and a sulfur atom in terms of stability of the compound.

The compound represented by general formula (1) has a skeleton represented by U in its structure and also has alkyl groups and the like represented by R¹, R², R³, R⁴, R⁵, R⁶, R⁷, R⁸, and R⁹ on its structure, thereby exhibiting high solubility in the liquid crystal composition. In particular, when the structure has a ring structure represented by A¹, A², A⁴, A⁵, A^{a}, A^{b}, A^{d1}, A^{d2}, A^{e1}, and A^{e2}, the entire compound approaches a rod-like structure, which improves the solubility in the liquid crystal composition and enhances dichroism when used as a dye. In particular, when these rings are aromatic, the π-electron conjugated system spreads throughout the molecule, which is effective for longer absorption wavelengths.

The compound represented by general formula (1) is preferably represented by the following formulae (1-A) to (1-D).

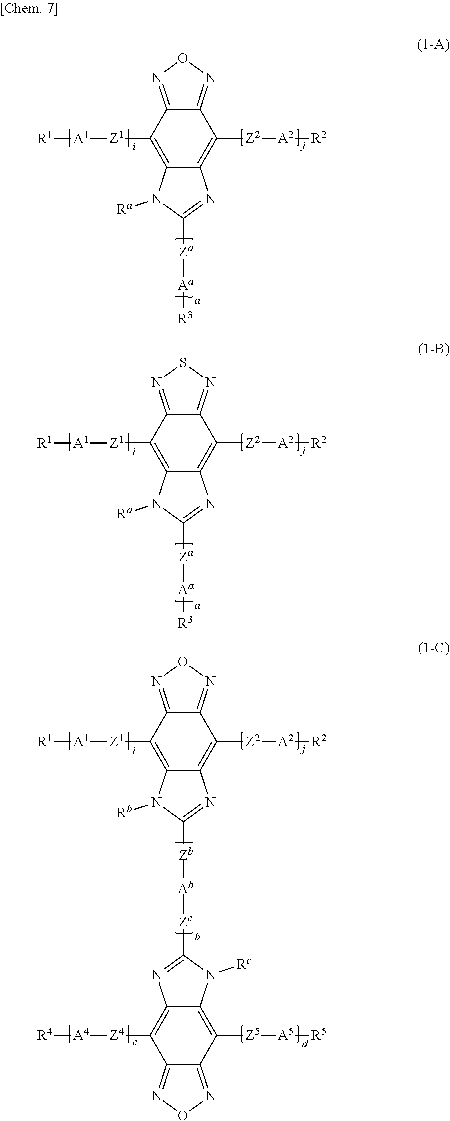

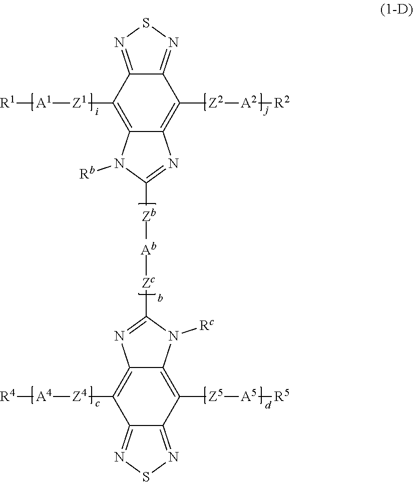

(In the formulae, R¹, R², R³, R⁴, R⁵, R^{a}, R^{b}, R^{c}, A¹, A², A⁴, A⁵, A^{a}, A^{b}, Z¹, Z², Z⁴, Z⁵, Z^{a}, Z^{b}, Z^{c}, i, j, a, b, c, and d each independently have the same meaning as R¹, R², R³, R⁴, R⁵, R^{a}, R^{b}, R^{c}, A¹, A², A⁴, A⁵, A^{a}, A^{b}, Z¹, Z², Z⁴, Z⁵, Z^{a}, Z^{b}, Z^{c}, i, j, a, b, c, and d in general formula (1).

Furthermore, among the compounds represented by general formula (1-A) to general formula (1-D), a structure represented by general formula (1-E) is preferred.

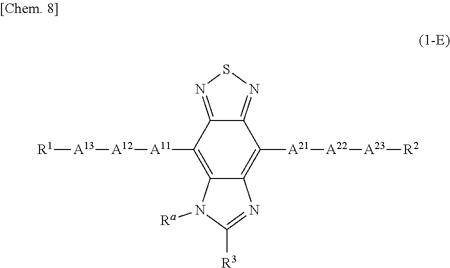

(In the formula, R¹, R², R³, and R^{a} have the same meaning as R¹, R², R³, and R^{a}, respectively, in general formula (1), A¹¹, A¹², and A¹³ each have the same meaning as A¹ in general formula (1) or a single bond, which may be the same or different, and A²¹, A²², and A²³ each have the same meaning as A² in general formula (1) or a single bond, which may be the same or different.)

The compound represented by general formula (1) preferably has a maximum absorption wavelength between 350 and 750 nm inclusive. In particular, the compound represented by general formula (1) preferably has a maximum absorption between 500 and 600 nm inclusive when it is a red dye, between 400 and 500 nm inclusive when it is a yellow dye, and between 600 and 750 nm inclusive when it is a blue dye. A dye-containing liquid crystal composition exhibiting a desired color can be prepared by using two or more compounds exhibiting these maximum absorption wavelengths in combination. In particular, when a black color is desired, it is preferable to use dyes exhibiting red, yellow, and blue colors in combination. It is also preferable to use the compound represented by general formula (1) in combination with a dichroic dye having a different structure.

The lower limit of the total amount of the compound represented by general formula (1) per 100% by mass of the liquid crystal composition without dye compounds or additives is preferably 0.1% by mass or more, preferably 0.2% by mass or more, preferably 0.3% by mass or more, preferably 0.4% by mass or more, preferably 0.5% by mass or more, preferably 0.7% by mass or more, and preferably 1% by mass or more.

The upper limit of the compound represented by general formula (1) per 100% by mass of the liquid crystal composition without dye compounds or additives is preferably 20% by mass or less, preferably 15% by mass or less, preferably 12% by mass or less, preferably 10% by mass or less, preferably 8% by mass or less, and preferably 5% by mass or less.

The total amount of the compound represented by general formula (1) per 100% by mass of the liquid crystal composition without dye compounds or additives is preferably 0.1 to 20% by mass, preferably 0.2 to 15% by mass, preferably 0.3 to 15% by mass, preferably 0.5 to 12% by mass, preferably 0.8 to 10% by mass, preferably 1 to 8% by mass, and preferably 1 to 6% by mass.

### Liquid Crystal Composition

It is preferable that the liquid crystal composition used for the dye-containing liquid crystal composition of the disclosure contains one or two or more compounds represented by general formula (II).

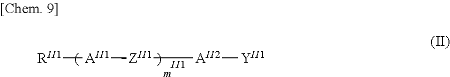

(In general formula (II), R^{II1} represents an alkyl group having 1 to 10 carbon atoms, one or two or more nonadjacent —CH₂—'s in the alkyl group are each independently optionally substituted with —CH═CH—, —O—, —CO—, —COO—, or —OCO—,

A^{II1} and A^{II2} each independently represent a group selected from the group consisting of
(a) a 1,4-cyclohexylene group (in which one —CH₂— or two or more nonadjacent —CH₂—'s are optionally substituted with —O—),
(b) a 1,4-phenylene group (in which one —CH═ or two or more nonadjacent —CH═'s are optionally substituted with —N═), and
(c) a naphthalene-2,6-diyl group, a 1,2,3,4-tetrahydronaphthalene-2,6-diyl group, or a decahydronaphthalene-2,6-diyl group (one —CH═ or two or more nonadjacent —CH═'s present in the naphthalene-2,6-diyl group or the 1,2,3,4-tetrahydronaphthalene-2,6-diyl group are optionally substituted with —N═),

the group (a), the group (b), and the group (c) are each independently optionally substituted with a cyano group, a fluorine atom, or a chlorine atom,

Z^{II1} represents a single bond, —CH₂CH₂—, —(CH₂)₄—, —OCH₂—, —CH₂O—, —COO—, —OCO—, —OCF₂—, —CF₂O—, —CH═N—N═CH—, —CH═CH—, —CF═CF—, or —C≡C—,

Y_{II1} represents a hydrogen atom, a fluorine atom, a chlorine atom, a cyano group, or an alkyl group having 1 to 10 carbon atoms, one or two or more nonadjacent —CH₂—'s in the alkyl group are each independently optionally substituted with —CH═CH—, —O—, —CO—, —COO—, or —OCO—, and one or two or more hydrogen atoms in the alkyl group are optionally substituted with a fluorine atom, and

m_{II1} represents 1, 2, 3, or 4, wherein when mill represents 2, 3, or 4, a plurality of A^{II1}s and a plurality of Z^{II1}s may be the same or different.)

In the liquid crystal composition of the disclosure, one or two or more compounds represented by general formula (II) can be combined to adjust the magnitude of dielectric constant anisotropy. The liquid crystal composition of the disclosure is preferably a negative liquid crystal composition with a negative dielectric constant anisotropy (Δε) having an absolute value (|Δε|) of 2 or more. Specific values of the dielectric constant anisotropy will be described later.

The compound represented by general formula (II) may be a liquid crystal compound with a negative dielectric constant anisotropy (Δε) (first mode) or a nonpolar liquid crystal compound with a dielectric constant anisotropy (Δε) near 0 (second mode), according to dielectric constant anisotropy. The dielectric constant anisotropy of the compound represented by general formula (II) is the value at 25° C. The compounds represented by general formula (II) in different modes will be described below.

[1] First Mode of Compound Represented by General Formula (II)

The first mode of the compound represented by general formula (II) (hereinafter referred to as the compound in the first mode) is a liquid crystal compound with a negative dielectric constant anisotropy (Δε). The compound in the first mode has a negative Δε with an absolute value preferably greater than 2, and more preferably the absolute value is greater than 3.

Examples of such a compound in the first mode include compounds selected from a group of compounds represented by the following general formulae (N-1) to (N-3).

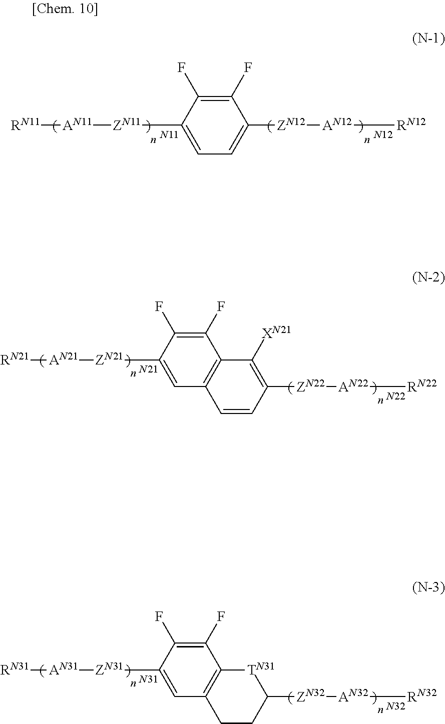

(In the formulae, R^{N11}, R^{N12}, R^{N21}, R^{N22}, R^{N31}, and R^{N32} each independently represent an alkyl group having 1 to 8 carbon atoms, one or two or more nonadjacent —CH₂—'s in the alkyl group are each independently optionally substituted with —CH═CH—, —C≡C—, —O—, —CO—, —COO—, or —OCO—,

A^{N11}, A^{N12}, A^{N21}, A^{N22}, A^{N31}, and A^{N32} each independently represent a group selected from the group consisting of
(a) a 1,4-cyclohexylene group (in which one —CH₂— or two or more nonadjacent —CH₂—'s are optionally substituted with —O—),
(b) a 1,4-phenylene group (in which one —CH═ or two or more nonadjacent —CH═'s are optionally substituted with —N═), and
(c) a naphthalene-2,6-diyl group, a 1,2,3,4-tetrahydronaphthalene-2,6-diyl group, or a decahydronaphthalene-2,6-diyl group (one —CH═ or two or more nonadjacent —CH═'s present in the naphthalene-2,6-diyl group or the 1,2,3,4-tetrahydronaphthalene-2,6-diyl group are optionally substituted with —N═),

the group (a), the group (b), and the group (c) are each independently optionally substituted with a cyano group, a fluorine atom, or a chlorine atom,

Z^{N11}, Z^{N12}, Z^{N21}, Z^{N22}, Z^{N31}, and Z^{N32} each independently represent a single bond, —CH₂CH₂—, —(CH₂)₄—, —OCH₂—, —CH₂O—, —COO—, —OCO—, —OCF₂—, —CF₂O—, —CH═N—N═CH—, —CH═CH—, —CF═CF—, or —C≡C—,

X^{N21} represents a hydrogen atom or a fluorine atom,

T^{N31} represents —CH₂— or an oxygen atom,

n^{N11}, n^{N12}, n^{N21}, n^{N22}, n^{N31}, and n^{N32} each independently represent an integer of 0 to 3, wherein n^{N11}±n^{N12}, n^{N21}±n^{N22}, and n^{N31}±n^{N32} are each independently 1, 2, or 3, and

pluralities of A^{N11} to A^{N32} and Z^{N11} to Z^{N32}, if any, may be the same or different. However, compounds represented by general formula (N-1) are excluded in general formula (N-2) and general formula (N-3), and compounds represented by general formula (N-2) are excluded in general formula (N-3).)

When the liquid crystal composition of the disclosure has a negative value of dielectric constant anisotropy (Δε) at 25° C., it is preferable that the liquid crystal composition of the disclosure contains one or two or more compounds selected from a group of compounds represented by general formulae (N-1), (N-2), and (N-3).

In general formulae (N-1), (N-2), and (N-3), R^{N11}, R^{N12}, R^{N21}, R^{N22}, R^{N31}, and R^{N32} are preferably each independently an alkyl group having 1 to 8 carbon atoms, an alkoxy group having 1 to 8 carbon atoms, an alkenyl group having 2 to 8 carbon atoms, or an alkenyloxy group having 2 to 8 carbon atoms, preferably an alkyl group having 1 to 5 carbon atoms, an alkoxy group having 1 to 5 carbon atoms, an alkenyl group having 2 to 5 carbon atoms, or an alkenyloxy group having 2 to 5 carbon atoms, even more preferably an alkyl group having 1 to 5 carbon atoms or an alkenyl group having 2 to 5 carbon atoms, even more preferably an alkyl group having 2 to 5 carbon atoms or an alkenyl group having 2 to 3 carbon atoms, and particularly preferably an alkenyl group (propenyl group) having 3 carbon atoms.

When the ring structure to which R^{N11}, R^{N12}, R^{N21}, R^{N22}, R^{N31}, and R^{N32} are each bonded is a phenyl group (aromatic), it is preferable that R^{N11}, R^{N12}, R^{N21}, R^{N22}, R^{N31}, and R^{N32} are each independently a linear alkyl group having 1 to 5 carbon atoms, a linear alkoxy group having 1 to 4 carbon atoms, and an alkenyl group having 4 to 5 carbon atoms. On the other hand, when the ring structure to which R^{N11}, R^{N12}, R^{N21}, R^{N22}, R^{N31}, and R^{N32} are each bonded is a saturated ring structure such as cyclohexane, pyran, and dioxane, it is preferable that R^{N11}, R^{N12}, R^{N21}, R^{N22}, R^{N31}, and R^{N32} are each independently a linear alkyl group having 1 to 5 carbon atoms, a linear alkoxy group having 1 to 4 carbon atoms, and a linear alkenyl group having 2 to 5 carbon atoms.

To stabilize the nematic phase, R^{N11}, R^{N12}, R^{N21}, R^{N22}, R^{N31}, and R^{N32} preferably each independently have a total of 5 or less carbon and oxygen atoms and are preferably linear.

The alkenyl group is preferably selected from the groups represented by any of formulae (R1) to (R5). The black dots in formulae (R1) to (R5) represent carbon atoms in the ring structure to which the alkenyl group is bonded.

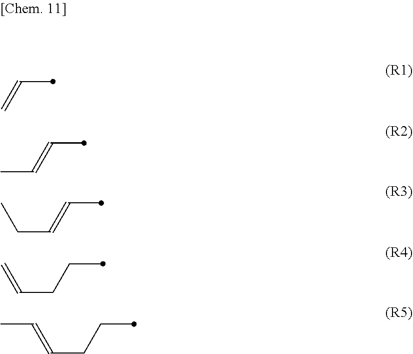

When a larger n is required, A^{N11}, A^{N12}, A^{N21}, A^{N22}, A^{N31}, and A^{N32} are preferably each independently aromatic. On the other hand, to improve the response speed, A^{N11}, A^{N12}, A^{N21}, A^{N22}, A^{N31}, and A^{N32} are preferably each independently aliphatic, and preferably represent a trans-1,4-cyclohexylene group, a 1,4-phenylene group, a 2-fluoro-1,4-phenylene group, a 3-fluoro-1,4 phenylene group, a 3,5-difluoro-1,4-phenylene group, a 2,3-difluoro-1,4-phenylene group, a 1,4-cyclohexenylene group, a 1,4-bicyclo[2.2.2]octylene group, a piperidine-1,4-diyl group, a naphthalene-2,6-diyl group, a decahydronaphthalene-2,6-diyl group, or a 1,2,3,4-tetrahydronaphthalene-2,6-diyl group.

Among those, A^{N11}, A^{N12}, A^{N21}, A^{N22}, A^{N31}, and A^{N32} preferably each independently represent one of the following structures.

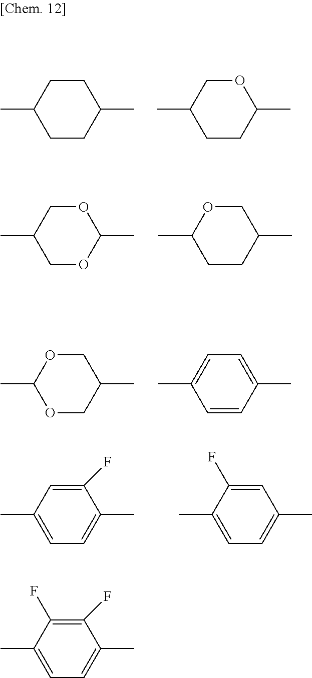

Furthermore, A^{N11}, A^{N12}, A^{N21}, A^{N22}, A^{N31}, and A^{N32} preferably each independently represent a trans-1,4-cyclohexylene group or a 1,4-phenylene group.

Z^{N11}, Z^{N12}, Z^{N21}, Z^{N22}, Z^{N31}, and Z^{N32} preferably each independently represent —CH₂O—, —CF₂O—, —CH₂CH₂—, —CF₂CF₂—, or a single bond, even more preferably —CH₂O—, —CH₂CH₂—, or a single bond, and particularly preferably —CH₂O— or a single bond.

X^{N21} is preferably a fluorine atom.

T^{N31} is preferably an oxygen atom.

n^{N11}+n^{N12}, n^{N21}+n^{N22}, and n^{N31}+n^{N32} are preferably 1 or 2. A combination in which n^{N11} is 1 and n^{N122} is 0, a combination in which n^{N11} is 2 and n^{N12} is 0, a combination in which n^{N11} is 1 and n^{N12} is 1, a combination in which n^{N11} is 2 and n^{N12} is 1, a combination in which n^{N21} is 1 and n^{N22} is 0, a combination in which n^{N21} is 2 and n^{N22} is 0, a combination in which n^{N31} is 1 and n^{N32} is 0, and a combination in which n^{N31} is 2 and n^{N32} is 0 are preferred.

The liquid crystal composition of the disclosure preferably contains one or two or more compounds selected from the group consisting of compounds in which at least one of Z^{N11} and Z^{N12} in general formula (N-1) represents —CH₂O—, compounds in which at least one of Z^{N21} and Z^{N22} in general formula (N-2) represents —CH₂O—, and compounds in which at least one of Z^{N31} and Z^{N32} in general formula (N-3) represents —CH₂O—.

The lower limit of the amount of the compound represented by formula (N-1) is preferably 0% by mass, 1% by mass, 10% by mass, 20% by mass, 30% by mass, 40% by mass, 50% by mass, 55% by mass, 60% by mass, 65% by mass, 70% by mass, 75% by mass, or 80% by mass in the total amount of the liquid crystal composition of the disclosure. The upper limit of the amount of the compound represented by formula (N-1) is preferably 95% by mass, 85% by mass, 75% by mass, 65% by mass, 55% by mass, 45% by mass, 35% by mass, 25% by mass, or 20% by mass in the total amount of the liquid crystal composition of the disclosure.

The preferred values of the upper and lower limits of the amount of the compound represented by formula (N-2) and the upper and lower limits of the amount of the compound represented by formula (N-3) can be the same as the preferred values of the upper and lower limits of the amount of the compound represented by formula (N-1).

When a low viscosity and a high response speed are required for the liquid crystal composition of the disclosure, it is preferable that the lower limit is low and the upper limit is low. Furthermore, when a high Tni and high temperature stability are required for the liquid crystal composition of the disclosure, it is preferable that the lower limit is low and the upper limit is low. When a larger dielectric constant anisotropy is desired to keep the drive voltage low, it is preferable that the lower limit is high and the upper limit is high.

Among others, it is preferable that the liquid crystal composition of the disclosure contains one or two or more compounds represented by general formula (N-1). Examples of the compounds represented by general formula (N-1) include a group of compounds represented by the following general formulae (N-1a) to (N-1g). Among those, it is preferable to include one or two or more compounds represented by general formula (N-1d) or (N-10, because they have a linking group represented by —CH₂O—, and it is more preferable to include one or two or more compounds represented by general formula (N-1d).

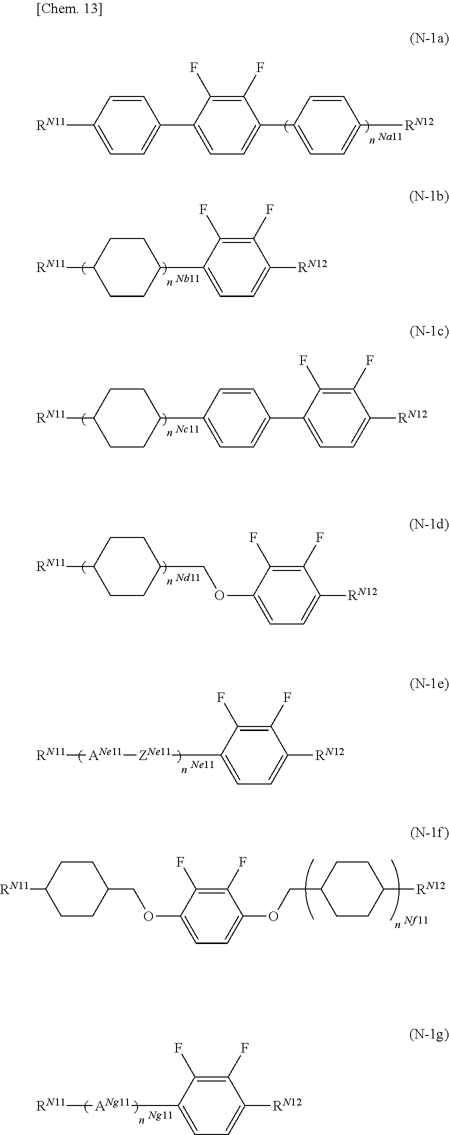

(In the formulae, R^{N11} and R^{N12} have the same meaning as R^{N11} and R^{N12} in general formula (N-1), n^{Na11} represents 0 or 1, n^{Nb11} represents 1 or 2, n^{Nc11} represents 0 or 1, n^{Nd11} represents 1 or 2, n^{Ne11} represents 1 or 2, n^{Nf12} represents 1 or 2, n^{Ng11} represents 1 or 2, A^{Ne11} represents a trans-1,4-cyclohexylene group or a 1,4-phenylene group, A^{Ng11} represents a trans-1,4-cyclohexylene group, a 1,4-cyclohexenylene group, or a 1,4-phenylene group, wherein at least one represents a 1,4-cyclohexenylene group, Z^{Ne11} represents a single bond or ethylene, wherein at least one present in the molecule is ethylene, and pluralities of A^{Ne11}s, Z^{Ne11}s, and/or A^{Ng11}s present in the molecule may be the same or different.)

More specifically, the compound represented by general formula (N-1) is preferably a compound selected from a group of compounds represented by general formulae (N-1-1) to (N-1-21).

The compound represented by general formula (N-1-1) is the following compound.

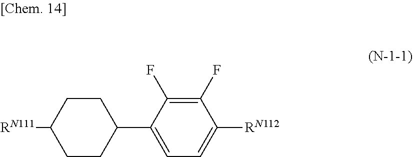

(In the formula, R^{N111} and R^{N112} each independently have the same meaning as R^{N11} and R^{N12} in general formula (N-1).)

R^{N111} is preferably an alkyl group having 1 to 5 carbon atoms or an alkenyl group having 2 to 5 carbon atoms, and preferably a propyl group, a pentyl group, or a vinyl group. R^{N112} is preferably an alkyl group having 1 to 5 carbon atoms, an alkenyl group having 4 to 5 carbon atoms, or an alkoxy group having 1 to 4 carbon atoms, and preferably an ethoxy group or a butoxy group.

The compound represented by general formula (N-1-1) can be used alone or two or more compounds may be used in combination. Any compounds can be used in combination and an appropriate combination is used depending on the required performance, such as solubility at low temperatures, transition temperature, electrical reliability, and birefringence index. In one embodiment of the disclosure, for example, one, two, three, four, five or more compounds are used.

The amount is preferably increased when improvement of Δε is important, increasing the amount is effective when solubility at low temperatures is important, and reducing the amount is effective when T_{NI} is important. Furthermore, when reduced dropping marks and improved image sticking characteristics are desired, the amount range is preferably set in the middle.

The lower limit of the amount of the compound represented by formula (N-1-1) is preferably 5% by mass, 10% by mass, 13% by mass, 15% by mass, 17% by mass, 20% by mass, 23% by mass, 25% by mass, 27% by mass, 30% by mass, 33% by mass, or 35% by mass in the total amount of the liquid crystal composition of the disclosure. The upper limit of the amount is preferably 50% by mass, 40% by mass, 38% by mass, 35% by mass, 33% by mass, 30% by mass, 28% by mass, 25% by mass, 23% by mass, 20% by mass, 18% by mass, 15% by mass, 13% by mass, 10% by mass, 8% by mass, 7% by mass, 6% by mass, 5% by mass, or 3% by mass in the total amount of the liquid crystal composition of the disclosure.

The compound represented by general formula (N-1-1) is preferably a compound selected from a group of compounds represented by formulae (N-1-1.1) to (N-1-1.22), preferably compounds represented by formulae (N-1-1.1) to (N-1-1.4), and preferably compounds represented by formulae (N-1-1.1) and (N-1-1.3).

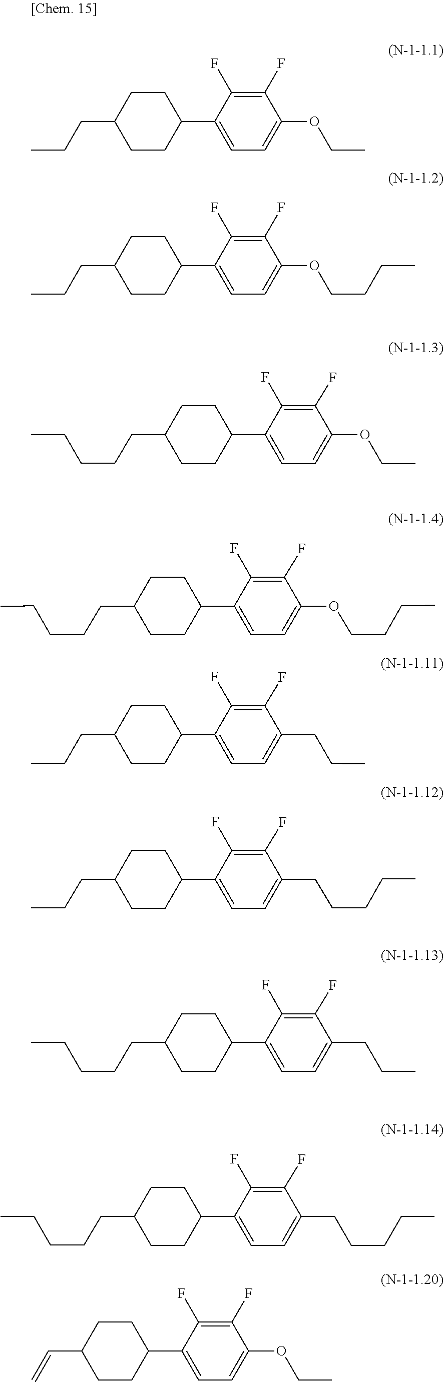

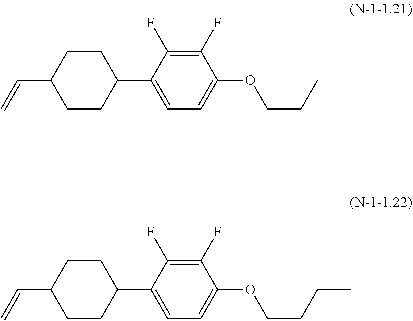

The compounds represented by formulae (N-1-1.1) to (N-1-1.22) can be used alone or may be used in combination. The lower limit of the amount of the compounds represented by formulae (N-1-1.1) to (N-1-1.22) is preferably 5% by mass, 10% by mass, 13% by mass, 15% by mass, 17% by mass, 20% by mass, 23% by mass, 25% by mass, 27% by mass, 30% by mass, 33% by mass, or 35% by mass in the total amount of the liquid crystal composition of the disclosure. The upper limit of the amount is preferably 50% by mass, 40% by mass, 38% by mass, 35% by mass, 33% by mass, 30% by mass, 28% by mass, 25% by mass, 23% by mass, 20% by mass, 18% by mass, 15% by mass, 13% by mass, 10% by mass, 8% by mass, 7% by mass, 6% by mass, 5% by mass, or 3% by mass in the total amount of the liquid crystal composition of the disclosure.

The compound represented by general formula (N-1-2) is the following compound.

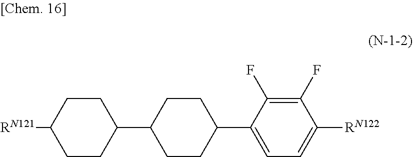

(In the formula, R^{N121} and R^{N122} each independently have the same meaning as R^{N11} and R^{N12} in general formula (N-1).)

R^{N121} is preferably an alkyl group having 1 to 5 carbon atoms or an alkenyl group having 2 to 5 carbon atoms, and preferably an ethyl group, a propyl group, a butyl group, or a pentyl group. R^{N122} is preferably an alkyl group having 1 to 5 carbon atoms, an alkenyl group having 4 to 5 carbon atoms, or an alkoxy group having 1 to 4 carbon atoms, and preferably a methyl group, a propyl group, a methoxy group, an ethoxy group, or a propoxy group.

The compound represented by general formula (N-1-2) can be used alone or two or more compounds may be used in combination. Any compounds can be used in combination and an appropriate combination is used depending on the required performance, such as solubility at low temperatures, transition temperature, electrical reliability, and birefringence index. In one embodiment of the disclosure, for example, one, two, three, four, five or more compounds are used.

The amount is preferably increased when improvement of Δε is important, reducing the amount is effective when solubility at low temperatures is important, and increasing the amount is effective when T_{NI} is important. Furthermore, when reduced dropping marks and improved image sticking characteristics are desired, the amount range is preferably set in the middle.

The lower limit of the amount of the compound represented by formula (N-1-2) is preferably 5% by mass, 7% by mass, 10% by mass, 13% by mass, 15% by mass, 17% by mass, 20% by mass, 23% by mass, 25% by mass, 27% by mass, 30% by mass, 33% by mass, 35% by mass, 37% by mass, 40% by mass, or 42% by mass in the total amount of the liquid crystal composition of the disclosure. The upper limit of the amount is preferably 50% by mass, 48% by mass, 45% by mass, 43% by mass, 40% by mass, 38% by mass, 35% by mass, 33% by mass, 30% by mass, 28% by mass, 25% by mass, 23% by mass, 20% by mass, 18% by mass, 15% by mass, 13% by mass, 10% by mass, 8% by mass, 7% by mass, 6% by mass, or 5% by mass in the total amount of the liquid crystal composition of the disclosure.

The compound represented by general formula (N-1-2) is preferably a compound selected from a group of compounds represented by formulae (N-1-2.1) to (N-1-2.22), and preferably compounds represented by formulae (N-1-2.3) to (N-1-2.7), (N-1-2.10), (N-1-2.11), (N-1-2.13), and (N-1-2.20). When improvement of Δε is important, compounds represented by formulae (N-1-2.3) to (N-1-2.7) are preferred. When improvement of T_{NI} is important, compounds represented by formulae (N-1-2.10), (N-1-2.11), and (N-1-2.13) are preferred. When improvement of response speed is important, compounds represented by formula (N-1-2.20) are preferred.

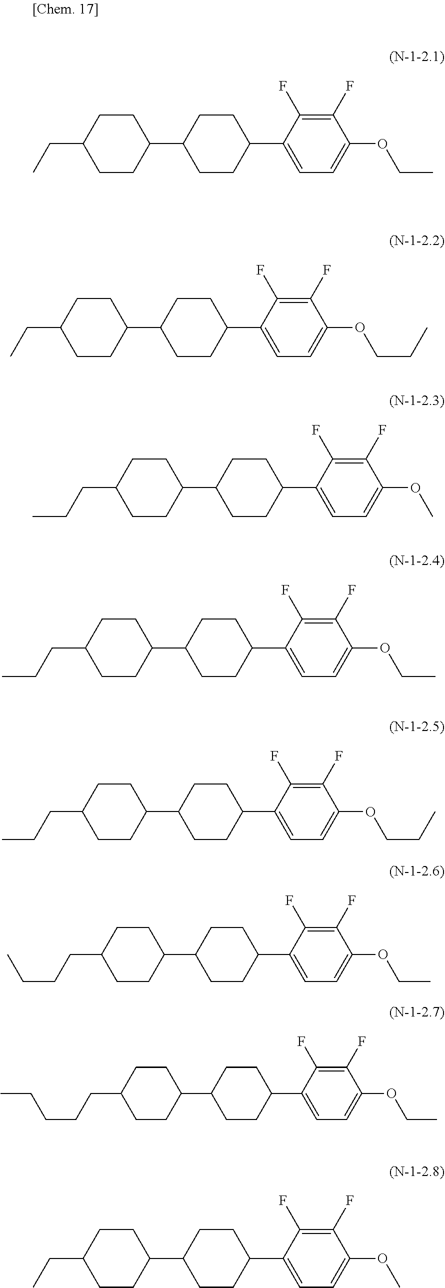

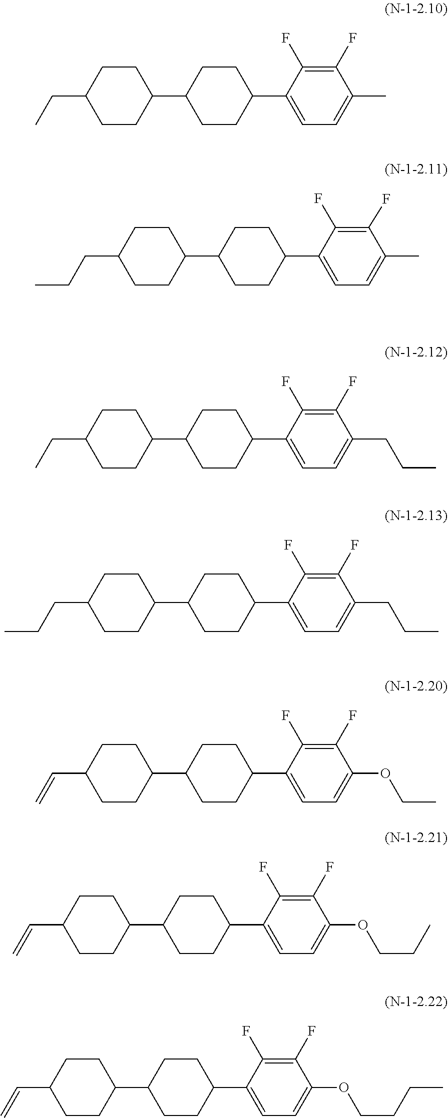

The compounds represented by formulae (N-1-2.1) to (N-1-2.22) can be used alone or may be used in combination. The lower limit of the amount of these compounds is preferably 5% by mass, 10% by mass, 13% by mass, 15% by mass, 17% by mass, 20% by mass, 23% by mass, 25% by mass, 27% by mass, 30% by mass, 33% by mass, or 35% by mass in the total amount of the liquid crystal composition of the disclosure. The upper limit of the amount is preferably 50% by mass, 40% by mass, 38% by mass, 35% by mass, 33% by mass, 30% by mass, 28% by mass, 25% by mass, 23% by mass, 20% by mass, 18% by mass, 15% by mass, 13% by mass, 10% by mass, 8% by mass, 7% by mass, 6% by mass, 5% by mass, or 3% by mass in the total amount of the liquid crystal composition of the disclosure.

The compound represented by general formula (N-1-3) is the following compound.

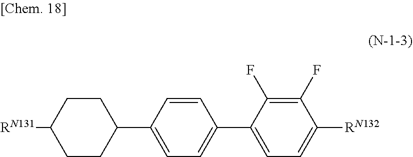

(In the formula, R^{N131} and R^{N132} each independently have the same meaning as R^{N11} and R^{N12} in general formula (N-1).)

R^{N131} is preferably an alkyl group having 1 to 5 carbon atoms or an alkenyl group having 2 to 5 carbon atoms, and preferably an ethyl group, a propyl group, or a butyl group. R^{N132} is preferably an alkyl group having 1 to 5 carbon atoms, an alkenyl group having 3 to 5 carbon atoms, or an alkoxy group having 1 to 4 carbon atoms, and preferably a 1-propenyl group, an ethoxy group, a propoxy group, or a butoxy group.

The compound represented by general formula (N-1-3) can be used alone or two or more compounds may be used in combination. Any compounds can be used in combination and an appropriate combination is used depending on the required performance, such as solubility at low temperatures, transition temperature, electrical reliability, and birefringence index. In one embodiment of the disclosure, for example, one, two, three, four, five or more compounds are used.

The amount is preferably increased when improvement of Δε is important, increasing the amount is effective when solubility at low temperatures is important, and increasing the amount is effective when T_{NI} is important. Furthermore, when reduced dropping marks and improved image sticking characteristics are desired, the amount range is preferably set in the middle.

The lower limit of the amount of the compound represented by general formula (N-1-3) is preferably 5% by mass, 10% by mass, 13% by mass, 15% by mass, 17% by mass, or 20% by mass, 20% by mass, 18% by mass, 15% by mass, or 13% by mass in the total amount of the liquid crystal composition of the disclosure.

The compound represented by general formula (N-1-3) is preferably a compound selected from a group of compounds represented by formulae (N-1-3.1) to (N-1-3.21), preferably a compound selected from a group of compounds represented by formulae (N-1-3.1) to (N-1-3.7) and (N-1-3.21), and preferably a compound selected from a group of compounds represented by formulae (N-1-3.1), (N-1-3.2), (N-1-3.3), (N-1-3.4), and (N-1-3.6).

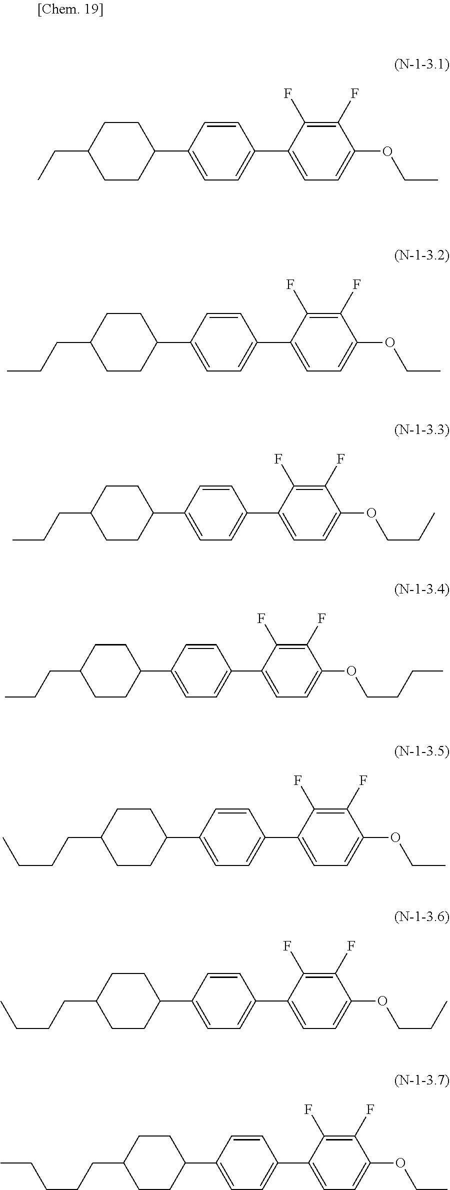

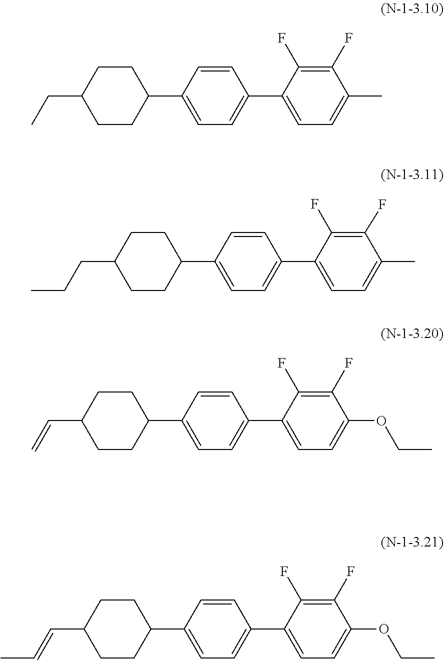

The compounds represented by formulae (N-1-3.1) to (N-1-3.4), (N-1-3.6), and (N-1-3.21) can be used alone or in combination. A combination of formulae (N-1-3.1) and (N-1-3.2), and a combination of two or three selected from formulae (N-1-3.3), (N-1-3.4), and (N-1-3.6) are preferred. The lower limit of the amount of these compounds is preferably 5% by mass, 10% by mass, 13% by mass, 15% by mass, 17% by mass, or 20% by mass in the total amount of the liquid crystal composition of the disclosure. The upper limit of the amount is preferably 35% by mass, 30% by mass, 28% by mass, 25% by mass, 23% by mass, 20% by mass, 18% by mass, 15% by mass, or 13% by mass in the total amount of the liquid crystal composition of the disclosure.

The compound represented by general formula (N-1-4) is the following compound.

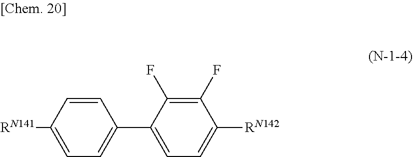

(In the formula, R^{N141} and R^{N142} each independently have the same meaning as R^{N11} and R^{N12} in general formula (N-1).)

R^{N141} and R^{N142} are preferably each independently an alkyl group having 1 to 5 carbon atoms, an alkenyl group having 4 to 5 carbon atoms, or an alkoxy group having 1 to 4 carbon atoms, and preferably a methyl group, a propyl group, an ethoxy group, or a butoxy group.

The compound represented by general formula (N-1-4) can be used alone or two or more compounds may be used in combination. Any compounds can be used in combination and an appropriate combination is used depending on the required performance, such as solubility at low temperatures, transition temperature, electrical reliability, and birefringence index. In one embodiment of the disclosure, for example, one, two, three, four, five or more compounds are used.

The amount is preferably increased when improvement of Δε is important, increasing the amount is effective when solubility at low temperatures is important, and reducing the amount is effective when T_{NI} is important. Furthermore, when reduced dropping marks and improved image sticking characteristics are desired, the amount range is preferably set in the middle.

The lower limit of the amount of the compound represented by general formula (N-1-4) is preferably 3% by mass, 5% by mass, 7% by mass, 10% by mass, 13% by mass, 15% by mass, 17% by mass, or 20% by mass in the total amount of the liquid crystal composition of the disclosure. The upper limit of the amount is preferably 35% by mass, 30% by mass, 28% by mass, 25% by mass, 23% by mass, 20% by mass, 18% by mass, 15% by mass, 13% by mass, 11% by mass, 10% by mass, or 8% by mass in the total amount of the liquid crystal composition of the disclosure.

The compound represented by general formula (N-1-4) is preferably a compound selected from a group of compounds represented by formulae (N-1-4.1) to (N-1-4.14), preferably compounds represented by formulae (N-1-4.1) to (N-1-4.4), and preferably compounds represented by formulae (N-1-4.1), (N-1-4.2), and (N-1-4.4).

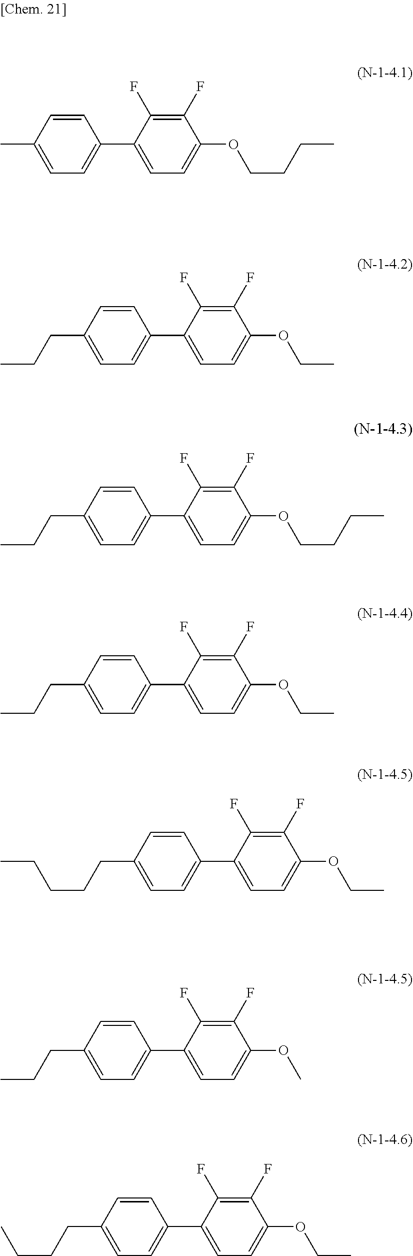

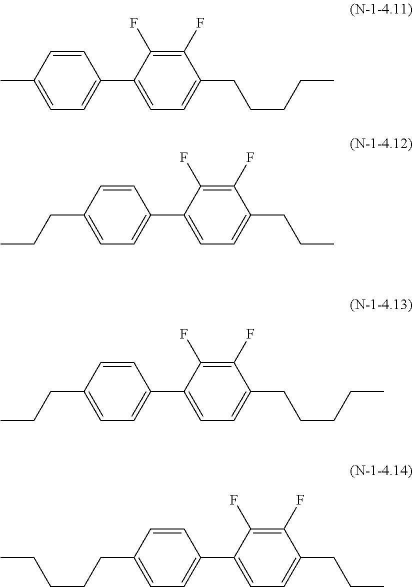

The compounds represented by formulae (N-1-4.1) to (N-1-4.14) can be used alone or may be used in combination. The lower limit of the amount of these compounds is preferably 3% by mass, 5% by mass, 7% by mass, 10% by mass, 13% by mass, 15% by mass, 17% by mass, or 20% by mass in the total amount of the liquid crystal composition of the disclosure. The upper limit of the amount is preferably 35% by mass, 30% by mass, 28% by mass, 25% by mass, 23% by mass, 20% by mass, 18% by mass, 15% by mass, 13% by mass, 11% by mass, 10% by mass, or 8% by mass in the total amount of the liquid crystal composition of the disclosure.

The compound represented by general formula (N-1-5) is the following compound.

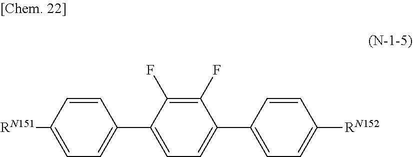

(In the formula, R^{N151} and R^{N152} each independently have the same meaning as R^{N11} and R^{N12} in general formula (N-1).)

R^{N151} and R^{N152} are preferably each independently an alkyl group having 1 to 5 carbon atoms, an alkenyl group having 4 to 5 carbon atoms, or an alkoxy group having 1 to 4 carbon atoms, and preferably an ethyl group, a propyl group, or a butyl group.

The compound represented by general formula (N-1-5) can be used alone or two or more compounds may be used in combination. Any compounds can be used in combination and an appropriate combination is used depending on the required performance, such as solubility at low temperatures, transition temperature, electrical reliability, and birefringence index. In one embodiment of the disclosure, for example, one, two, three, four, five or more compounds are used.

The amount is preferably increased when improvement of Δε is important, reducing the amount is effective when solubility at low temperatures is important, and increasing the amount is effective when T_{NI} is important. Furthermore, when reduced dropping marks and improved image sticking characteristics are desired, the amount range is preferably set in the middle.

The lower limit of the amount of the compound represented by general formula (N-1-5) is preferably 5% by mass, 8% by mass, 10% by mass, 13% by mass, 15% by mass, 17% by mass, or 20% by mass in the total amount of the liquid crystal composition of the disclosure. The upper limit of the amount is preferably 35% by mass, 33% by mass, 30% by mass, 28% by mass, 25% by mass, 23% by mass, 20% by mass, 18% by mass, 15% by mass, or 13% by mass in the total amount of the liquid crystal composition of the disclosure.

The compound represented by general formula (N-1-5) is preferably a compound selected from a group of compounds represented by formulae (N-1-5.1) to (N-1-5.6), and preferably compounds represented by formulae (N-1-5.1), (N-1-5.2), and (N-1-5.4).

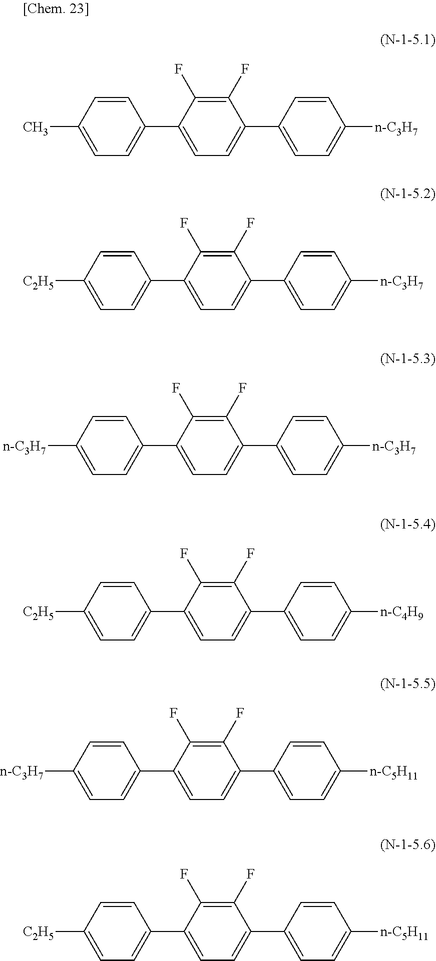

The compounds represented by formulae (N-1-5.1), (N-1-5.2), and (N-1-5.4) can be used alone or may be used in combination. The lower limit of the amount of these compounds is preferably 5% by mass, 8% by mass, 10% by mass, 13% by mass, 15% by mass, 17% by mass, or 20% by mass in the total amount of the liquid crystal composition of the disclosure. The upper limit of the amount is preferably 35% by mass, 33% by mass, 30% by mass, 28% by mass, 25% by mass, 23% by mass, 20% by mass, 18% by mass, 15% by mass, or 13% by mass in the total amount of the liquid crystal composition of the disclosure.

The compound represented by general formula (N-1-10) is the following compound.

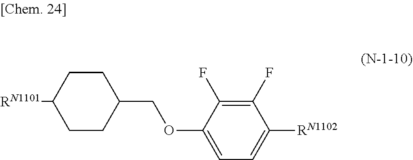

(In the formula, R^{N1101} and R^{N1102} each independently have the same meaning as R^{N11} and R^{N12} in general formula (N-1).)

R^{N1101} is preferably an alkyl group having 1 to 5 carbon atoms or an alkenyl group having 2 to 5 carbon atoms, and preferably an ethyl group, a propyl group, a butyl group, a vinyl group, or a 1-propenyl group.

R^{N1102} is preferably an alkyl group having 1 to 5 carbon atoms, an alkenyl group having 4 to 5 carbon atoms, or an alkoxy group having 1 to 4 carbon atoms. Among others, an alkoxy group having 1 to 4 carbon atoms is preferred. When R^{N1102} represents an alkoxy group, the 2,3-difluoro-1,4-phenylene group in general formula (N-1-10) is a structure bonded to the oxygen atom of the linking group (—CH₂O—) and the oxygen atom of the alkoxy group represented by R^{N1102}. The compound having such a structure can exhibit a negative dielectric constant anisotropy (Δε) and exhibit a large absolute value of the dielectric constant anisotropy. In particular, a liquid crystal composition with a negative dielectric constant anisotropy therefore can contain the above compound to increase Δε. R^{N1102} is more preferably an ethoxy group, a propoxy group, or a butoxy group among alkoxy groups having 1 to 4 carbon atoms.

The compound represented by general formula (N-1-10) can be used alone or two or more compounds may be used in combination. Any compounds can be used in combination and an appropriate combination is used depending on the required performance, such as solubility at low temperatures, transition temperature, electrical reliability, and birefringence index. In one embodiment of the disclosure, for example, one, two, three, four, five or more compounds are used.

The amount is preferably increased when improvement of Δε is important, increasing the amount is effective when solubility at low temperatures is important, and reducing the amount is effective when T_{NI} is important. Furthermore, when reduced dropping marks and improved image sticking characteristics are desired, the amount range is preferably set in the middle.

The lower limit of the amount of the compound represented by general formula (N-1-10) is preferably 5% by mass, 10% by mass, 13% by mass, 15% by mass, 17% by mass, or 20% by mass in the total amount of the liquid crystal composition of the disclosure. The upper limit of the amount is preferably 35% by mass, 30% by mass, 28% by mass, 25% by mass, 23% by mass, 20% by mass, 18% by mass, 15% by mass, or 13% by mass in the total amount of the liquid crystal composition of the disclosure.

The compound represented by general formula (N-1-10) is preferably a compound selected from a group of compounds represented by formulae (N-1-10.1) to (N-1-10.14), preferably compounds represented by formulae (N-1-10.1) to (N-1-10.5), and preferably compounds represented by formulae (N-1-10.1) and (N-1-10.2).

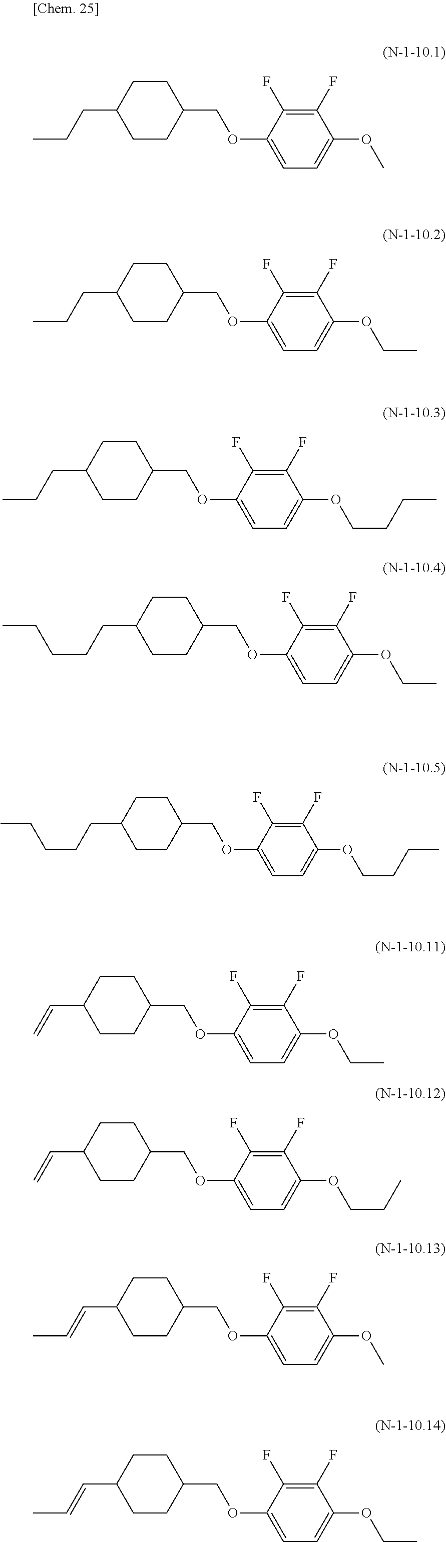

The compounds represented by formulae (N-1-10.1) and (N-1-10.2) can be used alone or may be used in combination. The lower limit of the amount of these compounds is preferably 5% by mass, 10% by mass, 13% by mass, 15% by mass, 17% by mass, or 20% by mass in the total amount of the liquid crystal composition of the disclosure. The upper limit of the amount is preferably 35% by mass, 30% by mass, 28% by mass, 25% by mass, 23% by mass, 20% by mass, 18% by mass, 15% by mass, or 13% by mass in the total amount of the liquid crystal composition of the disclosure.

The compound represented by general formula (N-1-11) is the following compound.

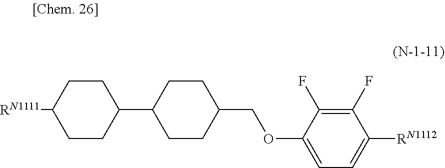

(In the formula, R^{N1111} and R^{N1112} each independently have the same meaning as R^{N11} and R^{N12} in general formula (N-1).)

R^{N1111} is preferably an alkyl group having 1 to 5 carbon atoms or an alkenyl group having 2 to 5 carbon atoms, and preferably an ethyl group, a propyl group, a butyl group, a vinyl group, or a 1-propenyl group.

R^{N1112} is preferably an alkyl group having 1 to 5 carbon atoms, an alkenyl group having 4 to 5 carbon atoms, or an alkoxy group having 1 to 4 carbon atoms. Among others, an alkoxy group having 1 to 4 carbon atoms is preferred. The reason for this is the same as the reason why it is preferable that R^{N1102} in general formula (N-1-10) above represents an alkoxy group. R^{N1112} is more preferably an ethoxy group, a propoxy group, or a butoxy group among alkoxy groups having 1 to 4 carbon atoms.

The compound represented by general formula (N-1-11) can be used alone or two or more compounds may be used in combination. Any compounds can be used in combination and an appropriate combination is used depending on the required performance, such as solubility at low temperatures, transition temperature, electrical reliability, and birefringence index. In one embodiment of the disclosure, for example, one, two, three, four, five or more compounds are used.

The amount is preferably increased when improvement of Δε is important, reducing the amount is effective when solubility at low temperatures is important, and increasing the amount is effective when T_{NI} is important. Furthermore, when reduced dropping marks and improved image sticking characteristics are desired, the amount range is preferably set in the middle.

The lower limit of the amount of the compound represented by general formula (N-1-11) is preferably 5% by mass, 10% by mass, 13% by mass, 15% by mass, 17% by mass, or 20% by mass in the total amount of the liquid crystal composition of the disclosure. The upper limit of the amount is preferably 35% by mass, 30% by mass, 28% by mass, 25% by mass, 23% by mass, 20% by mass, 18% by mass, 15% by mass, or 13% by mass in the total amount of the liquid crystal composition of the disclosure.

The compound represented by general formula (N-1-11) is preferably a compound selected from a group of compounds represented by formulae (N-1-11.1) to (N-1-11.14), preferably compounds represented by formulae (N-1-11.1) to (N-1-11.14), and preferably compounds represented by formulae (N-1-11.2) and (N-1-11.4).

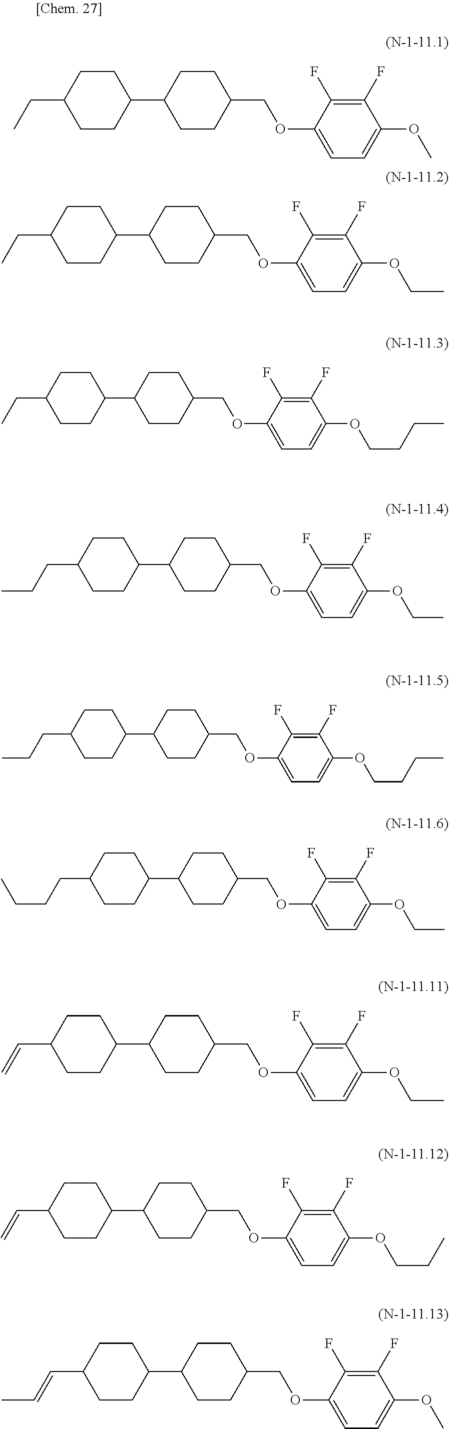

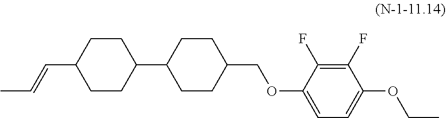

The compounds represented by formulae (N-1-11.2) and (N-1-11.4) can be used alone or may be used in combination. The lower limit of the amount of these compounds is preferably 5% by mass, 10% by mass, 13% by mass, 15% by mass, 17% by mass, or 20% by mass in the total amount of the liquid crystal composition of the disclosure. The upper limit of the amount is preferably 35% by mass, 30% by mass, 28% by mass, 25% by mass, 23% by mass, 20% by mass, 18% by mass, 15% by mass, or 13% by mass in the total amount of the liquid crystal composition of the disclosure.

The compound represented by general formula (N-1-12) is the following compound.

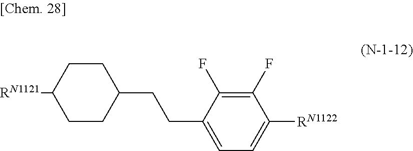

(In the formula, R^{N1121} and R^{N1122} each independently have the same meaning as R^{N11} and R^{N12} in general formula (N-1).)

R^{N1121} is preferably an alkyl group having 1 to 5 carbon atoms or an alkenyl group having 2 to 5 carbon atoms, and preferably an ethyl group, a propyl group, or a butyl group. R^{N1122} is preferably an alkyl group having 1 to 5 carbon atoms, an alkenyl group having 4 to 5 carbon atoms, or an alkoxy group having 1 to 4 carbon atoms, and preferably an ethoxy group, a propoxy group, or a butoxy group.

The compound represented by general formula (N-1-12) can be used alone or two or more compounds may be used in combination. Any compounds can be used in combination and an appropriate combination is used depending on the required performance, such as solubility at low temperatures, transition temperature, electrical reliability, and birefringence index. In one embodiment of the disclosure, for example, one, two, three, four, five or more compounds are used.

The amount is preferably increased when improvement of Δε is important, increasing the amount is effective when solubility at low temperatures is important, and reducing the amount is effective when T_{NI} is important. Furthermore, when reduced dropping marks and improved image sticking characteristics are desired, the amount range is preferably set in the middle.

The lower limit of the amount of the compound represented by general formula (N-1-12) is preferably 5% by mass, 10% by mass, 13% by mass, 15% by mass, 17% by mass, or 20% by mass in the total amount of the liquid crystal composition of the disclosure. The upper limit of the amount is preferably 35% by mass, 30% by mass, 28% by mass, 25% by mass, 23% by mass, 20% by mass, 18% by mass, 15% by mass, or 13% by mass in the total amount of the liquid crystal composition of the disclosure.

The compound represented by general formula (N-1-13) is the following compound.

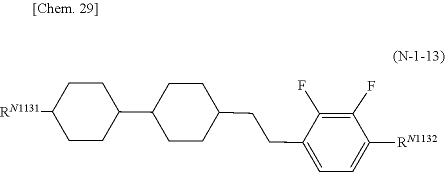

(In the formula, R^{N1131} and R^{N1132} each independently have the same meaning as R^{N11} and R^{N12} in general formula (N-1).)

R^{N1131} is preferably an alkyl group having 1 to 5 carbon atoms or an alkenyl group having 2 to 5 carbon atoms, and preferably an ethyl group, a propyl group, or a butyl group. R^{N1132} is preferably an alkyl group having 1 to 5 carbon atoms, an alkenyl group having 4 to 5 carbon atoms, or an alkoxy group having 1 to 4 carbon atoms, and preferably an ethoxy group, a propoxy group, or a butoxy group.

Any compounds can be used in combination and an appropriate combination is used depending on the required performance, such as solubility at low temperatures, transition temperature, electrical reliability, and birefringence index. In one embodiment of the disclosure, for example, one, two, three, four, five or more compounds are used.

The amount is preferably increased when improvement of Δε is important, increasing the amount is effective when solubility at low temperatures is important, and increasing the amount is effective when T_{NI} is important. Furthermore, when reduced dropping marks and improved image sticking characteristics are desired, the amount range is preferably set in the middle.

The lower limit of the amount of the compound represented by general formula (N-1-13) is preferably 5% by mass, 10% by mass, 13% by mass, 15% by mass, 17% by mass, or 20% by mass in the total amount of the liquid crystal composition of the disclosure. The upper limit of the amount is preferably 35% by mass, 30% by mass, 28% by mass, 25% by mass, 23% by mass, 20% by mass, 18% by mass, 15% by mass, or 13% by mass in the total amount of the liquid crystal composition of the disclosure.

The compound represented by general formula (N-1-14) is the following compound.

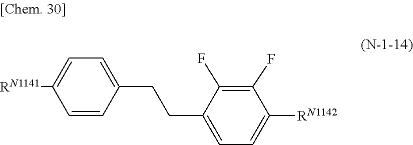

(In the formula, R^{N1141} and R^{N1142} each independently have the same meaning as R^{N11} and R^{N12} in general formula (N-1).)

R^{N1141} is preferably an alkyl group having 1 to 5 carbon atoms or an alkenyl group having 2 to 5 carbon atoms, and preferably an ethyl group, a propyl group, or a butyl group. R^{N1142} is preferably an alkyl group having 1 to 5 carbon atoms, an alkenyl group having 4 to 5 carbon atoms, or an alkoxy group having 1 to 4 carbon atoms, and preferably an ethoxy group, a propoxy group, or a butoxy group.

The compound represented by general formula (N-1-14) can be used alone or two or more compounds may be used in combination. Any compounds can be used in combination and an appropriate combination is used depending on the required performance, such as solubility at low temperatures, transition temperature, electrical reliability, and birefringence index. In one embodiment of the disclosure, for example, one, two, three, four, five or more compounds are used.

The amount is preferably increased when improvement of Δε is important, increasing the amount is effective when solubility at low temperatures is important, and reducing the amount is effective when T_{NI} is important. Furthermore, when reduced dropping marks and improved image sticking characteristics are desired, the amount range is preferably set in the middle.

The lower limit of the amount of the compound represented by general formula (N-1-14) is preferably 5% by mass, 10% by mass, 13% by mass, 15% by mass, 17% by mass, or 20% by mass in the total amount of the liquid crystal composition of the disclosure. The upper limit of the amount is preferably 35% by mass, 30% by mass, 28% by mass, 25% by mass, 23% by mass, 20% by mass, 18% by mass, 15% by mass, or 13% by mass in the total amount of the liquid crystal composition of the disclosure.

The compound represented by general formula (N-1-15) is the following compound.

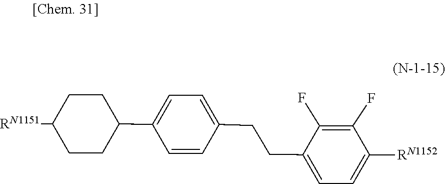

(In the formula, R^{N1151} and R^{N1152} each independently have the same meaning as R^{N11} and R^{N12} in general formula (N-1).)

R^{N1151} is preferably an alkyl group having 1 to 5 carbon atoms or an alkenyl group having 2 to 5 carbon atoms, and preferably an ethyl group, a propyl group, or a butyl group. R^{N1152} is preferably an alkyl group having 1 to 5 carbon atoms, an alkenyl group having 4 to 5 carbon atoms, or an alkoxy group having 1 to 4 carbon atoms, and preferably an ethoxy group, a propoxy group, or a butoxy group.

The compound represented by general formula (N-1-15) can be used alone or two or more compounds may be used in combination. Any compounds can be used in combination and an appropriate combination is used depending on the required performance, such as solubility at low temperatures, transition temperature, electrical reliability, and birefringence index. In one embodiment of the disclosure, for example, one, two, three, four, five or more compounds are used.

The amount is preferably increased when improvement of Δε is important, increasing the amount is effective when solubility at low temperatures is important, and increasing the amount is effective when T_{NI} is important. Furthermore, when reduced dropping marks and improved image sticking characteristics are desired, the amount range is preferably set in the middle.

The lower limit of the amount of the compound represented by formula (N-1-15) is preferably 5% by mass, 10% by mass, 13% by mass, 15% by mass, 17% by mass, or 20% by mass in the total amount of the liquid crystal composition of the disclosure. The upper limit of the amount is preferably 35% by mass, 30% by mass, 28% by mass, 25% by mass, 23% by mass, 20% by mass, 18% by mass, 15% by mass, or 13% by mass in the total amount of the liquid crystal composition of the disclosure.

The compound represented by general formula (N-1-16) is the following compound.

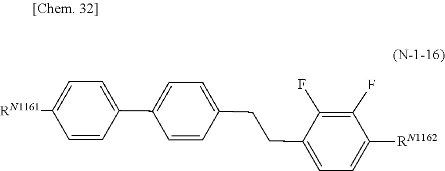

(In the formula, R^{N1161} and R^{N1162} each independently have the same meaning as R^{N11} and R^{N12} in general formula (N-1).)

R^{N1161} is preferably an alkyl group having 1 to 5 carbon atoms or an alkenyl group having 2 to 5 carbon atoms, and preferably an ethyl group, a propyl group, or a butyl group. R^{N1162} is preferably an alkyl group having 1 to 5 carbon atoms, an alkenyl group having 4 to 5 carbon atoms, or an alkoxy group having 1 to 4 carbon atoms, and preferably an ethoxy group, a propoxy group, or a butoxy group.

The compound represented by general formula (N-1-16) can be used alone or two or more compounds may be used in combination. Any compounds can be used in combination and an appropriate combination is used depending on the required performance, such as solubility at low temperatures, transition temperature, electrical reliability, and birefringence index. In one embodiment of the disclosure, for example, one, two, three, four, five or more compounds are used.

The amount is preferably increased when improvement of Δε is important, increasing the amount is effective when solubility at low temperatures is important, and increasing the amount is effective when T_{NI} is important. Furthermore, when reduced dropping marks and improved image sticking characteristics are desired, the amount range is preferably set in the middle.

The lower limit of the amount of the compound represented by formula (N-1-16) is preferably 5% by mass, 10% by mass, 13% by mass, 15% by mass, 17% by mass, or 20% by mass in the total amount of the liquid crystal composition of the disclosure. The upper limit of the amount is preferably 35% by mass, 30% by mass, 28% by mass, 25% by mass, 23% by mass, 20% by mass, 18% by mass, 15% by mass, or 13% by mass in the total amount of the liquid crystal composition of the disclosure.

The compound represented by general formula (N-1-17) is the following compound.

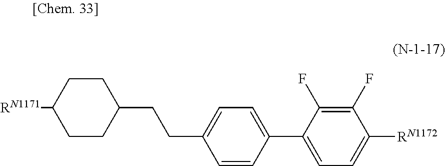

(In the formula, R^{N1171} and R^{N1172} each independently have the same meaning as R^{N11} and R^{N12} in general formula (N-1).)

R^{N1171} is preferably an alkyl group having 1 to 5 carbon atoms or an alkenyl group having 2 to 5 carbon atoms, and preferably an ethyl group, a propyl group, or a butyl group. R^{N1172} is preferably an alkyl group having 1 to 5 carbon atoms, an alkenyl group having 4 to 5 carbon atoms, or an alkoxy group having 1 to 4 carbon atoms, and preferably an ethoxy group, a propoxy group, or a butoxy group.

The compound represented by general formula (N-1-17) can be used alone or two or more compounds may be used in combination. Any compounds can be used in combination and an appropriate combination is used depending on the required performance, such as solubility at low temperatures, transition temperature, electrical reliability, and birefringence index. In one embodiment of the disclosure, for example, one, two, three, four, five or more compounds are used.

The amount is preferably increased when improvement of Δε is important, increasing the amount is effective when solubility at low temperatures is important, and increasing the amount is effective when T_{NI} is important. Furthermore, when reduced dropping marks and improved image sticking characteristics are desired, the amount range is preferably set in the middle.

The lower limit of the amount of the compound represented by formula (N-1-17) is preferably 5% by mass, 10% by mass, 13% by mass, 15% by mass, 17% by mass, or 20% by mass, 20% by mass, 18% by mass, 15% by mass, or 13% by mass in the total amount of the liquid crystal composition of the disclosure.

The compound represented by general formula (N-1-18) is the following compound.

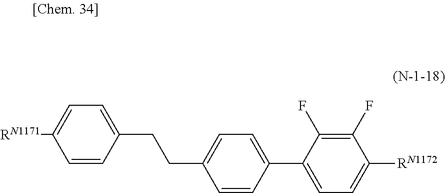

(In the formula, R^{N1181} and R^{N1182} each independently have the same meaning as R^{N11} and R^{N12} in general formula (N-1).)

R^{N1181} is preferably an alkyl group having 1 to 5 carbon atoms or an alkenyl group having 2 to 5 carbon atoms, and preferably a methyl group, an ethyl group, a propyl group, or a butyl group. R^{N1182} is preferably an alkyl group having 1 to 5 carbon atoms, an alkenyl group having 4 to 5 carbon atoms, or an alkoxy group having 1 to 4 carbon atoms, and preferably an ethoxy group, a propoxy group, or a butoxy group.

The compound represented by general formula (N-1-18) can be used alone or two or more compounds may be used in combination. Any compounds can be used in combination and an appropriate combination is used depending on the required performance, such as solubility at low temperatures, transition temperature, electrical reliability, and birefringence index. In one embodiment of the disclosure, for example, one, two, three, four, five or more compounds are used.

The amount is preferably increased when improvement of Δε is important, increasing the amount is effective when solubility at low temperatures is important, and increasing the amount is effective when T_{NI} is important. Furthermore, when reduced dropping marks and improved image sticking characteristics are desired, the amount range is preferably set in the middle.

The lower limit of the amount of the compound represented by formula (N-1-18) is preferably 5% by mass, 10% by mass, 13% by mass, 15% by mass, 17% by mass, or 20% by mass in the total amount of the liquid crystal composition of the disclosure. The upper limit of the amount is preferably 35% by mass, 30% by mass, 28% by mass, 25% by mass, 23% by mass, 20% by mass, 18% by mass, 15% by mass, or 13% by mass in the total amount of the liquid crystal composition of the disclosure.

The compound represented by general formula (N-1-18) is preferably a compound selected from a group of compounds represented by formulae (N-1-18.1) to (N-1-18.5), preferably compounds represented by formulae (N-1-18.1) to (N-1-18.3), and preferably compounds represented by formulae (N-1-18.2) and (N-1-18.3).

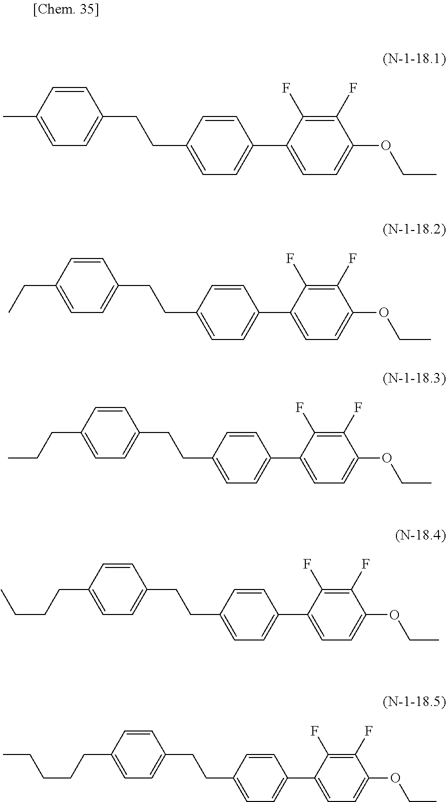

The compound represented by general formula (N-1-20) is the following compound.

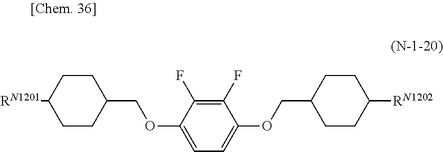

(In the formula, R^{N1201} and R^{N1202} each independently have the same meaning as R^{N11} and R^{N12} in general formula (N-1).)

R^{N1201} and R^{N1202} are preferably each independently an alkyl group having 1 to 5 carbon atoms or an alkenyl group having 2 to 5 carbon atoms, and preferably an ethyl group, a propyl group, or a butyl group.

The compound represented by general formula (N-1-20) can be used alone or two or more compounds may be used in combination. Any compounds can be used in combination and an appropriate combination is used depending on the required performance, such as solubility at low temperatures, transition temperature, electrical reliability, and birefringence index. In one embodiment of the disclosure, for example, one, two, three, four, five or more compounds are used.

The amount is preferably increased when improvement of Δε is important, increasing the amount is effective when solubility at low temperatures is important, and increasing the amount is effective when T_{NI} is important. Furthermore, when reduced dropping marks and improved image sticking characteristics are desired, the amount range is preferably set in the middle.

The lower limit of the amount of the compound represented by formula (N-1-20) is preferably 5% by mass, 10% by mass, 13% by mass, 15% by mass, 17% by mass, or 20% by mass in the total amount of the liquid crystal composition of the disclosure. The upper limit of the amount is preferably 35% by mass, 30% by mass, 28% by mass, 25% by mass, 23% by mass, 20% by mass, 18% by mass, 15% by mass, or 13% by mass in the total amount of the liquid crystal composition of the disclosure.

The compound represented by general formula (N-1-21) is the following compound.

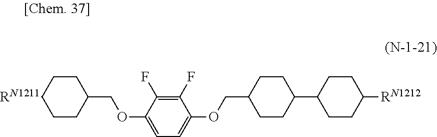

(In the formula, R^{N1211} and R^{N1212} each independently have the same meaning as R^{N11} and R^{N12} in general formula (N-1).)

R^{N1211} and R^{N1212} are preferably each independently an alkyl group having 1 to 5 carbon atoms or an alkenyl group having 2 to 5 carbon atoms, and preferably an ethyl group, a propyl group, or a butyl group.

The compound represented by general formula (N-1-21) can be used alone or two or more compounds may be used in combination. Any compounds can be used in combination and an appropriate combination is used depending on the required performance, such as solubility at low temperatures, transition temperature, electrical reliability, and birefringence index. In one embodiment of the disclosure, for example, one, two, three, four, five or more compounds are used.

The amount is preferably increased when improvement of Δε is important, increasing the amount is effective when solubility at low temperatures is important, and increasing the amount is effective when T_{NI} is important. Furthermore, when reduced dropping marks and improved image sticking characteristics are desired, the amount range is preferably set in the middle.

The lower limit of the amount of the compound represented by formula (N-1-21) is preferably 5% by mass, 10% by mass, 13% by mass, 15% by mass, 17% by mass, or 20% by mass, 20% by mass, 18% by mass, 15% by mass, or 13% by mass in the total amount of the liquid crystal composition of the disclosure.

The compound represented by general formula (N-1-22) is the following compound.

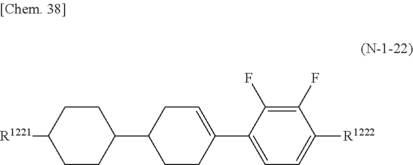

(In the formula, R^{N1221} and R^{N1222} each independently have the same meaning as R^{N11} and R^{N12} in general formula (N-1).)

R^{N1221} and R^{N1222} are preferably each independently an alkyl group having 1 to 5 carbon atoms or an alkenyl group having 2 to 5 carbon atoms, and preferably an ethyl group, a propyl group, or a butyl group.

The compound represented by general formula (N-1-22) can be used alone or two or more compounds may be used in combination. Any compounds can be used in combination and an appropriate combination is used depending on the required performance, such as solubility at low temperatures, transition temperature, electrical reliability, and birefringence index. In one embodiment of the disclosure, for example, one, two, three, four, five or more compounds are used.

The amount is preferably increased when improvement of Δε is important, increasing the amount is effective when solubility at low temperatures is important, and increasing the amount is effective when T_{NI} is important. Furthermore, when reduced dropping marks and improved image sticking characteristics are desired, the amount range is preferably set in the middle.

The lower limit of the amount of the compound represented by formula (N-1-21) is preferably 1% by mass, 5% by mass, 10% by mass, 13% by mass, 15% by mass, 17% by mass, or 20% by mass in the total amount of the liquid crystal composition of the disclosure. The upper limit of the amount is preferably 35% by mass, 30% by mass, 28% by mass, 25% by mass, 23% by mass, 20% by mass, 18% by mass, 15% by mass, 13% by mass, 10% by mass, or 5% by mass in the total amount of the liquid crystal composition of the disclosure.

The compound represented by general formula (N-1-22) is preferably a compound selected from a group of compounds represented by formulae (N-1-22.1) to (N-1-22.12), preferably compounds represented by formulae (N-1-22.1) to (N-1-22.5), and preferably compounds represented by formulae (N-1-22.1) to (N-1-22.4).

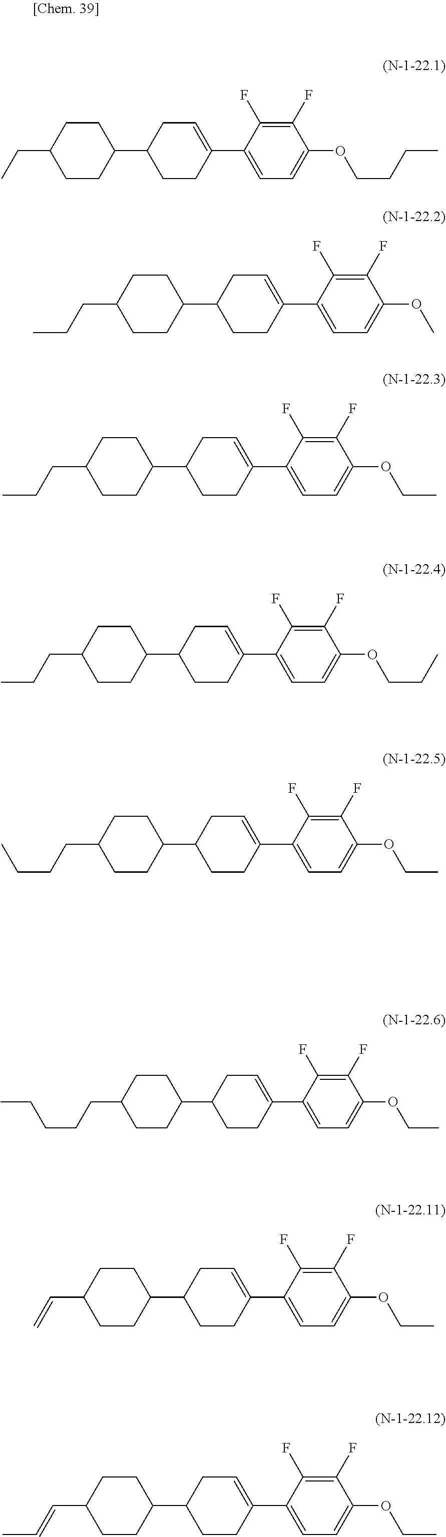

[2] Second Mode of Compound Represented by General Formula (II)

The second mode of the compound represented by general formula (II) (hereinafter referred to as the compound in the second mode) is a nonpolar liquid crystal compound with a dielectric constant anisotropy of approximately zero. The compound in the second mode preferably has a value of dielectric constant anisotropy (Δε) of −2 or more and 2 or less at 25° C.

The compound in the second mode can be a compound represented by the following general formula (L). More specifically, it is preferable that the liquid crystal composition of the disclosure contains one or two or more compounds represented by general formula (L).

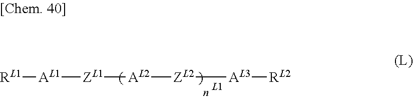

(In the formula, R^{L1} and R^{L2} each independently represent an alkyl group having 1 to 8 carbon atoms, one or two or more nonadjacent —CH₂—'s in the alkyl group are each independently optionally substituted with —CH═CH—, —O—, —CO—, —COO—, or —OCO—,

n^{L1} represents 0, 1, 2, or 3,

A^{L1}, A^{L2}, and A^{L3} each independently represent a group selected from the group consisting of
(a) a 1,4-cyclohexylene group (in which one —CH₂— or two or more nonadjacent —CH₂—'s are optionally substituted with —O—),
(b) a 1,4-phenylene group (in which one —CH═ or two or more nonadjacent —CH═'s are optionally substituted with —N═), and
(c) a naphthalene-2,6-diyl group, a 1,2,3,4-tetrahydronaphthalene-2,6-diyl group, or a decahydronaphthalene-2,6-diyl group (one —CH═ or two or more nonadjacent —CH═'s present in the naphthalene-2,6-diyl group or the 1,2,3,4-tetrahydronaphthalene-2,6-diyl group are optionally substituted with —N═),

the group (a), the group (b), and the group (c) are each independently optionally substituted with a cyano group, a fluorine atom, or a chlorine atom,

Z^{L1} and Z^{L2} each independently represent a single bond, —CH₂CH₂—, —(CH₂)₄—, —OCH₂—, —CH₂O—, —COO—, —OCO—, —OCF₂—, —CF₂O—, —CH═N—N═CH—, —CH═CH—, —CF═CF—, or —C≡C—,

when n^{L1} is 2 or 3 and there are a plurality of A^{L2}s, they may be the same or different, and when n^{L1} is 2 or 3 and there are a plurality of Z's, they may be the same or different.

However, compounds represented by general formulae (N-1), (N-2), and (N-3) are excluded.)

The compound represented by general formula (L) falls into dielectrically substantially neutral compounds (the value of Δε is −2 or more and 2 or less at 25° C.). In the compound represented by general formula (L), therefore, the number of polar groups such as halogens in the molecule is preferably two or less, preferably one or less, and the compound preferably has no polar groups such as halogens.

The compound represented by general formula (L) can be used alone or may be used in combination. Any compounds can be used in combination and an appropriate combination is used depending on the desired performance, such as solubility at low temperatures, transition temperature, electrical reliability, and birefringence index. For example, one, two, three, four, five, six, seven, eight, nine, or ten or more compounds are used.

The amount of the compound represented by general formula (L) needs to be adjusted as appropriate depending on the required performance, such as solubility at low temperatures, transition temperature, electrical reliability, birefringence index, process compatibility, dropping marks, image sticking, and dielectric constant anisotropy. The lower limit of the amount of the compound represented by general formula (L) is preferably 1% by mass, 10% by mass, 20% by mass, 30% by mass, 40% by mass, 50% by mass, 55% by mass, 60% by mass, 65% by mass, 70% by mass, 75% by mass, or 80% by mass in the total amount of the liquid crystal composition of the disclosure. The upper limit of the amount of the compound represented by general formula (L) is preferably 95% by mass, 85% by mass, 75% by mass, 65% by mass, 55% by mass, 45% by mass, 35% by mass, or 25% by mass in the total amount of the liquid crystal composition of the disclosure.

When a low viscosity and a high response speed are required for the liquid crystal composition of the disclosure, it is preferable that the lower limit of the amount of the compound represented by general formula (L) is high and the upper limit thereof is high. When a high Tni and high temperature stability are required for the liquid crystal composition of the disclosure, it is preferable that the lower limit of the amount of the compound represented by general formula (L) is high and the upper limit thereof is high. When a larger dielectric constant anisotropy is desired to keep the drive voltage low, it is preferable that the lower limit of the amount of the compound represented by general formula (L) is low and the upper limit thereof is low.

R^{L1} and R^{L2} are preferably both alkyl groups when reliability is important, and preferably alkoxy groups when reducing volatility of the compound is important, and at least one of them is preferably an alkenyl group when reducing viscosity is important.

When the ring structure of A^{L1} and A^{L3} to which R^{L1} and R^{L2} are bonded, respectively, is a phenyl group (aromatic), it is preferable that R^{L1} and R^{L2} are each independently a linear alkyl group having 1 to 5 carbon atoms, a linear alkoxy group having 1 to 4 carbon atoms, or an alkenyl group having 4 to 5 carbon atoms. When the ring structure of A^{L1} and A^{L3} to which R^{L1} and R^{L2} are bonded, respectively, is a saturated ring structure such as cyclohexane, pyran, and dioxane, it is preferable that R^{L1} and R^{L2} are each independently a linear alkyl group having 1 to 5 carbon atoms, a linear alkoxy group having 1 to 4 carbon atoms, or a linear alkenyl group having 2 to 5 carbon atoms. To stabilize the nematic phase, R^{L1} and R^{L2} preferably each independently have a total of 5 or less carbon and oxygen atoms and, in this case, they are preferably linear.

The alkenyl group is preferably selected from the groups represented by any of formulae (R1) to (R5) described in “[1] First Mode of Compound Represented by General Formula (II)”.

n^{L1} is preferably 0 when response speed is important, preferably 2 or 3 in order to improve the upper limit temperature of the nematic phase, and preferably 1 in order to balance them. In order to meet the characteristics required for liquid crystal compositions, it is preferable to combine compounds represented by general formula (L) with different values of nu.

A^{L1}, A^{L2}, and A^{L3} are preferably aromatic when a larger Δn is required, preferably aliphatic in order to improve response speed, and preferably each independently represent a trans-1,4-cyclohexylene group, a 1,4-phenylene group, a 2-fluoro-1,4-phenylene group, a 3-fluoro-1,4 phenylene group, a 3,5-difluoro-1,4-phenylene group, a 1,4-cyclohexenylene group, a decahydronaphthalene-2,6-diyl group, or a 1,2,3,4-tetrahydronaphthalene-2,6-diyl group.

Among those, A^{L1}, A^{L2}, and A^{L3} more preferably each independently represent the following structure, and more preferably represent a trans-1,4-cyclohexylene group or a 1,4-phenylene group.

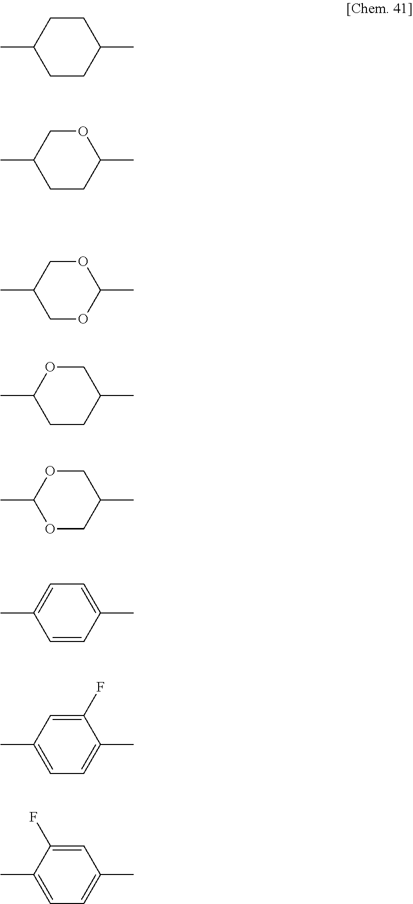

Z^{L1} and Z^{L2} are preferably single bonds when response speed is important.

In the compound represented by general formula (L), the number of halogen atoms present in the molecule is preferably 0, 1, 2, or 3, preferably 0 or 1, and preferably 1 when compatibility with other liquid crystal molecules is important.

It is preferable that the liquid crystal composition of the disclosure contains one or two or more compounds represented by general formula (L-1A) as a compound represented by general formula (L).

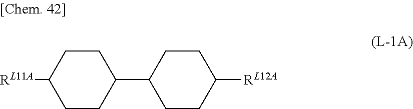

(In general formula (L-1A), R^{i1A} and R^{i2A} each independently represent an alkyl group having 1 to 8 carbon atoms, one or two or more nonadjacent —CH₂—'s in the alkyl group are each independently optionally substituted with —CH═CH—, —O—, —CO—, —COO—, or —OCO—, wherein, in at least one of R^{i1A} and R^{i2A}, one or two or more nonadjacent —CH₂—'s in the alkyl group are each independently substituted with —CH═CH—.)

In the compound represented by general formula (L-1A), at least one of R^{i1A} and R^{i2A} represents a group in which one or two or more nonadjacent —CH₂—'s in the alkyl group are each independently substituted with —CH═CH—. More specifically, in the compound represented by general formula (L-1A), at least one of R′ and R^{i2A} represents an alkenyl group having 2 to 8 carbon atoms.

Among those, at least one of R^{i1A} and R^{i2A} is preferably represented by any of the above formulae (R1) to (R5). Only one of R^{i1A} and R^{i2A} may be an alkenyl group, or both R^{i1A} and R^{i2A} may be alkenyl groups. When R^{i1A} and R^{i2A} are both alkenyl groups, R^{i1A} and R^{i2A} may be the same or different.

Among those, at least one of R^{i1A} and R^{i2A} preferably represents an alkenyl group having 2 to 5 carbon atoms.

It is preferable that the liquid crystal composition of the disclosure contains at least one of compounds represented by general formula (L-1A). The liquid crystal composition of the disclosure may contain two or more compounds in combination. Any compounds can be used in combination and an appropriate combination is used depending on the required performance, such as solubility at low temperatures, transition temperature, electrical reliability, and birefringence index. For example, one, two, three, four, five or more compounds are used.

The lower limit of the amount of the compound represented by general formula (L-1A) is preferably 1% by mass, 2% by mass, 3% by mass, 5% by mass, 7% by mass, 10% by mass, 15% by mass, 20% by mass, 25% by mass, 30% by mass, 35% by mass, 40% by mass, 45% by mass, 50% by mass, or 55% by mass in the total amount of the liquid crystal composition of the disclosure. The upper limit of the amount is preferably 70% by mass, 65% by mass, 60% by mass, 55% by mass, 50% by mass, 45% by mass, 40% by mass, 35% by mass, 30% by mass, or 25% by mass in the total amount of the liquid crystal composition of the disclosure.

The compound represented by general formula (L-1A) is preferably a compound selected from a group of compounds represented by general formula (L-1A-1).

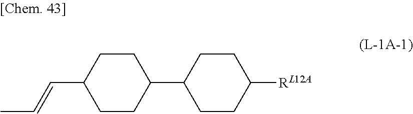

(In the formula, R^{L12A} has the same meaning as in general formula (L-1A).)

The compound represented by general formula (L-1A-1) is preferably a compound selected from a group of compounds represented by formulae (L-1A-1.1) to (L-1A-1.3), preferably a compound represented by formula (L-1A-1.2) or (L-1A-1.3), and particularly preferably a compound represented by formula (L-1A-1.3).

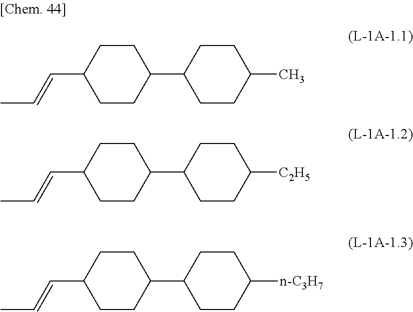

The preferred lower limit of the amount of the compound represented by formula (L-1A-1) is 1% by mass, 2% by mass, 3% by mass, 5% by mass, 7% by mass, or 10% by mass in the total amount of the liquid crystal composition of the disclosure. The preferred upper limit of the amount is 20% by mass, 15% by mass, 13% by mass, 10% by mass, 8% by mass, 7% by mass, 6% by mass, 5% by mass, or 3% by mass in the total amount of the liquid crystal composition of the disclosure. Among those, it is preferable that the compound represented by formula (L-1A-3) is contained within the range of the above lower and upper limits.

The compound represented by general formula (L-1A) is preferably a compound selected from a group of compounds represented by general formula (L-1A-2).

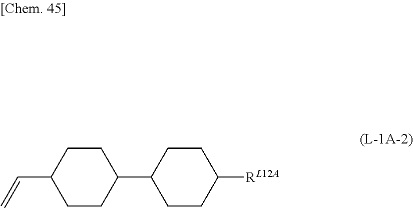

(In the formula, R^{L12A} has the same meaning as in general formula (L-1A).)

The lower limit of the amount of the compound represented by formula (L-1A-2) is preferably 1% by mass, 5% by mass, 10% by mass, 15% by mass, 17% by mass, 20% by mass, 23% by mass, 25% by mass, 27% by mass, 30% by mass, or 35% by mass in the total amount of the liquid crystal composition of the disclosure. The upper limit of the amount is preferably 60% by mass, 55% by mass, 50% by mass, 45% by mass, 42% by mass, 40% by mass, 38% by mass, 35% by mass, 33% by mass, or 30% by mass in the total amount of the liquid crystal composition of the disclosure.

The compound represented by general formula (L-1A-2) is preferably a compound selected from a group of compounds represented by formulae (L-1A-2.1) to (L-1A-2.4), and preferably compounds represented by formulae (L-1A-2.2) to (L-1A-2.4). In particular, the compound represented by formula (L-1A-2.2) is preferred because it particularly improves the response speed of the liquid crystal composition of the disclosure. When a higher Tni is required rather than the response speed, it is preferable to use a compound represented by formula (L-1A-2.3) or (L-1A-2.4). It is not preferable to set the amount of compounds represented by formulae (L-1A-2.3) and (L-1A-2.4) to 30% by mass or more to improve the solubility at low temperatures.

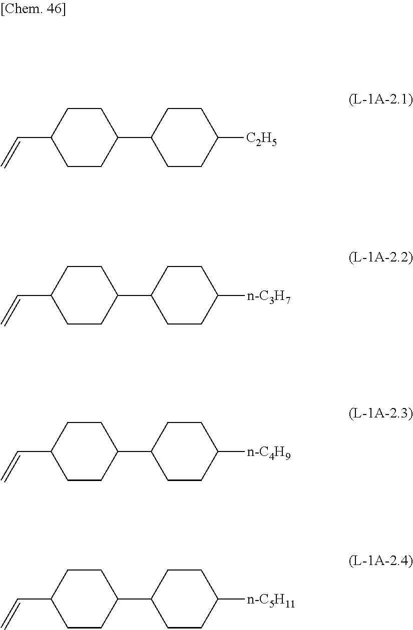

When the liquid crystal composition of the disclosure contains the compound represented by formula (L-1A-2.2), the lower limit of the amount of the compound represented by (L-1A-2.2) is preferably 10% by mass, 15% by mass, 18% by mass, 20% by mass, 23% by mass, 25% by mass, 27% by mass, 30% by mass, 33% by mass, 35% by mass, 38% by mass, or 40% by mass in the total amount of the liquid crystal composition of the disclosure. The upper limit of the amount is preferably 60% by mass, 55% by mass, 50% by mass, 45% by mass, 43% by mass, 40% by mass, 38% by mass, 35% by mass, 32% by mass, 30% by mass, 27% by mass, 25% by mass, or 22% by mass in the total amount of the liquid crystal composition of the disclosure.

It is preferable that the liquid crystal composition of the disclosure contains a compound represented by general formula (L-1A-1.3) and a compound represented by general formula (L-1A-2.2) at the same time. The lower limit of the amount of the compound represented by general formula (L-1A-1.3) and the compound represented by formula (L-1A-2.2) is preferably 10% by mass, 15% by mass, 20% by mass, 25% by mass, 27% by mass, 30% by mass, 35% by mass, or 40% by mass in the total amount of the liquid crystal composition of the disclosure. The upper limit of the amount is preferably 60% by mass, 55% by mass, 50% by mass, 45% by mass, 43% by mass, 40% by mass, 38% by mass, 35% by mass, 32% by mass, 30% by mass, 27% by mass, 25% by mass, or 22% by mass in the total amount of the liquid crystal composition of the disclosure.

The compound represented by general formula (L-1A) is preferably a compound selected from a group of compounds represented by general formulae (L-1A-4) and (L-1A-5).

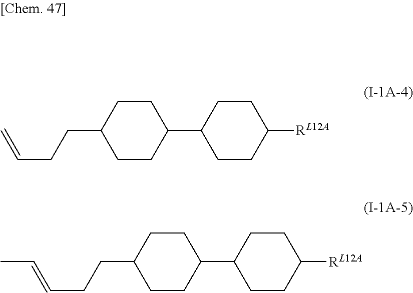

(In the formulae, R^{L12A} has the same meaning as in general formula (L-1A).)

In general formulae (L-1A-4) and (L-1A-5), R^{L12A} is preferably an alkyl group having 1 to 8 carbon atoms, an alkoxy group having 1 to 8 carbon atoms, or an alkenyl group having 2 to 8 carbon atoms, and preferably a linear alkyl group having 1 to 5 carbon atoms, a linear alkoxy group having 1 to 4 carbon atoms, and a linear alkenyl group having 2 to 5 carbon atoms.

The lower limit of the amount of the compound represented by general formula (L-1A-4) is preferably 1% by mass, 5% by mass, 10% by mass, 13% by mass, 15% by mass, 17% by mass, or 20% by mass in the total amount of the liquid crystal composition of the disclosure. The upper limit of the amount is preferably 25% by mass, 23% by mass, 20% by mass, 17% by mass, 15% by mass, 13% by mass, or 10% by mass in the total amount of the liquid crystal composition of the disclosure.

The lower limit of the amount of the compound represented by general formula (L-1A-5) is preferably 1% by mass, 5% by mass, 10% by mass, 13% by mass, 15% by mass, 17% by mass, or 20% by mass in the total amount of the liquid crystal composition of the disclosure. The upper limit of the amount is preferably 25% by mass, 23% by mass, 20% by mass, 17% by mass, 15% by mass, 13% by mass, or 10% by mass in the total amount of the liquid crystal composition of the disclosure.

The compounds represented by general formulae (L-1A-4) and (L-1A-5) are preferably compounds selected from a group of compounds represented by formulae (L-1A-4.1) to (L-1A-5.3), and preferably compounds represented by formula (L-1A-4.2) or (L-1A-5.2).

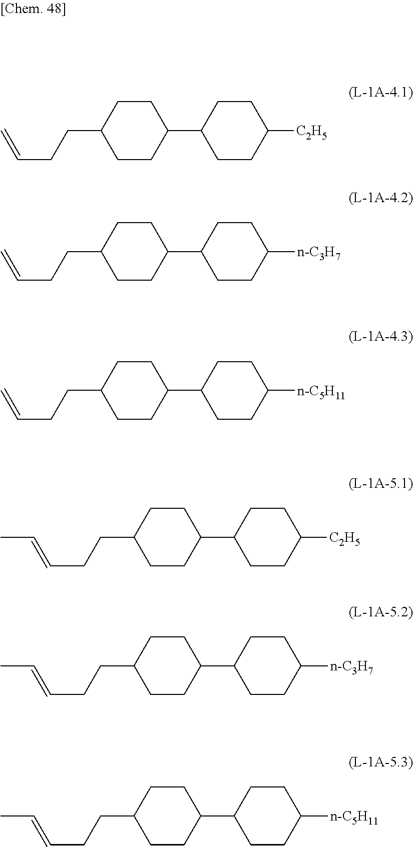

When the liquid crystal composition of the disclosure contains a compound represented by formula (L-1A-4.2), the lower limit of the amount of the compound represented by formula (L-1A-4.2) is preferably 1% by mass, 2% by mass, 3% by mass, 5% by mass, 7% by mass, 10% by mass, 13% by mass, 15% by mass, 18% by mass, or 20% by mass in the total amount of the liquid crystal composition of the disclosure. The upper limit of the amount is preferably 20% by mass, 17% by mass, 15% by mass, 13% by mass, 10% by mass, 8% by mass, 7% by mass, or 6% by mass in the total amount of the liquid crystal composition of the disclosure.

The compound represented by general formula (L-1A) is preferably a compound selected from a group of compounds represented by general formula (L-1A-6).

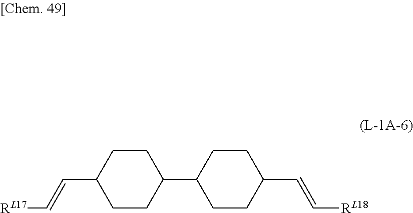

(In the formula, R^{L17} and R^{L18} each independently represent a methyl group or a hydrogen atom.)

The lower limit of the amount of the compound represented by formula (L-1A-6) is preferably 1% by mass, 5% by mass, 10% by mass, 15% by mass, 17% by mass, 20% by mass, 23% by mass, 25% by mass, 27% by mass, 30% by mass, or 35% by mass in the total amount of the liquid crystal composition of the disclosure. The upper limit of the amount is preferably 60% by mass, 55% by mass, 50% by mass, 45% by mass, 42% by mass, 40% by mass, 38% by mass, 35% by mass, 33% by mass, or 30% by mass in the total amount of the liquid crystal composition of the disclosure.

The compound represented by general formula (L-1A-6) is preferably a compound selected from a group of compounds represented by general formulae (L-1A-6.1) to (L-1A-6.3).

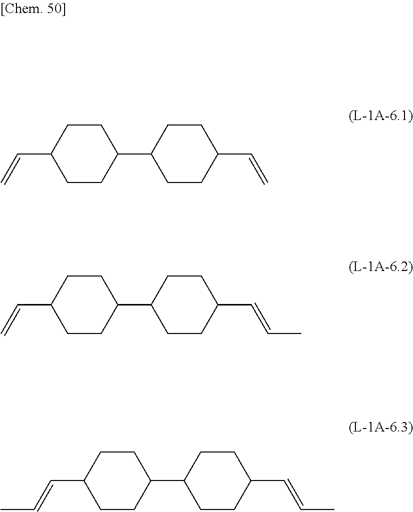

It is preferable that the liquid crystal composition of the disclosure contains one or two or more compounds selected from a group of compounds represented by general formula (L-1B) and general formulae (L-2) to (L-7), in addition to the compound represented by general formula (L-1A), as a compound represented by general formula (L).

The compound represented by general formula (L-1B) is the following compound.

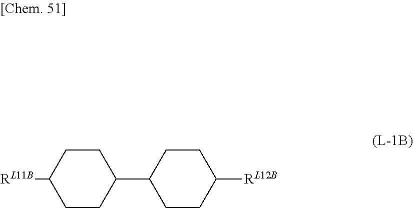

(In the formula, R^{L11B} and R^{L12B} each independently represent an alkyl group having 1 to 8 carbon atoms, and one or two or more nonadjacent —CH₂—'s in the alkyl group are each independently optionally substituted with —C≡C—, —O—, —CO—, —COO—, or —OCO—)

The compound represented by general formula (L-1B) is distinguished from the compound represented by general formula (L-1A) in that one or both of R^{L11B} and R^{L12B} do not represent alkenyl groups.

R^{L11B} and R^{L12B} are each preferably a linear alkyl group having 1 to 5 carbon atoms or a linear alkoxy group having 1 to 4 carbon atoms.

The liquid crystal composition of the disclosure may contain one of compounds represented by general formula (L-1B) or a combination of two or more. Any compounds can be used in combination and an appropriate combination is used depending on the required performance, such as solubility at low temperatures, transition temperature, electrical reliability, and birefringence index. For example, one, two, three, four, five or more compounds are used.

The lower limit of the amount of the compound represented by formula (L-1B) is preferably 1% by mass, 5% by mass, 10% by mass, 13% by mass, 15% by mass, 17% by mass, 20% by mass, 23% by mass, 25% by mass, or 30% by mass in the total amount of the liquid crystal composition of the disclosure. The upper limit of the amount is preferably 60% by mass, 55% by mass, 50% by mass, 45% by mass, 40% by mass, 37% by mass, 35% by mass, 33% by mass, 30% by mass, 27% by mass, 25% by mass, 23% by mass, 20% by mass, 17% by mass, 15% by mass, 13% by mass, or 10% by mass in the total amount of the liquid crystal composition of the disclosure.

The compound represented by general formula (L-1B) is preferably a compound selected from a group of compounds represented by formulae (L-1B-1) to (L-1B-13), and preferably a compound selected from a group of compounds represented by formulae (L-1B-1), (L-1B-3), and (L-1B-4). In particular, the compound represented by formula (L-1B-1) is preferred because it particularly improves the response speed of the liquid crystal composition of the disclosure. When a higher Tni is required rather than the response speed, it is preferable to use a compound selected from a group of compounds represented by formulae (L-1B-3), (L-1B-4), (L-1B-11), and (L-1B-12). It is not preferable to set the total amount of compounds represented by formulae (L-1B-3), (L-1B-4), (L-1B-11), and (L-1B-13) to 20% by mass or more to improve the solubility at low temperatures.

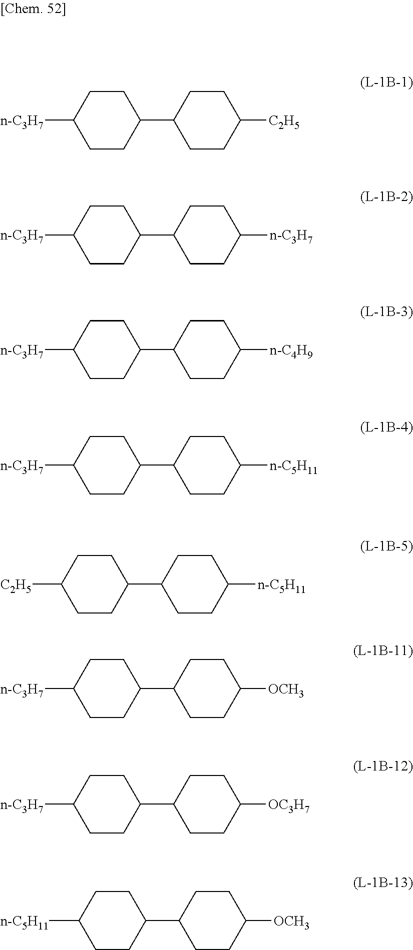

When the liquid crystal composition of the disclosure contains the compound represented by formula (L-1B-1), the lower limit of the amount of the compound represented by formula (L-1B-1) is preferably 1% by mass, 2% by mass, 3% by mass, 5% by mass, 7% by mass, 10% by mass, 13% by mass, 15% by mass, 18% by mass, or 20% by mass in the total amount of the liquid crystal composition of the disclosure. The upper limit of the amount is preferably 20% by mass, 17% by mass, 15% by mass, 13% by mass, 10% by mass, 8% by mass, 7% by mass, or 6% by mass in the total amount of the liquid crystal composition of the disclosure.

It is preferable that the liquid crystal composition of the disclosure contains a combination of two or more compounds selected from a group of compounds represented by formulae (L-1A-1.3), (L-1A-2.2), (L-1B-1), (L-1B-3), (L-1B-4), (L-1B-11), and (L-1B-12). It is also preferable that the liquid crystal composition of the disclosure contains a combination of two or more compounds selected from compounds represented by formulae (L-1A-1.3), (L-1A-2.2), (L-1B-1), (L-1B-3), (L-1B-4), and (L-1A-4.2). The lower limit of the total amount of these compounds is preferably 1% by mass, 2% by mass, 3% by mass, 5% by mass, 7% by mass, 10% by mass, 13% by mass, 15% by mass, 18% by mass, 20% by mass, 23% by mass, 25% by mass, 27% by mass, 30% by mass, 33% by mass, or 35% by mass in the total amount of the liquid crystal composition of the disclosure. The upper limit of the amount is preferably 80% by mass, 70% by mass, 60% by mass, 50% by mass, 45% by mass, 40% by mass, 37% by mass, 35% by mass, 33% by mass, 30% by mass, 28% by mass, 25% by mass, 23% by mass, or 20% by mass in the total amount of the liquid crystal composition of the disclosure.

When the reliability of the liquid crystal composition is important, it is preferable to combine two or more compounds selected from the compounds represented by formulae (L-1B-1), (L-1B-3), and (L-1B-4). When the response speed of the liquid crystal composition is important, it is preferable to combine two or more compounds selected from the compounds represented by formulae (L-1A-1.3) and (L-1A-2.2).

It is preferable that the liquid crystal composition of the disclosure contains one or more compounds represented by general formula (L-1A) and one or more compounds represented by general formula (L-1B). The lower limit of the total amount of the compound represented by general formula (L-1A) and the compound represented by general formula (L-1B) is preferably 1% by mass, 2% by mass, 3% by mass, 5% by mass, 7% by mass, 10% by mass, 15% by mass, 20% by mass, 25% by mass, 30% by mass, 35% by mass, 40% by mass, 45% by mass, 50% by mass, or 55% by mass in the total amount of the liquid crystal composition of the disclosure. The upper limit of the amount is preferably 95% by mass, 90% by mass, 85% by mass, 80% by mass, 75% by mass, 70% by mass, 65% by mass, 60% by mass, 55% by mass, 50% by mass, 45% by mass, 40% by mass, 35% by mass, 30% by mass, or 25% by mass in the total amount of the liquid crystal composition of the disclosure.

When a low viscosity and a high response speed are required for the liquid crystal composition of the disclosure, it is preferable that the lower limit of the total amount of the compound represented by general formula (L-1A) and the compound represented by general formula (L-1B) is high and the upper limit thereof is high. When a high Tni and high temperature stability are required for the liquid crystal composition of the disclosure, it is preferable that the lower limit of the total amount of the compound represented by general formula (L-1A) and the compound represented by general formula (L-1B) is intermediate and the upper limit thereof is intermediate. When a larger dielectric constant anisotropy is desired to keep the drive voltage low, it is preferable that the lower limit of the total amount of the compound represented by general formula (L-1A) and the compound represented by general formula (L-1B) is low and the upper limit thereof is low.

The compound represented by general formula (L-2) is the following compound.

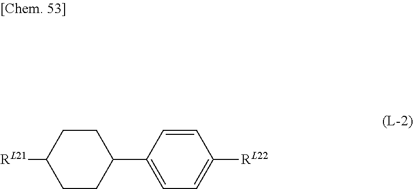

(In the formula, R^{L21} and R^{L22} each independently have the same meaning as R^{L1} and R^{L2} in general formula (L).)

R^{L21} is preferably an alkyl group having 1 to 5 carbon atoms or an alkenyl group having 2 to 5 carbon atoms. R^{L22} is preferably an alkyl group having 1 to 5 carbon atoms, an alkenyl group having 4 to 5 carbon atoms, or an alkoxy group having 1 to 4 carbon atoms, and it is preferable that the unsaturated bond of the alkenyl group and benzene are not directly bonded.

The compound represented by general formula (L-2) can be used alone or two or more compounds may be used in combination. Any compounds can be used in combination and an appropriate combination is used depending on the required performance, such as solubility at low temperatures, transition temperature, electrical reliability, and birefringence index. In one embodiment of the disclosure, for example, one, two, three, four, five or more compounds are used.

Increasing the amount is effective when solubility at low temperatures is important, and conversely, reducing the amount is effective when response speed is important. Furthermore, when reduced dropping marks and improved image sticking characteristics are desired, the amount range is preferably set in the middle.

The lower limit of the amount of the compound represented by formula (L-2) is preferably 1% by mass, 2% by mass, 3% by mass, 5% by mass, 7% by mass, or 10% by mass in the total amount of the liquid crystal composition of the disclosure. The upper limit of the amount is preferably 20% by mass, 15% by mass, 13% by mass, 10% by mass, 8% by mass, 7% by mass, 6% by mass, 5% by mass, or 3% by mass in the total amount of the liquid crystal composition of the disclosure.

The compound represented by general formula (L-2) is preferably a compound selected from a group of compounds represented by formulae (L-2.1) to (L-2.6), and preferably compounds represented by formulae (L-2.1), (L-2.3), (L-2.4), and (L-2.6).

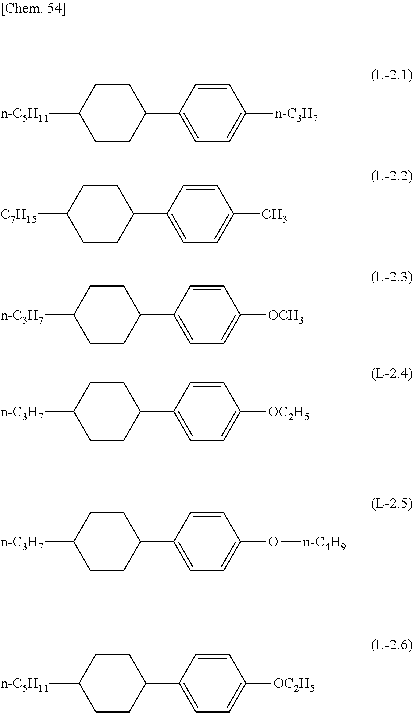

The compound represented by general formula (L-3) is the following compound.

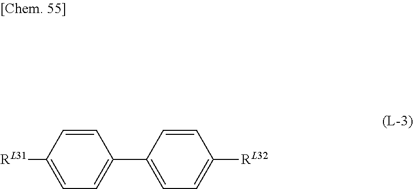

(In the formula, R^{L31} and R^{L32} each independently have the same meaning as R^{L1} and R^{L2} in general formula (L).)

R^{L31} and R^{L32} are preferably each independently an alkyl group having 1 to 5 carbon atoms, an alkenyl group having 4 to 5 carbon atoms, or an alkoxy group having 1 to 4 carbon atoms. It is preferable that the unsaturated bond of the alkenyl group and benzene are not directly bonded.

The compound represented by general formula (L-3) can be used alone or two or more compounds may be used in combination. Any compounds can be used in combination and an appropriate combination is used depending on the required performance, such as solubility at low temperatures, transition temperature, electrical reliability, and birefringence index. In one embodiment of the disclosure, for example, one, two, three, four, five or more compounds are used.

The lower limit of the amount of the compound represented by formula (L-3) is preferably 1% by mass, 2% by mass, 3% by mass, 5% by mass, 7% by mass, or 10% by mass in the total amount of the liquid crystal composition of the disclosure. The upper limit of the amount is preferably 20% by mass, 15% by mass, 13% by mass, 10% by mass, 8% by mass, 7% by mass, 6% by mass, 5% by mass, or 3% by mass in the total amount of the liquid crystal composition of the disclosure.

Increasing the amount is effective when a high birefringence index is desired, and conversely, reducing the amount is effective when a high Tni is important. Furthermore, when reduced dropping marks and improved image sticking characteristics are desired, the amount range is preferably set in the middle.

The compound represented by general formula (L-3) is preferably a compound selected from a group of compounds represented by formulae (L-3.1) to (L-3.7), and preferably compounds represented by formulae (L-3.2) to (L-3.5).

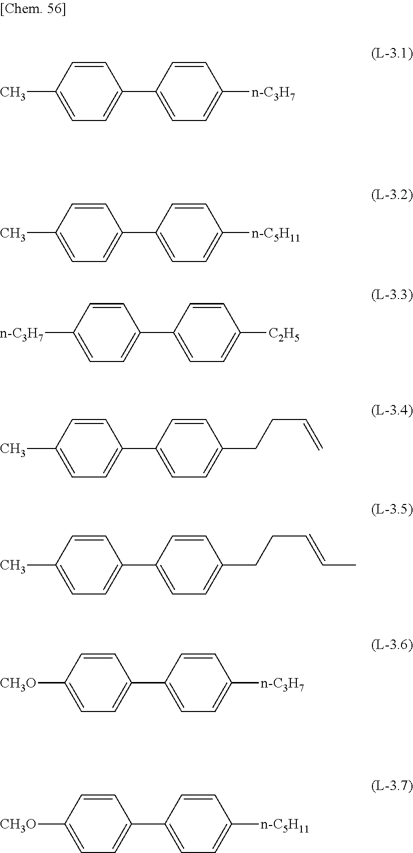

The compound represented by general formula (L-4) is the following compound.

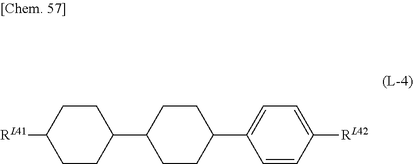

(In the formula, R^{L41} and R^{L42} each independently have the same meaning as R^{L1} and R^{L2} in general formula (L).)

R^{L41} is preferably an alkyl group having 1 to 5 carbon atoms or an alkenyl group having 2 to 5 carbon atoms, and R^{L42} is preferably an alkyl group having 1 to 5 carbon atoms, an alkenyl group having 4 to 5 carbon atoms, or an alkoxy group having 1 to 4 carbon atoms. It is preferable that the unsaturated bond of the alkenyl group and benzene are not directly bonded.

The compound represented by general formula (L-4) can be used alone or two or more compounds may be used in combination. Any compounds can be used in combination and an appropriate combination is used depending on the required performance, such as solubility at low temperatures, transition temperature, electrical reliability, and birefringence index. In one embodiment of the disclosure, for example, one, two, three, four, five or more compounds are used.

In the liquid crystal composition of the disclosure, the amount of the compound represented by general formula (L-4) needs to be adjusted as appropriate depending on the required performance, such as solubility at low temperatures, transition temperature, electrical reliability, birefringence index, process compatibility, dropping marks, image sticking, and dielectric constant anisotropy.

The lower limit of the amount of the compound represented by general formula (L-4) is preferably 1% by mass, 2% by mass, 3% by mass, 5% by mass, 7% by mass, 10% by mass, 14% by mass, 16% by mass, 20% by mass, 23% by mass, 26% by mass, 30% by mass, 35% by mass, or 40% by mass in the total amount of the liquid crystal composition of the disclosure. The upper limit of the amount is preferably 50% by mass, 40% by mass, 35% by mass, 30% by mass, 20% by mass, 15% by mass, 10% by mass, or 5% by mass in the total amount of the liquid crystal composition of the disclosure.

The compound represented by general formula (L-4) is preferably compounds represented by general formulae (L-4.1) to (L-4.3).

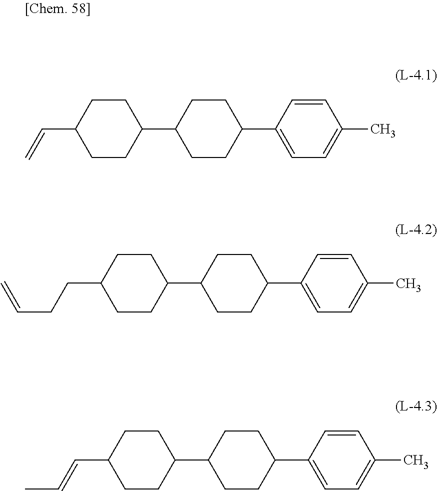

Depending on the required performance, such as solubility at low temperatures, transition temperature, electrical reliability, and birefringence index, the compound represented by formula (L-4.1) may be contained, the compound represented by formula (L-4.2) may be contained, both of the compound represented by formula (L-4.1) and the compound represented by formula (L-4.2) may be contained, or all of the compounds represented by formulae (L-4.1) to (L-4.3) may be contained. The lower limit of the amount of the compound represented by formula (L-4.1) or (L-4.2) is preferably 3% by mass, 5% by mass, 7% by mass, 9% by mass, 11% by mass, 12% by mass, 13% by mass, 18% by mass, or 21% by mass in the total amount of the liquid crystal composition of the disclosure, and the preferred upper limit is 45, 40% by mass, 35% by mass, 30% by mass, 25% by mass, 23% by mass, 20% by mass, 18% by mass, 15% by mass, 13% by mass, 10% by mass, or 8% by mass.

When both of the compound represented by formula (L-4.1) and the compound represented by formula (L-4.2) are contained, the lower limit of the total amount of these compounds is preferably 15% by mass, 19% by mass, 24% by mass, or 30% by mass in the total amount of the liquid crystal composition of the disclosure, and the upper limit of the total amount is preferably 45, 40% by mass, 35% by mass, 30% by mass, 25% by mass, 23% by mass, 20% by mass, 18% by mass, 15% by mass, or 13% by mass in the total amount of the liquid crystal composition of the disclosure.

The compound represented by general formula (L-4) is preferably, for example, compounds represented by formulae (L-4.4) to (L-4.6), and preferably a compound represented by formula (L-4.4).

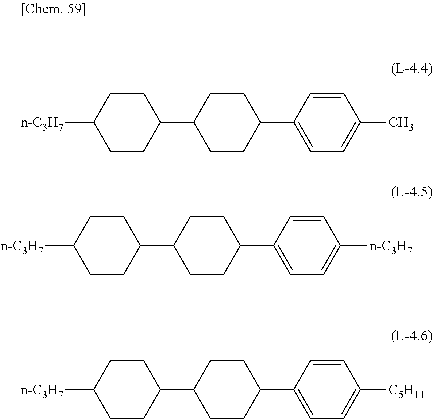

Depending on the required performance, such as solubility at low temperatures, transition temperature, electrical reliability, and birefringence index, the compound represented by formula (L-4.4) may be contained, the compound represented by formula (L-4.5) may be contained, or both of the compound represented by formula (L-4.4) and the compound represented by formula (L-4.5) may be contained.

The lower limit of the amount of the compound represented by formula (L-4.4) or (L-4.5) is preferably 3% by mass, 5% by mass, 7% by mass, 9% by mass, 11% by mass, 12% by mass, 13% by mass, 18% by mass, or 21% by mass in the total amount of the liquid crystal composition of the disclosure. The upper limit of the amount is preferably 45% by mass, 40% by mass, 35% by mass, 30% by mass, 25% by mass, 23% by mass, 20% by mass, 18% by mass, 15% by mass, 13% by mass, 10% by mass, or 8% by mass in the total amount of the liquid crystal composition of the disclosure.

When both of the compound represented by formula (L-4.4) and the compound represented by formula (L-4.5) are contained, the lower limit of the total amount of these compounds is preferably 15% by mass, 19% by mass, 24% by mass, or 30% by mass in the total amount of the liquid crystal composition of the disclosure, and the preferred upper limit of the total amount is preferably 45% by mass, 40% by mass, 35% by mass, 30% by mass, 25% by mass, 23% by mass, 20% by mass, 18% by mass, 15% by mass, or 13% by mass in the total amount of the liquid crystal composition of the disclosure.

The compound represented by general formula (L-4) is preferably compounds represented by formulae (L-4.7) to (L-4.10), and in particular preferably a compound represented by formula (L-4.9).

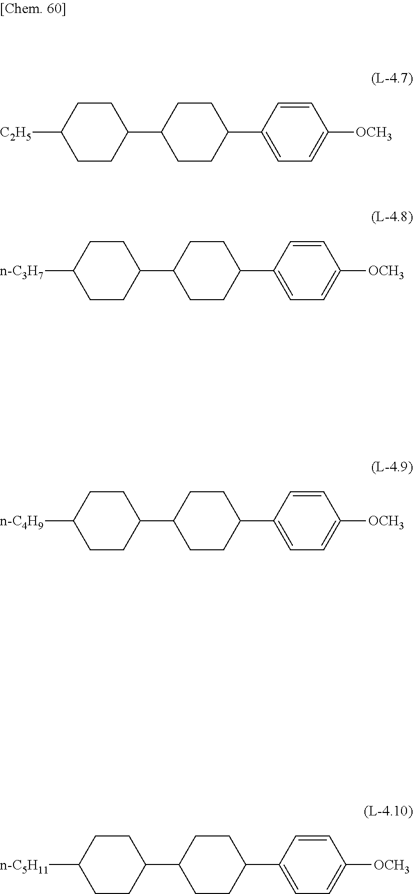

The compound represented by general formula (L-5) is the following compound.

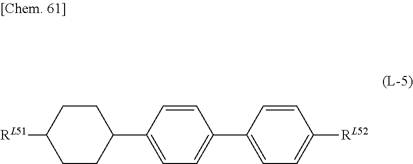

(In the formula, R^{L51} and R^{L52} each independently have the same meaning as R^{L1} and R^{L2} in general formula (L).)

R^{L51} is preferably an alkyl group having 1 to 5 carbon atoms or an alkenyl group having 2 to 5 carbon atoms, and R^{L52} is preferably an alkyl group having 1 to 5 carbon atoms, an alkenyl group having 4 to 5 carbon atoms, or an alkoxy group having 1 to 4 carbon atoms. It is preferable that the unsaturated bond of the alkenyl group and benzene are not directly bonded.

The compound represented by general formula (L-5) can be used alone or two or more compounds may be used in combination. Any compounds can be used in combination and an appropriate combination is used depending on the required performance, such as solubility at low temperatures, transition temperature, electrical reliability, and birefringence index. In one embodiment of the disclosure, for example, one, two, three, four, five or more compounds are used.

In the liquid crystal composition of the disclosure, the amount of the compound represented by general formula (L-5) needs to be adjusted as appropriate depending on the required performance, such as solubility at low temperatures, transition temperature, electrical reliability, birefringence index, process compatibility, dropping marks, image sticking, and dielectric constant anisotropy.

The lower limit of the amount of the compound represented by general formula (L-5) is preferably 1% by mass, 2% by mass, 3% by mass, 5% by mass, 7% by mass, 10% by mass, 14% by mass, 16% by mass, 20% by mass, 23% by mass, 26% by mass, 30% by mass, 35% by mass, or 40% by mass in the total amount of the liquid crystal composition of the disclosure. The upper limit of the amount is preferably 50% by mass, 40% by mass, 35% by mass, 30% by mass, 20% by mass, 15% by mass, 10% by mass, or 5% by mass in the total amount of the liquid crystal composition of the disclosure.

The compound represented by general formula (L-5) is preferably a compound represented by formula (L-5.1) or (L-5.2), and in particular preferably a compound represented by formula (L-5.1).

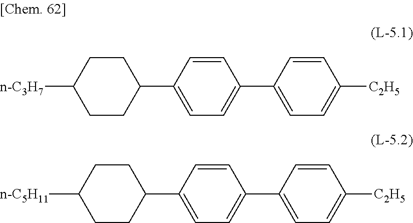

The lower limit of the amount of the compound represented by formula (L-5.1) or (L-5.2) is preferably 1% by mass, 2% by mass, 3% by mass, 5% by mass, or 7% by mass in the total amount of the liquid crystal composition of the disclosure. The upper limit of the amount is preferably 20% by mass, 15% by mass, 13% by mass, 10% by mass, or 9% by mass in the total amount of the liquid crystal composition of the disclosure.

The compound represented by general formula (L-5) is preferably a compound represented by formula (L-5.3) or (L-5.4).

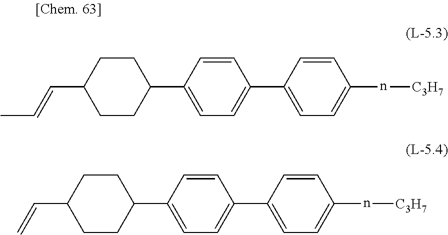

The lower limit of the amount of the compound represented by formula (L-5.3) or (L-5.4) is preferably 1% by mass, 2% by mass, 3% by mass, 5% by mass, or 7% by mass in the total amount of the liquid crystal composition of the disclosure. The upper limit of the amount is preferably 20% by mass, 15% by mass, 13% by mass, 10% by mass, or 9% by mass in the total amount of the liquid crystal composition of the disclosure.

The compound represented by general formula (L-5) is preferably a compound selected from a group of compounds represented by formulae (L-5.5) to (L-5.7), in particular, preferably a compound represented by formula (L-5.7).

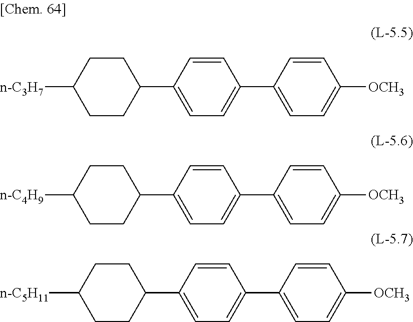

The lower limit of the amount of these compounds is preferably 1% by mass, 2% by mass, 3% by mass, 5% by mass, or 7% by mass in the total amount of the liquid crystal composition of the disclosure. The upper limit of the amount is preferably 20% by mass, 15% by mass, 13% by mass, 10% by mass, or 9% by mass in the total amount of the liquid crystal composition of the disclosure.

The compound represented by general formula (L-6) is the following compound.

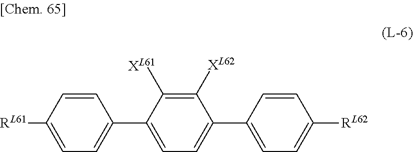

(In the formula, R^{L61} and R^{L62} each independently have the same meaning as R^{L1} and R^{L2} in general formula (L), and X^{L61} and X^{L62} each independently represent a hydrogen atom or a fluorine atom. However, the compound represented by general formula (N-1) is excluded.)

R^{L61} and R^{L62} are preferably each independently an alkyl group having 1 to 5 carbon atoms or an alkenyl group having 2 to 5 carbon atoms. It is preferable that the unsaturated bond of the alkenyl group and benzene are not directly bonded.

It is preferable that one of X^{L61} and X^{L62} is a fluorine atom and the other is a hydrogen atom.

The compound represented by general formula (L-6) can be used alone or two or more compounds may be used in combination. Any compounds can be used in combination and an appropriate combination is used depending on the required performance, such as solubility at low temperatures, transition temperature, electrical reliability, and birefringence index. In one embodiment of the disclosure, for example, one, two, three, four, five or more compounds are used.

The lower limit of the amount of the compound represented by general formula (L-6) is preferably 1% by mass, 2% by mass, 3% by mass, 5% by mass, 7% by mass, 10% by mass, 14% by mass, 16% by mass, 20% by mass, 23% by mass, 26% by mass, 30% by mass, 35% by mass, or 40% by mass in the total amount of the liquid crystal composition of the disclosure. The upper limit of the amount is preferably 50% by mass, 40% by mass, 35% by mass, 30% by mass, 20% by mass, 15% by mass, 10% by mass, or 5% by mass in the total amount of the liquid crystal composition of the disclosure. The amount is preferably increased when increasing Δn is important, and the amount is preferably reduced when precipitation at low temperatures is important.

The compound represented by general formula (L-6) is preferably compounds represented by formulae (L-6.1) to (L-6.9).

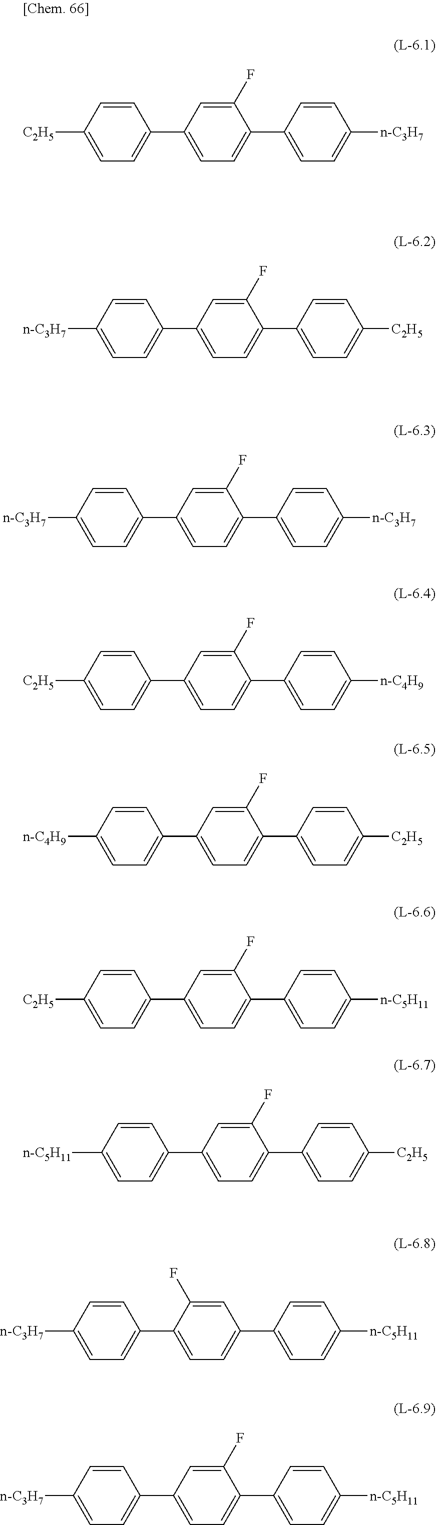

Any compounds can be used in combination, but it is preferable that one to three of these compounds are contained, and it is even more preferable that one to four of them are contained. Since a wide distribution of molecular weight of the selected compounds is also effective for solubility, it is preferable that, for example, one of compounds represented by formula (L-6.1) or (L-6.2), one of compounds represented by formula (L-6.4) or (L-6.5), one of compounds represented by formula (L-6.6) or (L-6.7), and one of compounds represented by formula (L-6.8) or (L-6.9) are selected and these are combined as appropriate. Among those, it is preferable that compounds represented by formulae (L-6.1), (L-6.3), (L-6.4), (L-6.6), and (L-6.9) are contained.

The compound represented by general formula (L-6) is preferably, for example, compounds represented by formulae (L-6.10) to (L-6.17), and among those, preferably a compound represented by formula (L-6.11).

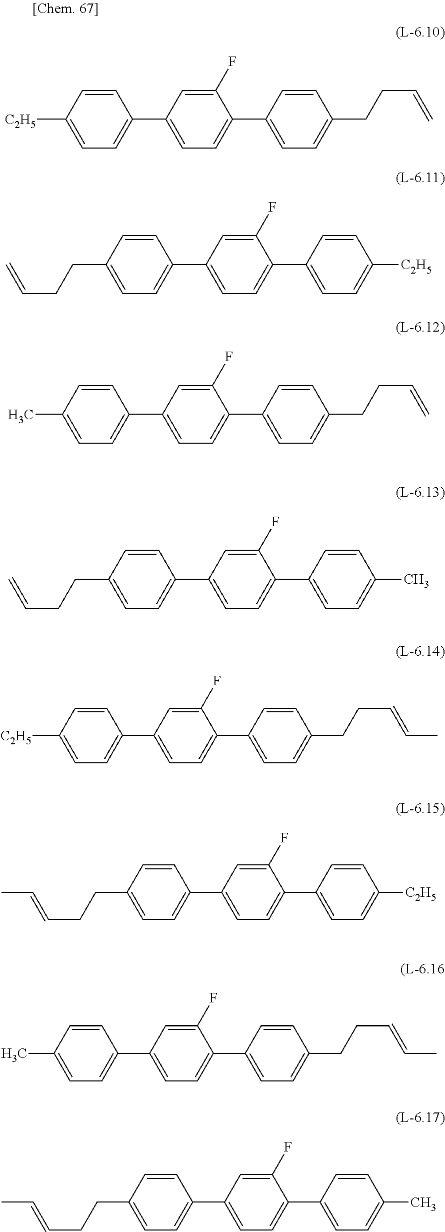

The lower limit of the amount of these compounds is preferably 1% by mass, 2% by mass, 3% by mass, 5% by mass, or 7% by mass in the total amount of the liquid crystal composition of the disclosure. The upper limit of the amount of these compounds is preferably 20% by mass, 15% by mass, 13% by mass, 10% by mass, or 9% by mass in the total amount of the liquid crystal composition of the disclosure.

The compound represented by general formula (L-7) is the following compound.

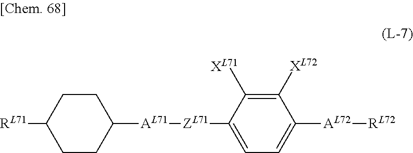

(In the formula, R^{L71} and R^{L72} each independently have the same meaning as R^{L1} and R^{L2} in general formula (L), and A^{L71} and A^{L72} each independently have the same meaning as A^{L2} and A^{L3} in general formula (L), wherein the hydrogen atoms on A^{L71} and A^{L72} are each independently optionally substituted with a fluorine atom, Z^{L71} has the same meaning as Z^{L2} in general formula (L), and X^{L71} and X^{L72} each independently represent a fluorine atom or a hydrogen atom. However, the compounds represented by general formulae (N-1) to (N-3) are excluded.)

In the formula, R^{L71} and R^{L72} are preferably each independently an alkyl group having 1 to 5 carbon atoms, an alkenyl group having 2 to 5 carbon atoms, or an alkoxy group having 1 to 4 carbon atoms. It is preferable that the unsaturated bond of the alkenyl group and benzene are not directly bonded.

A^{L71} and A^{L72} are preferably each independently a 1,4-cyclohexylene group or a 1,4-phenylene group, and the hydrogen atoms on A^{L71} and A^{L72} are each independently optionally substituted with a fluorine atom.

Z^{L71} is preferably a single bond or COO—, and a single bond is preferred.

X^{L71} and X^{L72} are both preferably a hydrogen atom.

Any compounds can be used in combination and compounds are combined depending on the required performance, such as solubility at low temperatures, transition temperature, electrical reliability, and birefringence index. In one embodiment of the disclosure, for example, one, two, three, or four compounds are used.

In the liquid crystal composition of the disclosure, the amount of the compound represented by general formula (L-7) needs to be adjusted as appropriate depending on the required performance, such as solubility at low temperatures, transition temperature, electrical reliability, birefringence index, process compatibility, dropping marks, image sticking, and dielectric constant anisotropy.

The lower limit of the amount of the compound represented by formula (L-7) is preferably 1% by mass, 2% by mass, 3% by mass, 5% by mass, 7% by mass, 10% by mass, 14% by mass, 16% by mass, or 20% by mass in the total amount of the liquid crystal composition of the disclosure. The upper limit of the amount of the compound is preferably 30% by mass, 25% by mass, 23% by mass, 20% by mass, 18% by mass, 15% by mass, 10% by mass, or 5% by mass in the total amount of the liquid crystal composition of the disclosure.

When an embodiment of the liquid crystal composition with a high Tni is desired, the amount of the compound represented by formula (L-7) is preferably increased, and when an embodiment with a low viscosity is desired, the amount is preferably reduced.

The compound represented by general formula (L-7) is preferably compounds represented by formulae (L-7.1) to (L-7.4), and preferably a compound represented by formula (L-7.2).

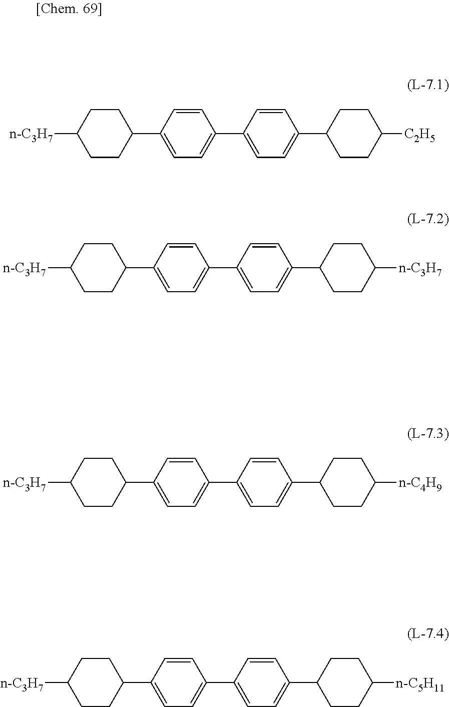

The compound represented by general formula (L-7) is preferably compounds represented by formulae (L-7.11) to (L-7.13), and preferably a compound represented by formula (L-7.11).

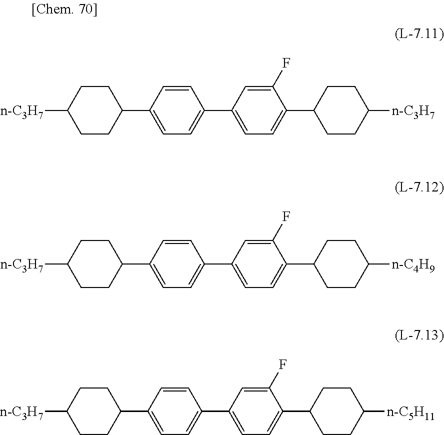

The compound represented by general formula (L-7) is preferably compounds represented by general formulae (L-7.21) to (L-7.23). The compound represented by general formula (L-7.21) is preferred.

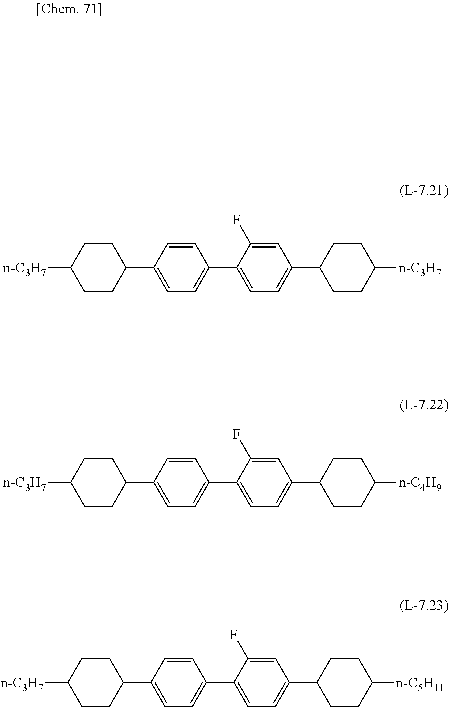

The compound represented by general formula (L-7) is preferably compounds represented by formulae (L-7.31) to (L-7.34), and preferably a compound represented by formula (L-7.31) and/or formula (L-7.32).

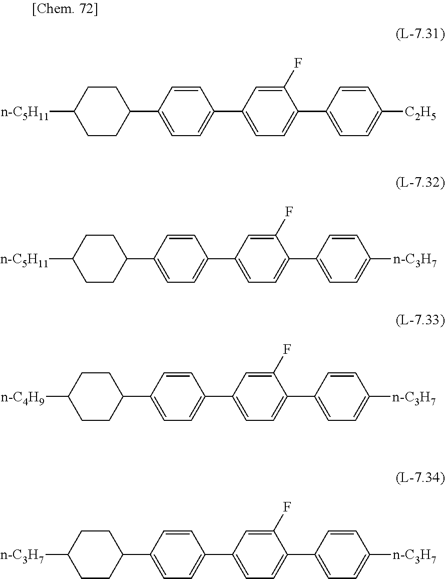

The compound represented by general formula (L-7) is preferably compounds represented by formulae (L-7.41) to (L-7.44), and preferably a compound represented by formula (L-7.41) and/or formula (L-7.42).

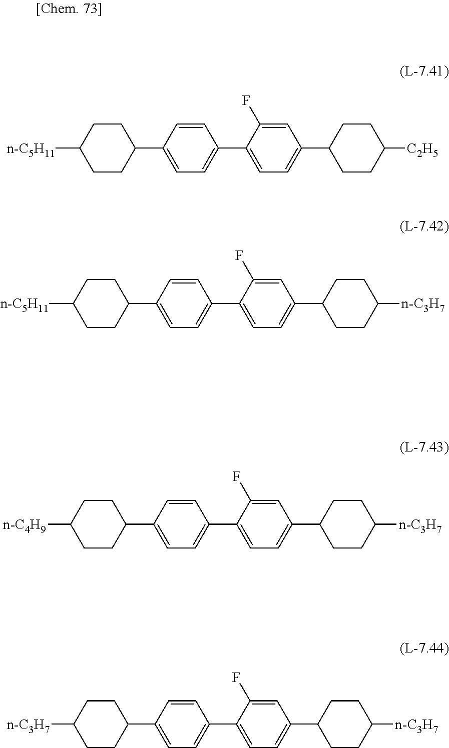

The compound represented by general formula (L-7) is preferably compounds represented by formulae (L-7.51) to (L-7.53).

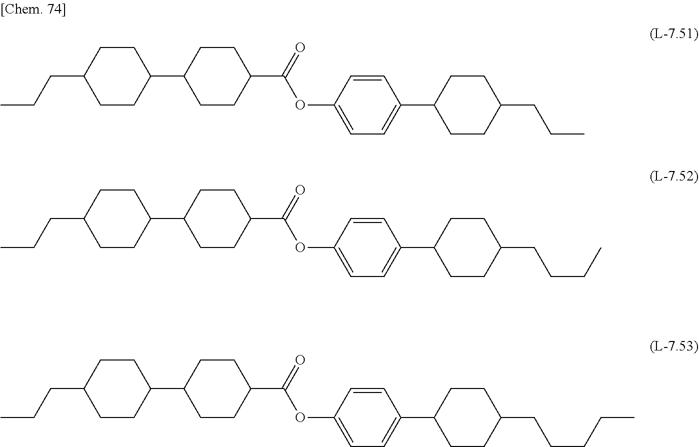

[4] Others

In the liquid crystal composition of the disclosure, the total amount of the compound represented by general formula (II) is preferably 80% by mass or more, 85% by mass or more, 88% by mass or more, 90% by mass or more, 92% by mass or more, 93% by mass or more, 94% by mass or more, 95% by mass or more, 96% by mass or more, 97% by mass or more, 98% by mass or more, or 99% by mass or more in the total amount of the liquid crystal composition of the disclosure. The total amount is preferably less than 99.99% by mass, 99.95% by mass or less, 99.5% by mass or less, 99.0% by mass or less, 98% by mass or less, or 95% by mass or less in the total amount of the liquid crystal composition of the disclosure.

In order that the liquid crystal composition of the disclosure has a negative value of dielectric constant anisotropy (Δε) at 25° C., the total amount of a compound selected from a group of compounds represented by general formulae (N-1) to (N-3) and a compound represented by general formula (L) is preferably 80% by mass or more, 85% by mass or more, 88% by mass or more, 90% by mass or more, 92% by mass or more, 93% by mass or more, 94% by mass or more, 95% by mass or more, 96% by mass or more, 97% by mass or more, 98% by mass or more, or 99% by mass or more in the total amount of the liquid crystal composition of the disclosure. The total amount is preferably less than 99.99% by mass, 99.95% by mass or less, 99.5% by mass or less, 99.0% by mass or less, 98% by mass or less, or 95% by mass or less in the total amount of the liquid crystal composition of the disclosure.

In terms of achieving both of high light resistance and high solubility of the liquid crystal composition, when the compound represented by general formula (II) is used, the total amount of the compound represented by general formula (L) and the compounds represented by general formulae (N-1) to (N-3) is preferably 95 to 100% by mass in 100% by mass of the dye-containing liquid crystal composition, and preferably 97 to 100% by mass.

Here, the compound represented by general formula (L) is preferably a compound selected from a group of compounds consisting of general formulae (L-1A), (L-1B), (L-2), (L-3), (L-4), (L-5), (L-6), and (L-7). The total amount of the compound selected from a group of compounds consisting of general formulae (L-1A), (L-1B), (L-2), (L-3), (L-4), (L-5), (L-6), and (L-7) is preferably 90% or more of the total amount of the compound represented by general formula (L), and preferably 95% or more.

It is preferable that the compound represented by general formula (L) contains one or more compounds selected from a group of compounds consisting of general formulae (L-1A), (L-1B), (L-2), and (L-3) and contains one or more compounds selected from a group of compounds consisting of general formulae (L-4), (L-5), (L-6), and (L-7).

The relation of the amounts is applicable to the compound represented by general formula (II) and/or any subordinate concepts of compounds represented by general formulae (N-1) to (N-3), and is also applicable to the compound represented by general formula (II) including subordinate concepts, and/or any combination of compounds represented by general formulae (N-1) to (N-3).

The liquid crystal composition of the disclosure has a large amount of a compound in which the ring structures in the molecule are all six-membered rings. The amount of the compound in which the ring structures in the molecule are all six-membered rings is preferably 80% by mass or more in the total amount of the liquid crystal composition of the invention, more preferably 90% by mass or more, and even more preferably 95% by mass or more. It is most preferable that the liquid crystal composition of the disclosure is substantially entirely composed of a compound in which the ring structures in the molecule are all six-membered rings.

In order to suppress degradation of the liquid crystal composition due to oxidation, it is preferable that the liquid crystal composition of the disclosure contains a small amount of a compound having a cyclohexenylene group as a ring structure. The amount of the compound having a cyclohexenylene group is preferably 10% by mass or less in the total amount of the liquid crystal composition of the disclosure, more preferably 8% by mass or less, even more preferably 5% by mass or less, and preferably 3% by mass or less, and it is even more preferable that the compound having a cyclohexenylene group is not contained.

As used herein “substantially not contained” means not being contained excluding unintentionally contained substances (unavoidable impurities).

When the liquid crystal composition of the disclosure has a negative dielectric constant anisotropy (Δε), the dielectric constant anisotropy (Δε) of the liquid crystal composition at 25° C. is preferably −2 or less, specifically, preferably in a range from −2.0 to −8.0, preferably in a range from −2.0 to −6.0, more preferably in a range from −2.0 to −5.0, and particularly preferably in a range from −2.5 to −4.0.

The liquid crystal composition of the disclosure has a refractive index anisotropy (Δn) preferably in a range from 0.08 to 0.14 at 25° C., more preferably in a range from 0.09 to 0.13, and particularly preferably in a range from 0.09 to 0.12. In more detail, the refractive index anisotropy (Δn) is preferably in a range from 0.10 to 0.13 for a thin cell gap, and preferably in a range from 0.08 to 0.10 for a thick cell gap.

The liquid crystal composition of the disclosure has a viscosity (η) of 10 to 50 m·Pas at 25° C. The viscosity is more preferably 10 to 40 m·Pas, and particularly preferably 10 to 35 mPa·s.

The liquid crystal composition of the disclosure has a rotational viscosity (γ₁) in a range from 40 to 130 m·Pas at 25° C., more preferably in a range from 50 to 110 m·Pas, and particularly preferably in a range from 60 to 100 m·Pas.

The liquid crystal composition of the disclosure has a nematic-isotropic phase transition temperature (Tₙᵢ) preferably in a range from 60° C. to 120° C., more preferably in a range from 70° C. to 110° C., and particularly preferably in a range from 80° C. to 100° C. Dye Compound

It is preferable that the dye-containing liquid crystal composition according to the disclosure contains one or two or more additional dye compounds, in addition to the dye compound represented by general formula (1), and it is preferable that the dye-containing liquid crystal composition contains the compound represented by general formula (1) and a total of three or more other dye compounds. When a plurality of dye compounds are used, it is preferable that a plurality of dye compounds have different absorption wavelengths so that a desired color such as black can be prepared.

The dye compound preferably has a maximum absorption wavelength between 350 and 750 nm inclusive. In particular, the compound represented by general formula (1) preferably has a maximum absorption between 500 and 600 nm inclusive when it is a red dye, between 400 and 500 nm inclusive when it is a yellow dye, and between 600 and 750 nm inclusive when it is a blue dye.

The maximum absorption wavelength is measured by the following method.

First, a sample is prepared by adding and dissolving 1.0 part by mass of a dye compound in 100 parts by mass of any liquid crystal composition in which the dye compound can be dissolved.

Next, a cell having an inlet with a cell thickness adjusted to 10 μm with plastic particles is fabricated using two 2 cm×2 cm glass substrates having ITO electrodes and alignment films for horizontal alignment on the ITO electrodes, with the ITO electrode layers facing inside of the cell.

A device is fabricated by injecting the sample into the cell and sealing the inlet with a sealant.

Then, the maximum absorption wavelength of the dye compound can be determined by measuring the absorption spectrum between 350 and 750 nm using a spectrometer (“LCD-5200” from Otsuka Electronics Co., Ltd.) at 25° C. and with no voltage applied to the fabricated device.

The dye compound is preferably a dichroic dye.

It is preferable that the dye compound is selected from the group consisting of azo compounds, anthraquinone compounds, methine compounds, azomethine compounds, merocyanine compounds, quinone compounds, naphthoquinone compounds, tetrazine compounds, perylene compounds, terrylene compounds, quaterrylene compounds, higher rylene compounds, indigo compounds, dioxazine compounds, azulene compounds, pyrromethene compounds, spiropyran compounds, and diarylethene compounds.

Examples of the azo compounds include disazo compounds and trisazo compounds.

Specific examples of the dye compound include SI-486 (yellow, dichroic dye, azo compound), SI-426 (red, dichroic dye, azo compound), M-483 (dichroic dye, blue), and M-412 (dichroic dye, blue).

One or two or more, preferably one to five, preferably one to four, preferably one to three dye compounds are used for the liquid crystal composition.

The lower limit of the total amount of dye compounds including the compound represented by general formula (1) per 100% by mass of the liquid crystal composition without dye compounds or additives is preferably 0.1% by mass or more, preferably 0.2% by mass or more, preferably 0.3% by mass or more, preferably 0.4% by mass or more, preferably 0.5% by mass or more, preferably 0.7% by mass or more, and preferably 1% by mass or more.

The upper limit of dye compounds including the compound represented by general formula (1) per 100% by mass of the liquid crystal composition without dye compounds or additives is preferably 20% by mass or less, preferably 15% by mass or less, preferably 12% by mass or less, preferably 10% by mass or less, preferably 8% by mass or less, and preferably 5% by mass or less.

The total amount of dye compounds including the compound represented by general formula (1) per 100% by mass of the liquid crystal composition without dye compounds or additives is preferably 0.1 to 20% by mass, preferably 0.2 to 15% by mass, preferably 0.3 to 15% by mass, preferably 0.5 to 12% by mass, preferably 0.8 to 10% by mass, preferably 1 to 8% by mass, and preferably 1 to 6% by mass.

### Haze Adjuster

The dye-containing liquid crystal composition according to the disclosure can contain a haze adjuster, if necessary. It is preferable that the haze adjuster is a compound having a non-ionic and highly polar functional group, in terms of adjusting the voltage holding ratio or the resistivity to an appropriate value while preventing display defects of the device due to the ion chromatographic phenomenon during production of the liquid crystal display device.

One or two or more, preferably one to five, preferably one to four, preferably one to three, preferably one to two haze adjusters are used for the dye-containing liquid crystal composition.

When the haze adjuster is used, the lower limit of the total amount of the haze adjuster per 100% by mass of the liquid crystal composition without dye compounds or additives is preferably 0.01% by mass or more, preferably 0.05% by mass or more, and preferably 0.1% by mass or more.

When the haze adjuster is used, the upper limit of the total amount of the haze adjuster per 100% by mass of the liquid crystal composition without dye compounds or additives is preferably 4.0% by mass or less, preferably 3.0% by mass or less, preferably 2.0% by mass or less, preferably 1.5% by mass or less, and preferably 1.0% by mass or less.

When the haze adjuster is used, the total amount of the haze adjuster per 100% by mass of the liquid crystal composition without dye compounds or additives is preferably 0.01 to 3.0% by mass, preferably 0.01 to 2.0% by mass, preferably 0.05 to 1.5% by mass, and preferably 0.1 to 1.0% by mass.

As the haze adjuster, a compound represented by the following general formula (H) is preferred.

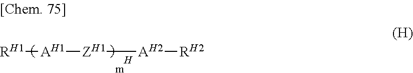

(In general formula (H),

R^{H1} and R^{H2} each represent a hydrogen atom, a fluorine atom, a chlorine atom, a bromine atom, an iodine atom, a pentafluorosulfuranyl group, a cyano group, a nitro group, a nitroso group, an isocyano group, a thioisocyano group, or a linear or branched alkyl group having 1 to 20 carbon atoms in which one —CH₂— or two or more nonadjacent —CH₂—'s are each independently optionally substituted with —O—, —S—, —CO—, —COO—, —OCO—, —CO—S—, —S—CO—, —O—CO—O—, —CO—NH—, —NH—CO—, or —C≡C—, wherein any hydrogen atom in the alkyl group is optionally substituted with a fluorine atom,

A^{H1} and A^{H2} each independently represent a 1,2-phenylene group, a 1,3-phenylene group, a 1,4-phenylene group, a 1,4-cyclohexylene group, a pyridine-2,5-diyl group, a pyrimidine-2,5-diyl group, a naphthalene-2,6-diyl group, or a naphthalene-1,4-diyl group, wherein these groups may be unsubstituted or substituted with one or more L^{H}s, and a plurality of A^{H1}s, if any, may be the same or different,

L^{H} represents a fluorine atom, a chlorine atom, a bromine atom, an iodine atom, a pentafluorosulfanyl group, a nitro group, a nitroso group, an isocyano group, an amino group, a hydroxyl group, a mercapto group, a methylamino group, a dimethylamino group, a diethylamino group, a diisopropylamino group, a trimethylsilyl group, a dimethylsilyl group, a thioisocyano group, or a linear or branched alkyl group having 1 to 20 carbon atoms in which one —CH₂— or two or more nonadjacent —CH₂—'s are each independently optionally substituted with —O—, —S—, —CO—, —COO—, —OCO—, —CO—S—, —S—CO—, —O—CO—O—, —CO—NH—, —NH—CO—, —CH═CH—COO—, —CH═CH—OCO—, —COO—CH═CH—, —OCO—CH═CH—, —CH═CH—, —CF═CF—, or —C≡C—, wherein a plurality of Ls, if any, may be the same or different,

Z^{H1} represents —O—, —S—, —OCH₂—, —CH₂O—, —CH₂CH₂—, —CO—, —COO—, —OCO—, —CO—S—, —S—CO—, —O—CO—O—, —CO—NH—, —NH—CO—, —OCO—NH—, —NH—COO—, —NH—CO—NH—, —NH—O—, —O—NH—, —SCH₂—, —CH₂S—, —CF₂O—, —OCF₂—, —CF₂S—, —SCF₂—, —CH═CH—COO—, —CH═CH—OCO—, —COO—CH═CH—, —OCO—CH═CH—, —COO—CH₂CH₂—, —OCO—CH₂CH₂—, —CH₂CH₂—OCO—, —CH₂CH₂—OCO—, —COO—CH₂—, —OCO—CH₂—, —CH₂—OCO—, —CH₂—OCO—, —CH═CH—, —N═N—, —CH═N—, —N═CH—, —CH═N—N═CH—, —CF═CF—, —C≡C—, or a single bond, wherein a plurality of Z^{H1}s, if any, may be the same or different,

m^{H} represents 0, 1, or 2, and

the structure has one or more chlorine atoms, bromine atoms, iodine atoms, pentafluorosulfuranyl groups, cyano groups, nitro groups, nitroso groups, isocyano groups, amino groups, hydroxyl groups, mercapto groups, methylamino groups, dimethylamino groups, diethylamino groups, diisopropylamino groups, trimethylsilyl groups, dimethylsilyl groups, or thioisocyano groups.)

As the haze adjuster, specifically, the following compounds are preferred.

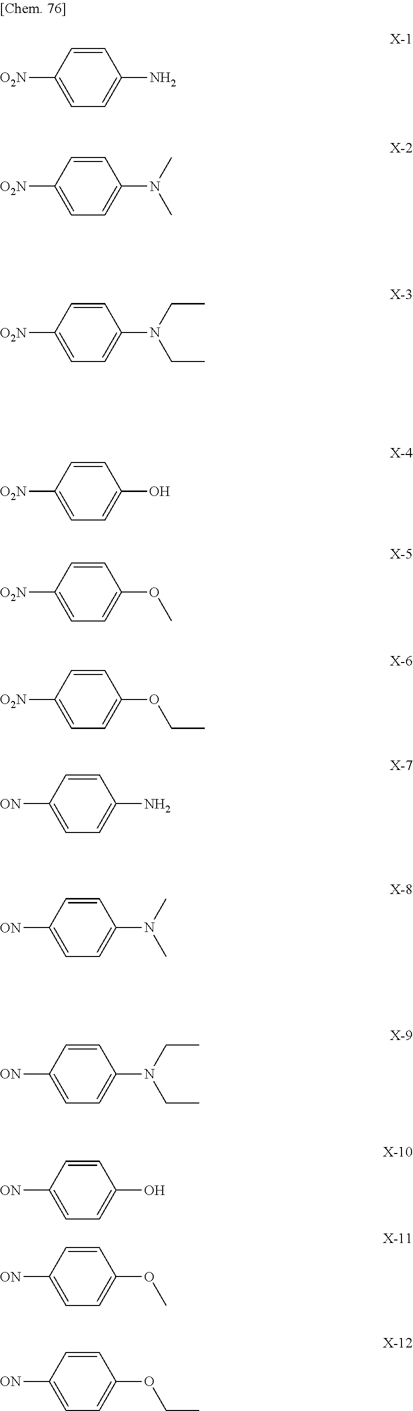

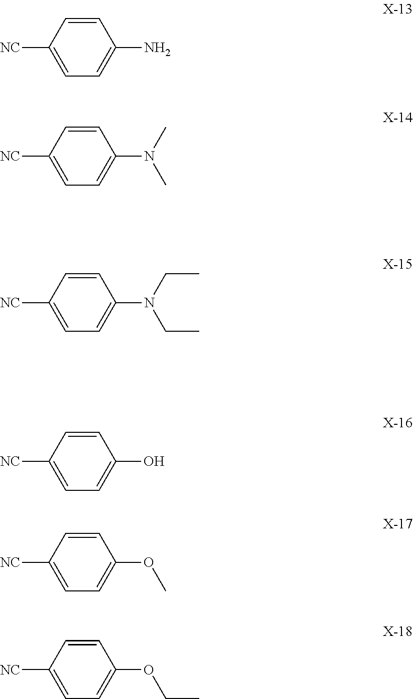

### Additives

The dye-containing liquid crystal composition according to the disclosure can be produced by mixing the other compounds described above and additives, if necessary. Examples of the additives include stabilizers, chiral agents, antistatic agents, nematic liquid crystals, smectic liquid crystals, cholesteric liquid crystals, and polymerizable compounds.

The stabilizers include antioxidants, ultraviolet (UV) absorbers, photostabilizers, or infrared absorbers.

The antioxidants include hydroquinone derivatives, nitrosoamine polymerization inhibitors, and hindered phenol antioxidants.

More specifically, examples include tert-butylhydroquinone, methylhydroquinone, “Q-1300” and “Q-1301” from Wako Pure Chemical Industries, Ltd., and “IRGANOX1010”, “IRGANOX1035”, “IRGANOX1076”, “IRGANOX1098”, “IRGANOX1135”, “IRGANOX1330”, “IRGANOX1425”, “IRGANOX1520”, “IRGANOX1726”, “IRGANOX245”, “IRGANOX259”, “IRGANOX3114”, “IRGANOX3790”, “IRGANOX5057”, and “IRGANOX565” from BASF SE.

As the ultraviolet (UV) absorbers, those with high absorption ability of UV light at wavelengths of 370 nm or less and low absorption of visible light at wavelengths of 400 nm or more are preferred in terms of favorable liquid crystal display characteristics.

More specifically, examples include hindered phenol compounds, benzotriazole compounds, hydroxybenzophenone compounds, salicylic acid ester compounds, benzophenone compounds, cyanoacrylate compounds, nickel complex salt compounds, and triazine compounds.

Examples of the hindered phenol compounds include 2,6-di-tert-butyl-p-cresol, pentaerythrityl-tetrakis[3-(3′,5′-di-tert-butyl-4-hydroxyphenyl)propionate], N,N′-hexamethylene bis(3,5-di-tert-butyl-4-hydroxy-hydrocinnamide), 1,3,5-trimethyl-2,4,6-tris(3,5-di-tert-butyl-4-hydroxy benzyl)benzene, and tris-(3,5-di-tert-butyl-4-hydroxy benzyl)-isocyanurate.

Examples of the benzotriazole compounds include 2-(2′-hydroxy-5′-methylphenyl)benzotriazole, 2,2-methylenebis(4-(1,1,3,3-tetramethylbutyl)-6-(2H-benzotriazol-2-yl)phenol), (2,4-bis-(n-octylthio)-6-(4-hydroxy-3,5-di-tert-butylanilino)-1,3,5-triazine, triethylene glycol-bis[3-(3-tert-butyl-5-methyl-4-hydroxyphenyl)propionate], N,N′-hexamethylenebis(3,5-di-tert-butyl-4-hydroxy-hydrocinnamide), 1,3,5-trimethyl-2,4,6-tris(3,5-di-tert-butyl-4-hydroxybenzyl)benzene, 2-(2′-hydroxy-3′,5′-di-tert-butylphenyl)-5-chlorobenzotriazole, (2-(2′-hydroxy-3′,5-di-tert-amylphenyl)-5-chlorobenzotriazole, 2,6-di-tert-butyl-p-cresol, and pentaerythrythyl-tetrakis[3-(3,5-di-tert-butyl-4-hydroxyphenyl)propionate].

More specifically, examples include “TINUVIN109”, “TINUVIN171”, “TINUVIN326”, “TINUVIN327”, “TINUVIN328”, “TINUVIN770”, “TINUVIN900”, and “TINUVIN928” from BASF Japan Ltd., and “KEMISORB 71”, “KEMISORB73”, and “KEMISORB74” from Chemipro Kasei Kaisha, Ltd.

One or two or more, preferably one to five, preferably one to four, preferably one to three, preferably one to two stabilizers are used for the dye-containing liquid crystal composition.

When the stabilizer is used, the lower limit of the total amount of the stabilizer per 100% by mass of the liquid crystal composition without dye compounds or additives is preferably 0.01% by mass or more, preferably 0.05% by mass or more, and preferably 0.1% by mass or more.

When the stabilizer is used, the upper limit of the total amount of the stabilizer per 100% by mass of the liquid crystal composition without dye compounds or additives is preferably 2.0% by mass or less, preferably 1.5% by mass or less, and preferably 1.0% by mass or less.

When the stabilizer is used, the total amount of the stabilizer per 100% by mass of the liquid crystal composition without dye compounds or additives is preferably 0.01 to 2.0% by mass, preferably 0.05 to 1.5% by mass, and preferably 0.1 to 1.0% by mass.

A chiral agent can be added to the dye-containing liquid crystal composition to orient the liquid crystal in a twisted manner. When the chiral agent is added, the twist of liquid crystal molecules in the dye-containing liquid crystal composition is preferably 90° or more, preferably 180° or more, preferably 90 to 720°, preferably 180 to 360°, preferably 180 to 720°, preferably 270 to 540°, and preferably 270 to 450° in terms of increasing the absorbance.

The twist of the liquid crystal molecules can also be adjusted by adjusting the angle of the orientation axis by the arrangement of a first transparent substrate and a second transparent substrate.

When a chiral agent is added, the twist pitch (p) in the dye-containing liquid crystal composition is preferably 2 to 30 and preferably 5 to 20

The twist pitch (p) is calculated as follows. A liquid crystal composition containing a prescribed amount of a chiral agent is injected into a wedge-shaped liquid crystal cell having two substrates and rubbed in antiparallel with a cell thickness gradually changing, and the twist pitch can be calculated according to p=2×L×tan θ from the inclination angle θ of the wedge-shaped liquid crystal cell (inclination of the upper substrate), and the distance L of the disclination line of the wedge-shaped liquid crystal cell measured by a length measuring instrument or the like.

The d/p value, which is the relation between the twist pitch (p) and the cell thickness (d), is preferably 0.1 to 2.2 and preferably 0.5 to 1.5. Specifically, it is preferable to make an adjustment such that the d/p value of the relation between the twist pitch (p) and the cell thickness (d) is optimal according to the twist angle. The optimum d/p value is a region free from orientation defects such as reverse twisted domains and striped domains. It is preferable to make an adjustment to prevent orientation defects by observing the domains visually or under a microscope.

The chiral agent may be either right- or left-handed, and can be used as appropriate depending on the configuration of the device. As the chiral agent, chiral agents for use in the TN mode or the STN mode may be used.

Examples of the chiral agent include “Chiral S-811 (a compound represented by the following structural formula (CA-1))”.

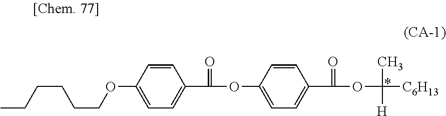

In structural formula (CA-1), “*” represents asymmetric center.

One or two or more, preferably one to five, preferably one to four, preferably one to three, preferably one to two, or preferably one chiral agent is used for the dye-containing liquid crystal composition.

When the chiral agent is used, the lower limit of the total amount of the chiral agent per 100% by mass of the liquid crystal composition without dye compounds or additives is preferably 0.05% by mass or more, preferably 0.1% by mass or more, preferably 0.3% by mass or more, and preferably 0.5% by mass or more.

When the chiral agent is used, the upper limit of the total amount of the chiral agent per 100% by mass of the liquid crystal composition without dye compounds or additives is preferably 5% by mass or less, preferably 3.0% by mass or less, preferably 2.0% by mass or less, and preferably 1.5% by mass or less.

When the chiral agent is used, the total amount of the chiral agent per 100% by mass of the liquid crystal composition without dye compounds or additives is preferably 0.05 to 5% by mass, preferably 0.1 to 3.0% by mass, preferably 0.3 to 2.0% by mass, and preferably 0.5 to 1.5% by mass.

The liquid crystal phase upper limit temperature (T_{NI}) is the temperature at which the liquid crystal composition used in the dye-containing liquid crystal composition undergoes a phase transition from the nematic phase to the isotropic phase. The liquid crystal phase upper limit temperature (T_{NI}) of the liquid crystal composition used in the dye-containing liquid crystal composition according to the disclosure is preferably 95° C. or higher, preferably 100 to 150° C., and preferably 100 to 130° C., because with a higher T_{NI}, the nematic phase can be maintained at higher temperatures and a wider drive temperature range can be ensured.

The liquid crystal phase lower limit temperature (T_{→N}) is the temperature at which the liquid crystal composition used in the dye-containing liquid crystal composition undergoes a phase transition from other phases (glass, smectic, or crystalline phase) to the nematic phase. The liquid crystal phase lower limit temperature (T_{→N}) of the liquid crystal composition used in the dye-containing liquid crystal composition according to the disclosure is preferably −15° C. or lower, preferably −78 to −20° C., and preferably −65 to −25° C., because with a lower T_{→N}, the nematic phase can be maintained at lower temperatures and a wider drive temperature range can be ensured.

The refractive index anisotropy (Δn) of the liquid crystal composition used in the dye-containing liquid crystal composition according to the disclosure at 25° C. and 589 nm is preferably 0.05 or more, preferably 0.06 to 0.20, preferably 0.07 to 0.15, and preferably 0.08 to 0.13.

The refractive index (nₑ) in the long axis direction of the liquid crystal molecules at 25° C. and 589 nm of the liquid crystal composition used in the dye-containing liquid crystal composition according to the disclosure is preferably 1.4 or higher, preferably 1.45 to 1.65, and preferably 1.50 to 1.63.

The refractive index (nₒ) in the short axis direction of the liquid crystal molecules at 25° C. and 589 nm of the liquid crystal composition used in the dye-containing liquid crystal composition according to the disclosure is preferably 1.3 or higher, preferably 1.35 to 1.55, and preferably 1.40 to 1.53.

An can be calculated by measuring ne and no of the liquid crystal composition used in the dye-containing liquid crystal composition, using an Abbe refractometer.

The rotational viscosity (γ₁) of the liquid crystal composition used in the dye-containing liquid crystal composition according to the disclosure at 25° C. is preferably 100 to 180 m·Pas, preferably 105 to 175 m·Pas, preferably 110 to 170 m·Pas, and preferably 115 to 165 m·Pas.

The elastic constant K₁₁ of the liquid crystal composition used in the dye-containing liquid crystal composition according to the disclosure at 25° C. is preferably 1.0 to 30.0 pN, preferably 5.0 to 25.0 pN, and preferably 10.0 to 20.0 pN.

The elastic constant K₂₂ of the liquid crystal composition used in the dye-containing liquid crystal composition according to the disclosure at 25° C. is preferably 1.0 to 25.0 pN, preferably 3.0 to 20.0 pN, and preferably 5.0 to 15.0 pN.

The elastic constant K₃₃ of the liquid crystal composition used in the dye-containing liquid crystal composition according to the disclosure at 25° C. is preferably 1.0 to 35.0 pN, preferably 5.0 to 30.0 pN, and preferably 10.0 to 25.0 pN.

Liquid Crystal Device

A liquid crystal device using the dye-containing liquid crystal composition described above will now be described.

The liquid crystal device of the disclosure is a liquid crystal device including two transparent substrates, at least one of which has a transparent electrode, and a drive layer containing a liquid crystal composition containing a dichroic dye (dye-containing liquid crystal composition) between the transparent substrates, and it is preferable that a vertical alignment film is installed on a surface of the transparent substrate in contact with the drive layer.

The liquid crystal device of the disclosure is not limited to specific embodiments as long as it has the above components. For example, the dye-containing liquid crystal composition may be sandwiched in a hollow element including two transparent substrates, at least one of which has a transparent electrode, and a vertical alignment film.

The liquid crystal device of the disclosure may be in a light transmissive state when no voltage is applied and be in a light scattering state when voltage is applied. Here, the liquid crystal device of the disclosure can achieve a high contrast ratio without a dense polymer network (polymer network) formed of a polymer in the drive layer. The liquid crystal device of the disclosure therefore can be fabricated without incurring an undesirable phenomenon such as decomposition of dye compounds that may occur when a polymer network is formed by a polymerization reaction.

The pretilt angle of the dye-containing liquid crystal composition in the liquid crystal device is preferably 80 to 99.9°, even more preferably 90 to 99.7°, and particularly preferably 95 to 99.5°. The pretilt angle can be measured using OPTIPRO from SHINTECH, Inc.

The distance (cell thickness) between the transparent substrates in the liquid crystal device is preferably 1 to 100 μm, more preferably 1.5 to 30 μm, and even more preferably 3 to 20 μm. The distance between the substrates may be adjusted using a spacer. Examples of the spacer include glass particles, plastic particles, alumina particles, and photoresist materials.

The liquid crystal device according to the disclosure may have an ultraviolet protection film to prevent degradation due to UV light. For example, an ultraviolet (UV) protection film for blocking light at wavelengths of 400 nm or less may be laminated or attached to the liquid crystal device.

The liquid crystal device according to the disclosure may be used as a single layer, or a plurality of liquid crystal devices may be stacked in two layers or three or more layers.

Transparent Electrode

The transparent electrode is provided to generate an electric field that can control the orientation of liquid crystal molecules in the drive layer, in the liquid crystal device of the disclosure. An ITO electrode is preferred as a transparent electrode layer. The electric field intensity is controlled by the degree of voltage application to the transparent electrode.

The transparent electrode may have any shape and the conductive portion may have a striped or mesh-like pattern, or a random mesh-like pattern.

Transparent Substrate

Examples of the material of the transparent substrate include glass and plastic. When the liquid crystal device of the disclosure is applied to flexible displays, the transparent substrate is preferably flexible.

Method of Driving Liquid Crystal Device

It is desirable that the liquid crystal device is driven by a rectangular wave having a frequency of 30 to 300 Hz. With the frequency of 30 Hz or lower, luminance change at the time of polarity reversal is visible, leading to quality degradation. With too high a frequency, signal delay becomes a concern in the case of large-area devices. Thus, the upper limit is preferably 300 Hz or lower. A more preferred range is 50 to 200 Hz, and an even more preferred range is 60 to 100 Hz.

Production Example of Liquid Crystal Device

The device can be fabricated as follows.

For example, a hollow cell can be fabricated by drawing a sealing agent such as an epoxy thermosetting composition on the first transparent substrate with an inlet, laminating the second transparent substrate and the first substrate with the transparent electrode facing inside, and then heating the laminate to thermally set the sealing agent. Then, a liquid crystal device can be fabricated by placing a dye-containing liquid crystal composition in the hollow cell, for example, using an ordinary vacuum injection method.

The liquid crystal device may be fabricated by drawing a sealing agent such as an epoxy thermosetting composition on the first transparent substrate, dropping a dye-containing liquid crystal composition, for example, by an ODF process or an inkjet process under a vacuum, then laminating the second transparent substrate and the first substrate with the transparent electrode facing inside, and then heating the laminate to thermally set the sealing agent.

To improve the contrast, an optical film may be further arranged on the liquid crystal device.

The liquid crystal device of the disclosure is preferably used, for example, in sunglasses, optical devices in the infrared region, building materials, light control glass, smart windows for automotive applications, and light control units in OLED displays. The liquid crystal device of the disclosure can also be used in various applications similar to those for conventional polymer-dispersed liquid crystal display devices. Preferred applications of the liquid crystal device include liquid crystal display devices, light control devices, and light transmitting apparatuses.

Voltage Holding Ratio of Liquid Crystal Device

In an active-matrix liquid crystal display device using TFTs, when a TFT is turned on, a signal voltage Vs is applied as a drain voltage Vd to the pixel electrodes through the TFT. Here, the amount of charge between the electrodes attenuates with time due to various factors, so that a predetermined voltage is no longer applied to the liquid crystal layer. The voltage holding ratio (VHR, %) indicates how much of the charge is held during one frame (16.7 ms).

In the liquid crystal device of the disclosure, the voltage holding ratio is a certain value or less, thereby exhibiting a high contrast ratio based on excellent transmission and scattering characteristics. In this respect, the voltage holding ratio is preferably 80% or less, preferably 75% or less, preferably 70% or less, preferably 65% or less, preferably 60% or less, preferably 55% or less, preferably 50% or less, preferably 45% or less, preferably 40% or less, preferably 35% or less, and preferably 30% or less. On the other hand, as long as this high contrast ratio can be achieved, a higher voltage holding ratio is preferable because if so, power consumption is low. In this respect, the voltage holding ratio is preferably 1% or more, 2% or more, preferably 3% or more, preferably 5% or more, preferably 7% or more, preferably 10% or more, preferably 12% or more, preferably 15% or more, preferably 18% or more, preferably 20% or more, preferably 23% or more, and preferably 25% or more. To sum up, the voltage holding ratio is preferably 1% or more and 80% or less, 2% or more and 75% or less, 2% or more and 70% or less, 2% or more and 65% or less, 3% or more and 75% or less, 3% or more and 70% or less, 3% or more and 65% or less, 3% or more and 60% or less, 5% or more and 75% or less, 5% or more and 70% or less, 5% or more and 65% or less, or 5% or more and 60% or less.

Haze Value of Liquid Crystal Device

The liquid crystal device of the disclosure exhibits a cloudy appearance at the time of light scattering. In this case, “haze” and “haze value” indicate light scattering by the drive layer and the degree thereof. The terms “haze” and “haze value” as used herein refer to the transmission haze of an optical apparatus.

“Transmission haze” is defined as forward scattering of light from a surface of an optical apparatus which is observed when light is transmitted. “Transmission haze” refers to the haze when a transparent or slightly translucent material is observed by viewing light passing through the material. It usually does not include light backscattered through a sample. The haze value (%) is the percentage of light scattered at an angle greater than a certain angle from the direction of incident light. When the haze value is measured, the percentage of diffuse scattered light (Tdiffuse) to total transmitted light (Ttotal) is reported as follows.

Haze value (%)=Tdiffuse×100/Ttotal

(Here T=% transmittance)

### EXAMPLES

The disclosure is described in further detail with examples below but the disclosure is not limited to the following examples.

The compositions in the following examples and comparative examples contain the compounds in the proportions listed in the table, and the amount is expressed by “% by mass”. The compounds are represented by the following abbreviations as listed in Tables 1 and 2. Compounds that can have cis configuration and trans configuration represent the trans configuration unless otherwise specified.

Ring Structure

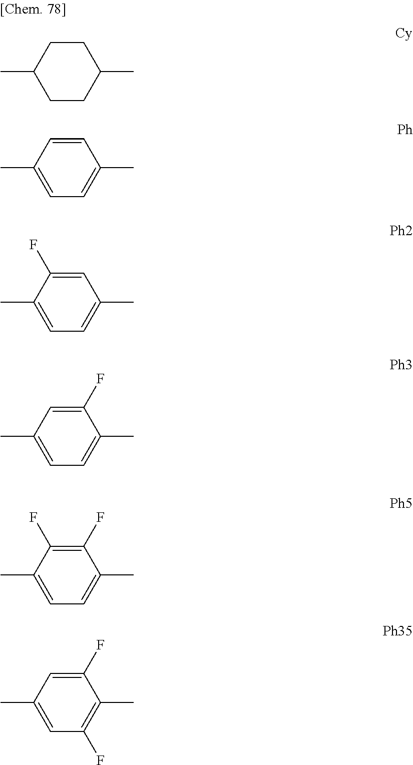

End Structure

TABLE 1

| Abbreviation | Chemical structure |
|---|---|
| -n | —CₙH₂ₙ₊₁ |
| n- | CₙH₂ₙ₊₁— |
| —On | —OCₙH₂ₙ₊₁ |
| nO— | CₙH₂ₙ₊₁O— |
| —F | —F |
| —CN | —CN |
| —V | —CH═CH₂ |
| V— | CH₂═CH— |
| —2V | —CH₂—CH₂—CH═CH₂ |
| V2— | CH₂═CH—CH₂—CH₂— |
| —V1 | —CH═CH—CH₃ |
| 1V— | CH₃—CH═CH— |

(n in the table is a natural number.)

Linking Structure

TABLE 2

| Abbreviation | Chemical structure |
|---|---|
| — | single bond |
| -n- | —CₙH₂ₙ— |
| -E1- | —C(═O)—O— |
| -E2- | —O—C(═O)— |

Dye Compound

TABLE 3
Dye

| | Maximum absorption |
|---|---|
| Type | wavelength (nm) |
| B-1 | 625 |
| B-2 | 626 |
| B-3 | 663 |
| B-4 | 626 |
| R-1 | 504 |
| Y-1 | 402 |
| Y-2 | 458 |
| Y-3 | 456 |

[Chem. 79] 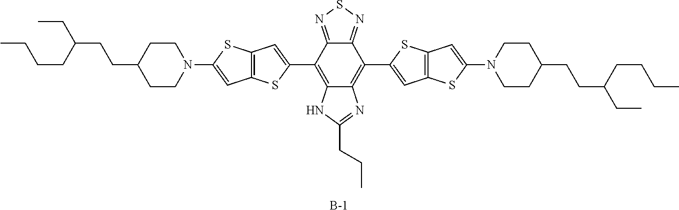 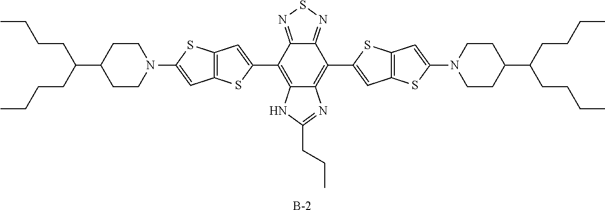 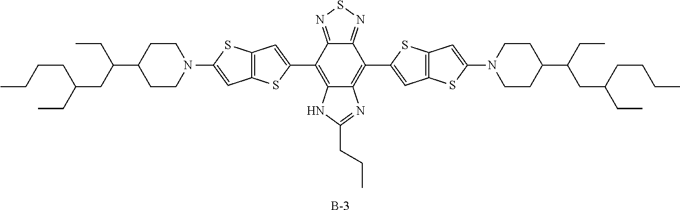 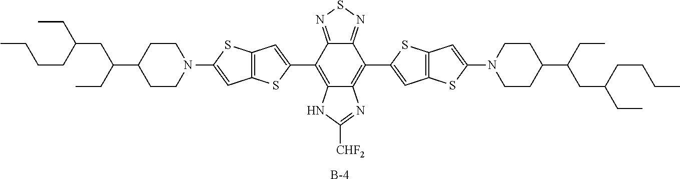
[Chem. 80]

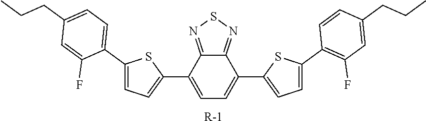

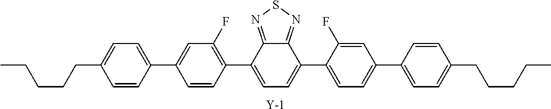

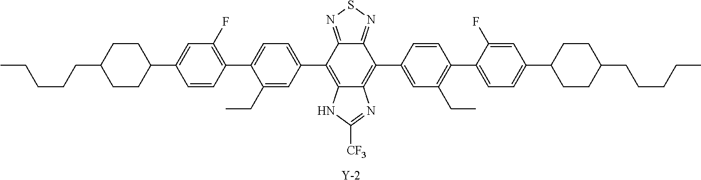

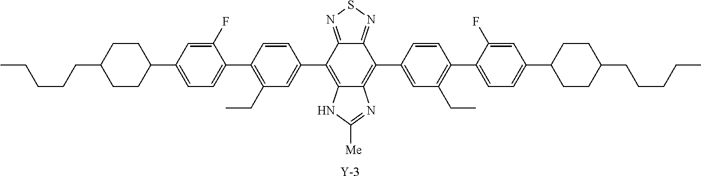

The following dyes are commercially available azo dyes having structures different from that of general formula (1).
AZO-1: dichroic dye compound (azo-based) exhibiting blue color, maximum absorption wavelength 633 nm
AZO-2: dichroic dye compound (azo-based) exhibiting red color, maximum absorption wavelength 517 nm
AZO-3: dichroic dye compound (azo-based) exhibiting yellow color, maximum absorption wavelength 405 nm

Antioxidant
IRGANOX1076: hindered phenol antioxidant

Ultraviolet (UV) Absorber
KEMISORB71: benzotriazole compound

Physical Properties of Liquid Crystal Composition Used in Dye-Containing Liquid Crystal Composition

The physical properties were measured for the liquid crystal composition used in the dye-containing liquid crystal composition. The meaning of each item is as follows.
T_{NI} (° C.): temperature at which the liquid crystal composition undergoes a transition from the nematic phase to the isotropic phase (upper limit temperature)
T_{→N} (° C.): temperature at which the liquid crystal composition undergoes a transition from other phases to the nematic phase (lower limit temperature)
Δn: refractive index anisotropy of the liquid crystal composition at 25° C. and 589 nm
Δε: dielectric constant anisotropy of the liquid crystal composition at 25° C.
γ₁ (m·Pas): rotational viscosity at 25° C.

### Examples 1 to 11 and Comparative Examples 1 to 10

Preparation of Liquid Crystal Composition for Use in Dye-Containing Liquid Crystal Composition

Liquid crystal compositions LC-1 to LC-5 for use in dye-containing liquid crystal compositions were prepared by mixing each liquid crystal compound in the corresponding proportion, and their physical properties were measured. The results are listed in Tables 4 and 5.

TABLE 4

| Liquid crystal compound | LC1 | LC2 | LC3 | LC4 | LC5 |
|---|---|---|---|---|---|
| 3-Cy-Cy-2 | 14 | | | | |
| 3-Cy-Cy-4 | 5 | | | | |
| 3-Cy-Ph—O2 | 14 | 10 | 10 | 8 | |
| 3-Cy-Cy—V | | 21 | 19 | 21 | |
| 3-Cy-Ph—Ph-2 | 6 | 6 | 6 | 6 | 5 |
| 5-Cy-Ph—Ph-2 | 6 | 6 | 6 | 6 | |
| V—Cy-Cy—Ph-1 | 4 | | | | |
| V2—Cy-Cy—Ph-1 | 7 | 13 | 15 | 15 | |
| 3-Cy-1O—Ph5—O2 | 4 | 10 | 10 | 10 | 12 |
| 3-Cy-Cy-E1—Ph5—O2 | 6 | | | | |
| 3-Cy-Cy—Ph5—O2 | | | 5 | | |
| 2-Cy-Cy-1O—Ph5—O2 | 12 | 14 | 12 | 14 | |
| 3-Cy-Cy-1O—Ph5—O2 | 12 | 20 | 17 | 20 | 19 |
| V—Cy-Cy-1O—Ph5—O2 | 5 | | | | |
| V—Cy-Cy-1O—Ph5—O3 | 5 | | | | |
| 5-Ph—Ph-1 | | | | | 22 |
| 3-Cy-Ph—Ph-1 | | | | | 5 |
| 3-Cy-Ph—Ph—O1 | | | | | 5 |
| 3-Cy-1O—Ph5—O1 | | | | | 7 |
| 2-Cy-Ph—Ph5—O2 | | | | | 5 |
| 3-Cy-Ph—Ph5—O2 | | | | | 10 |
| 3-Cy-Ph—Ph5—O4 | | | | | 10 |
| Total (% by mass) | 100 | 100 | 100 | 100 | 100 |

TABLE 5

| Physical | | | | | |
|---|---|---|---|---|---|
| properties | LC1 | LC2 | LC3 | LC4 | LC5 |
| T_{NI} (° C.) | 104.5 | 99.4 | 103.1 | 102.2 | 88.1 |
| T_{→N} (° C.) | G-53 | G-52 | G-52 | G-52 | G-39 |
| Δn | 0.095 | 0.094 | 0.097 | 0.095 | 0.146 |
| Δε | −3.2 | −2.9 | −3.2 | −3.0 | −4.5 |
| γ1 | 141 | 118 | 130 | 122 | 195 |

### Fabrication of Liquid Crystal Device

Dye-containing liquid crystal compositions were prepared by mixing and dissolving a dye compound, an antioxidant, and a UV absorber in LC1 to LC5. Next, a cell having an inlet with a cell thickness adjusted to 10 μm with plastic particles was fabricated using two 2 cm×2 cm glass substrates having ITO electrodes and alignment films for vertical alignment (JALS-20965) on the ITO electrodes, with the ITO electrode layers facing inside of the cell. A liquid crystal device was fabricated by injecting the dye-containing liquid crystal composition into the cell and sealing the inlet with a sealant.

### Voltage Holding Ratio Test

To the fabricated liquid crystal device, 10 V was applied with a pulse width of 60 μs at 25° C., and the ratio between the measurement voltage measured after a frame time of 16.7 ms and the initial applied voltage was expressed by %. The results are listed in Tables 6 to 10. Haze Test

Haze values were measured for the fabricated liquid crystal device when no voltage was applied and when a voltage was applied, using a rectangular wave voltage (AC 0 V to 50 V, 60 Hz). For haze characteristic evaluation, NDH-7000 from NIPPON DENSHOKU INDUSTRIES CO., LTD. was used. The results are listed in Tables 6 to 10.

In Tables 6 to 10, the amounts (parts by mass) of dye compounds, antioxidants, and chiral agents represent the amounts added to 100 parts by mass of the liquid crystal composition.

TABLE 6

| | | | | | | Voltage | | | | | | |
|---|---|---|---|---|---|---|---|---|---|---|---|---|
| | Liquid | Dye | | | | holding | Haze | Haze | Haze | Haze | Haze | Haze |
| | crystal | | Amount | Antioxidant | | ratio @ | @ | @ | @ | @ | @ | @ |
| | composition | Type | added | IRGANOX1076 | KEMISORB71 | 10 V | 0 V | 5 V | 10 V | 20 V | 30 V | 50 V |
| Example 1 | LC-1 | B-1 | 0.5 | 0.1 | 0.2 | 29.0 | 0.3 | 0.4 | 1.3 | 44.5 | 46.2 | 51.3 |
| Example 2 | LC-1 | B-1 | 1 | 0.1 | 0.2 | 13.0 | 0.2 | 12.9 | 33.9 | 61.7 | 66.0 | 71.7 |
| Example 3 | LC-1 | B-2 | 1 | 0.1 | 0.2 | 27.0 | 0.3 | 0.8 | 1.0 | 39.0 | 56.0 | 58.0 |
| Example 4 | LC-1 | B-3 | 1 | 0.1 | 0.2 | 28.0 | 0.4 | 0.9 | 1.3 | 41.0 | 58.0 | 61.0 |
| Example 5 | LC-1 | B-4 | 1 | 0.1 | 0.2 | 17.0 | 0.3 | 0.7 | 0.8 | 64.0 | 72.0 | 83.0 |
| Example 6 | LC-1 | B-1 | 2 | 0.1 | 0.2 | 3.0 | 0.2 | 25.4 | 66.6 | 78.9 | 85.8 | 92.1 |
| Comparative | LC-1 | AZO-1 | 0.5 | 0.1 | 0.2 | 79.0 | 0.2 | 0.3 | 0.3 | 0.3 | 1.7 | 1.4 |
| Example 1 | | | | | | | | | | | | |
| Comparative | LC-1 | AZO-1 | 1 | 0.1 | 0.2 | 74.7 | 0.1 | 0.3 | 0.2 | 5.9 | 6.9 | 6.1 |
| Example 2 | | | | | | | | | | | | |
| Comparative | LC-1 | AZO-1 | 2 | 0.1 | 0.2 | 70.0 | 0.6 | 0.7 | 0.7 | 1.2 | 12.3 | 7.1 |
| Example 3 | | | | | | | | | | | | |

TABLE 7

| | | | | | | Voltage | | | | | | |
|---|---|---|---|---|---|---|---|---|---|---|---|---|
| | Liquid | Dye | | | | holding | Haze | Haze | Haze | Haze | Haze | Haze |
| | crystal | | Amount | Antioxidant | | ratio @ | @ | @ | @ | @ | @ | @ |
| | composition | Type | added | IRGANOX1076 | KEMISORB71 | 10 V | 0 V | 5 V | 10 V | 20 V | 30 V | 50 V |
| Comparative | LC-1 | AZO-3 | 1 | 0.1 | 0.2 | 97.9 | 0.8 | 0.9 | 0.9 | 0.9 | 0.0 | 0.9 |
| Example 4 | | | | | | | | | | | | |
| Comparative | LC-1 | Y-1 | 1 | 0.1 | 0.2 | 95.5 | 0.4 | 1.2 | 1.2 | 1.3 | 1.3 | 1.3 |
| Example 5 | | | | | | | | | | | | |
| Comparative | LC-1 | Y-2 | 1 | 0.1 | 0.2 | 94.2 | 0.4 | 0.8 | 1.2 | 1.5 | 1.5 | 1.7 |
| Example 6 | | | | | | | | | | | | |
| Comparative | LC-1 | Y-3 | 1 | 6.1 | 0.2 | 93.3 | 0.3 | 0.5 | 1.0 | 1.3 | 1.3 | 1.5 |
| Example 7 | | | | | | | | | | | | |

TABLE 8

| | | | | | | Voltage | | | | | | |
|---|---|---|---|---|---|---|---|---|---|---|---|---|
| | Liquid | Dye | | | | holding | Haze | Haze | Haze | Haze | Haze | Haze |
| | crystal | | Amount | Antioxidant | | ratio @ | @ | @ | @ | @ | @ | @ |
| | composition | Type | added | IRGANO1076 | KEMISORB71 | 10 V | 0 V | 5 V | 10 V | 20 V | 30 V | 50 V |
| Comparative | LC-1 | AZO-2 | 1.0 | 0.1 | 0.2 | 98 | 0.0 | 0.1 | 0.2 | 0.2 | 0.2 | 0.4 |
| Example 8 | | | | | | | | | | | | |
| Comparative | LC-1 | AZO-2 | 2.0 | 0.1 | 0.2 | 97.1 | 0 | 0.13 | 0.14 | 0.12 | 0.31 | 0.73 |
| Example 9 | | | | | | | | | | | | |
| Comparative | LC-1 | R-1 | 1.0 | 0.1 | 0.2 | 92.2 | 0.7 | 3 | 3.355 | 3.575 | 3.655 | 3.72 |
| Example 10 | | | | | | | | | | | | |

TABLE 9

| | | | | | | Voltage | | | | | | |
|---|---|---|---|---|---|---|---|---|---|---|---|---|
| | Liquid | Dye | | | | holding | Haze | Haze | Haze | Haze | Haze | Haze |
| | crystal | | Amount | Antioxidant | | ratio @ | @ | @ | @ | @ | @ | @ |
| | composition | Type | added | IRGANOX1076 | KEMISORB71 | 10 V | 0 V | 5 V | 10 V | 20 V | 30 V | 50 V |
| Example 7 | LC-2 | B-1 | 1 | 0.1 | 0.2 | 12.0 | 0.3 | 26.0 | 64.0 | 77.7 | 82.0 | 92.9 |
| Example 8 | LC-3 | B-2 | 1 | 0.1 | 0.2 | 26.0 | 0.3 | 0.9 | 1.3 | 40.3 | 55.2 | 59.2 |
| Example 9 | LC-4 | B-3 | 1 | 0.1 | 0.2 | 29.0 | 0.3 | 0.9 | 1.5 | 42.0 | 59.1 | 63.0 |
| Example 10 | LC-2 | B-4 | 1 | 0.1 | 0.2 | 15.0 | 0.4 | 0.7 | 1.1 | 64.0 | 71.1 | 81.0 |
| Example 11 | LC-3 | B-1 | 2 | 0.1 | 0.2 | 2.0 | 0.3 | 24.5 | 65.0 | 79.1 | 83.3 | 93.3 |

Examples 1 to 11 and Comparative Examples 1 to 10 suggest that, in the liquid crystal device using the dye-containing liquid crystal composition of the disclosure, the difference in haze value between when no voltage is applied and when a rectangular wave voltage is applied is large under a condition in which the voltage holding ratio of the dye-containing liquid crystal composition is below a certain value.

The uniformity of haze in the device plane was visually recognized in all of the liquid crystal devices.

### Comparative Examples 11 to 20

To the dye-containing liquid crystal compositions containing a liquid crystal composition, a dye, an antioxidant, and a UV absorber used in Comparative Examples 1 to 10, cetyltrimethylammonium bromide (CTAB) from Sigma-Aldrich was added to adjust the voltage holding ratio to 60% or less. The non-uniformity of haze in the device plane was visually recognized depending on the flow direction of the liquid crystal composition in the liquid crystal injection process in fabrication of the liquid crystal device.

### Examples 12 and 13

Liquid crystal devices were fabricated in the same way as in Examples 1 to 11 using a black dye-containing liquid crystal composition prepared using three dichroic dyes. The results are listed in Tables 10 and 11.

TABLE 10

| | | Dye | | Dye | | Dye | | | |
|---|---|---|---|---|---|---|---|---|---|
| | Liquid crystal | | Amount | | Amount | | Amount | Antioxidant | |
| | composition | Type | added | Type | added | Type | added | IRGANOX1076 | KEMISORB71 |
| Example 12 | LC-1 | B-1 | 2 | AZO-2 | 1.3 | AZO-3 | 0.7 | 0.1 | 0.2 |
| Comparative | LC-1 | AZO-1 | 2 | AZO-2 | 1.3 | AZO-3 | 0.7 | 0.1 | 0.2 |
| Example 21 | | | | | | | | | |

TABLE 11

| | Voltage | | | | | | |
|---|---|---|---|---|---|---|---|
| | holding | Haze | Haze | Haze | Haze | Haze | Haze |
| | ratio @ | @ | @ | @ | @ | @ | @ |
| | 10 V | 0 V | 5 V | 10 V | 20 V | 30 V | 50 V |
| Example 12 | 2.4 | 0.3 | 27.6 | 64.2 | 79.4 | 85.78 | 91.94 |
| Comparative | 66.6 | 0.3 | 1.3 | 4.4 | 10.1 | 11.2 | 12.7 |
| Example 21 | | | | | | | |

Example 12 indicates that the liquid crystal device using the dye-containing liquid crystal composition of the disclosure exhibits an extremely excellent contrast ratio in the case of black color, because the haze value is significantly low when no voltage is applied, while the haze value is significantly high when voltage is applied.

On the other hand, Comparative Example 21 indicates that the contrast is inferior to that of Example 12, because the voltage holding ratio is relatively high and the haze is not large.

Based on the above results, it was confirmed that the liquid crystal device of the disclosure exhibits a large difference in haze value between when no voltage is applied and when a rectangular wave voltage is applied, and exhibits an excellent contrast ratio. Even when a chiral material (CA-1) was added to the liquid crystal composition in Example 12 so that d/p=1.0, a similar voltage holding ratio of 3.0% and haze value of 92.5% at 50 V were achieved, and similar effects were confirmed.

### Examples 13 and 14

Liquid crystal devices were fabricated in the same way as in Examples 1 to 11 by further adding the following compound as a haze adjuster to the black dye-containing liquid crystal composition prepared using three dichroic dyes. The results are listed in Tables 12 and 13.

TABLE 12

| | Liquid | Dye | | Dye | | Dye | | Adjuster | | Antioxidant | |
|---|---|---|---|---|---|---|---|---|---|---|---|
| | crystal | | Amount | | Amount | | Amount | | Amount | IRGANOX | KEMISOR |
| | composition | Type | added | Type | added | Type | added | Type | added | 1076 | B71 |
| Example 13 | LC-1 | AZO-1 | 2 | AZO-2 | 1.3 | AZO-3 | 0.7 | X-1 | 0.5 | 0.1 | 0.2 |
| Example 14 | LC-1 | AZO-1 | 2 | AZO-2 | 1.3 | AZO-3 | 0.7 | X-2 | 0.5 | 0.1 | 0.2 |
| Comparative | LC-2 | AZO-1 | 2 | AZO-2 | 1.3 | AZO-3 | 0.7 | — | 0 | 0.1 | 0.2 |
| Example 21 | | | | | | | | | | | |

[Chem. 81]

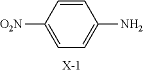

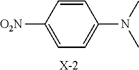

TABLE 13

| | Voltage | | | | | | |
|---|---|---|---|---|---|---|---|
| | holding | Haze | Haze | Haze | Haze | Haze | Haze |
| | ratio @ | @ | @ | @ | @ | @ | @ |
| | 10 V | 0 V | 5 V | 10 V | 20 V | 30 V | 50 V |
| Example 13 | 1.3 | 0.3 | 20 | 60.5 | 70.1 | 77.1 | 85.5 |
| Example 14 | 3.3 | 0.3 | 22.2 | 62.1 | 71.1 | 74.8 | 87.1 |
| Comparative | 66.6 | 0.3 | 1.3 | 4.4 | 10.1 | 11.2 | 12.7 |
| Example 21 | | | | | | | |

Examples 13 and 14 indicate that the liquid crystal device using the dye-containing liquid crystal composition of the disclosure exhibits an extremely excellent contrast ratio in the case of black color, because the haze value is significantly low when no voltage is applied, while the haze value is significantly high when voltage is applied.

Based on the above results, it was confirmed that the liquid crystal device of the disclosure exhibits a large difference in haze value between when no voltage is applied and when a rectangular wave voltage is applied, and exhibits an excellent contrast ratio. Even when a chiral material (CA-1) was added to the liquid crystal compositions in Examples 13 and 14 so that d/p=1.0, a similar voltage holding ratio of 3.0% and haze value of 92.5% at 50 V were achieved, and similar effects were confirmed.

### Examples 15 and 16

Liquid crystal devices were fabricated in the same way as in Examples 1 to 11 by using a black dye-containing liquid crystal composition prepared using three dichroic dyes and a haze adjuster, and further adding a chiral agent (CA-1) to this dye-containing liquid crystal composition. The results are listed in Tables 14 and 15.

TABLE 14

| | Liquid | Dye | | Dye | | Dye | | Adjuster | | Chiral | | | |
|---|---|---|---|---|---|---|---|---|---|---|---|---|---|
| | crystal | | Amount | | Amount | | Amount | | Amount | material | | Antioxidant | |
| | composition | Type | added | Type | added | Type | added | Type | added | Type | Added | IRGANOX1076 | KEMISORB71 |
| Example 15 | LC-5 | AZO- | 2 | AZO- | 1.3 | AZO- | 0.7 | X-1 | 0.5 | — | 0 | 0.1 | 0.2 |
| | | 1 | | 2 | | 3 | | | | | | | |
| Example 16 | LC-5 | AZO- | 2 | AZO- | 1.3 | AZO- | 0.7 | X-1 | 0.5 | CA- | 0.8 | 0.1 | 0.2 |
| | | 1 | | 2 | | 3 | | | | 1 | | | |
| Comparative | LC-1 | AZO- | 2 | AZO- | 1.3 | AZO- | 0.7 | — | 0 | — | 0 | 0.1 | 0.2 |
| Example 21 | | 1 | | 2 | | 3 | | | | | | | |

TABLE 15

| | Voltage | | | | | | |
|---|---|---|---|---|---|---|---|
| | holding | Haze | Haze | Haze | Haze | Haze | Haze |
| | ratio @ | @ | @ | @ | @ | @ | @ |
| | 10 V | 0 V | 5 V | 10 V | 20 V | 30 V | 50 V |
| Example 15 | 2.8 | 0.3 | 30 | 70.1 | 75.5 | 83.1 | 90.2 |
| Example 16 | 2.3 | 0.3 | 42 | 80.3 | 83.3 | 90.5 | 92 |
| Comparative | 66.6 | 0.3 | 1.3 | 4.4 | 10.1 | 11.2 | 12.7 |
| Example 21 | | | | | | | |

Example 15 indicates that the liquid crystal device using the dye-containing liquid crystal composition containing a liquid crystal composition with a high Δn, such as LC-5, exhibits an extremely excellent contrast ratio in the case of black color, because the haze value is significantly low when no voltage is applied, while the haze value is significantly high when voltage is applied.

Example 16 indicates that even with inclusion of a chiral agent, the haze value is significantly low when no voltage is applied while the haze value is significantly high when voltage is applied, similarly.

What is claimed is:

1. A liquid crystal device comprising:
two transparent substrates, at least one of the transparent substrates having a transparent electrode; and
a drive layer containing a liquid crystal composition containing a dichroic dye (dye-containing liquid crystal composition) disposed between the transparent substrates,
the liquid crystal device being in a light transmissive state when no voltage is applied to the transparent electrode and being in a light scattering state when voltage is applied, wherein
the liquid crystal composition exhibits a negative dielectric constant anisotropy,
a haze value of the liquid crystal device is 10% or less when no voltage is applied at 25° C., and the haze value is 50% or more when a rectangular wave voltage (AC 50 V, 60 Hz) is applied, and
a voltage holding ratio of the dye-containing liquid crystal composition (the liquid crystal composition is injected into a cell with a cell thickness of 10 μm, 10 V is applied with a pulse width of 60 μs, and a ratio between a measurement voltage measured after a frame time of 16.7 ms and an initial applied voltage is expressed by % as the voltage holding ratio) is 60% or less at 25° C.

2. The liquid crystal device according to claim 1, wherein the drive layer does not contain a polymer network.

3. The liquid crystal device according to claim 1, wherein a vertical alignment film is installed on a surface of the transparent substrate in contact with the drive layer.

4. The liquid crystal device according to claim 1, wherein the dichroic dye is a compound represented by general formula (1) 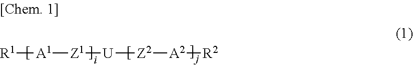
(wherein U is one group selected from groups represented by general formulae (2) to (5) 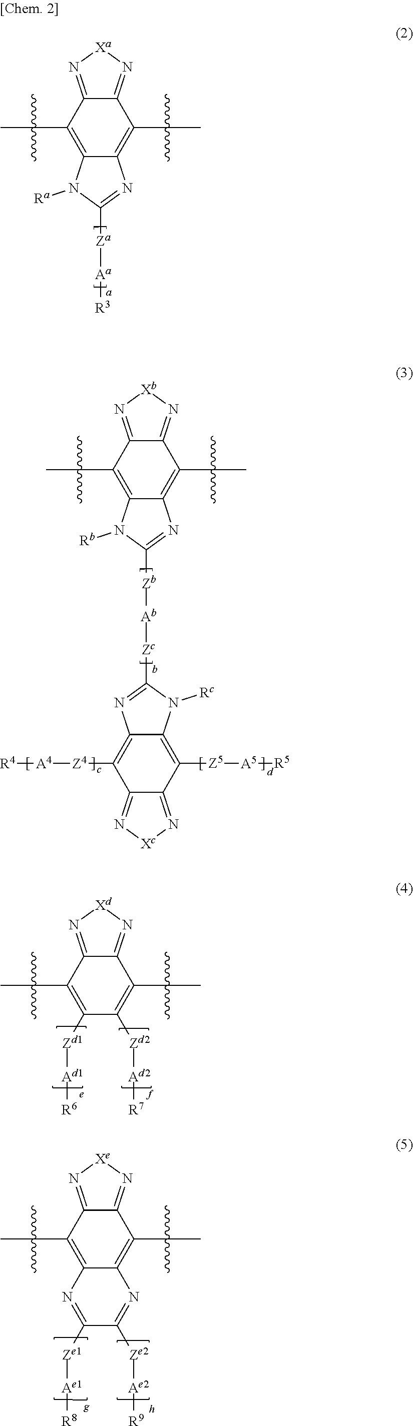
R¹, R², R³, R⁴, R⁵, R⁶, R⁷, R⁸, and R⁹ each independently represent a hydrogen atom, a fluorine atom, a cyano group, an alkyl group having 1 to 20 carbon atoms, or an alkenyl group having 2 to 30 carbon atoms, one —CH₂— or two or more nonadjacent —CH₂—'s present in these groups are optionally substituted with —NR^{N1}—, —O—, —S—, —CO—, —CS—, —COO—, —OCO—, —CO—S—, —S—CO—, —SO—, —SO₂—, —O—CO—O—, —CO—NH—, —NH—CO—, —CH═CH—, —CF═CF—, or —C≡C—, a hydrogen atom present in these groups is optionally substituted with a fluorine atom, wherein R^{N1} represents a hydrogen atom, an alkyl group having 1 to 20 carbon atoms, or an alkenyl group having 2 to 30 carbon atoms, one —CH₂— or two or more nonadjacent —CH₂—'s present in these groups are optionally substituted with —O—, —S—, —COO—, —OCO—, or —CO—, and a hydrogen atom present in these groups is optionally substituted with a fluorine atom,
R^{a}, R^{b}, and R^{c} each independently represent a hydrogen atom, an alkyl group having 1 to 20 carbon atoms, or an alkenyl group having 2 to 30 carbon atoms, one —CH₂— or two or more nonadjacent —CH₂—'s present in these groups are optionally substituted with —NR^{N2}—, —O—, —S—, —CO—, —CS—, —COO—, —OCO—, —CO—S—, —S—CO—, —SO—, —SO₂—, —O—CO—O—, —CO—NH—, —NH—CO—, —CH═CH—, —CF═CF—, or —C≡C—, a hydrogen atom present in these groups is optionally substituted with a fluorine atom, wherein R^{N2} represents a hydrogen atom, an alkyl group having 1 to 20 carbon atoms, or an alkenyl group having 2 to 30 carbon atoms, one —CH₂— or two or more nonadjacent —CH₂—'s present in these groups are optionally substituted with —O—, —S—, —COO—, —OCO—, or —CO—, a hydrogen atom present in these groups is optionally substituted with a fluorine atom,
X^{a}, X^{b}, X^{c}, X^{d}, and X^{e} each independently represent —S— or —O—,
A¹, A², A⁴, A⁵, A^{a}, A^{b}, A^{d1}, A^{d2}, A^{e1} and A^{e2} each independently represent an optionally substituted hydrocarbon ring or heterocyclic ring having 3 to 16 carbon atoms,
Z¹, Z², Z⁴, Z⁵, Z^{a}, Z^{b}, Z^{c}, Z^{d1}, Z^{d2}, Z^{e1}, and Z^{e2} each independently represent —CH₂O—, —OCH₂—, —CF₂O—, —OCF₂—, —COO—, —OCO—, —CH₂CH₂—, —CF₂CF₂—, —CH═CH—, —CF═CF—, —N═CH—, —CH═N—, —N═N—, —C≡C—, or a single bond,
i, j, a, b, c, d, e, f, g, and h each independently represent an integer of 0 to 4, and
pluralities of A¹s, A²s, A⁴s, A⁵s, A^{a}s, A^{b}s, A^{d1}s, A^{d2}s, A^{e1}s, and A^{e2}s, if present, may be the same or different A¹s, A²s, A⁴s, A⁵s, A^{a}s, A^{b}s, A^{d1}s, A^{d2}s, A^{e1}s, and A^{e2}s, pluralities of Z¹s, Z²s, Z⁴s, Z⁵s, Z^{a}s, Z^{b}s, Z^{c}s, Z^{d1}s, Z^{d2}s, Z^{e1}s, and Z^{e2}s, if present, may be the same or different Z¹s, Z²s, Z⁴s, Z⁵s, Z^{a}s, Z^{b}s, Z^{c}s, Z^{d1}s, Z^{d2}s, Z^{e1}s, and Z^{e2}s, and pluralities of R^{N1}s and R^{N2}s, if present, may be the same or different R^{N1}s and R^{N2}s).

5. The liquid crystal device according to claim 1, wherein the dye-containing liquid crystal composition further contains a haze adjuster.

6. The liquid crystal device according to claim 1, wherein the dye-containing liquid crystal composition contains one or two or more compounds represented by general formula (II) 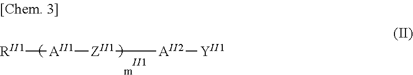
(wherein
R^{II1} represents an alkyl group having 1 to 10 carbon atoms, one or two or more nonadjacent —CH₂—'s in the alkyl group are each independently optionally substituted with —CH═CH—, —O—, —CO—, —COO—, or —OCO—,
A^{II1} and A^{II2} each independently represent a group selected from the group consisting of
(a) a 1,4-cyclohexylene group (in which one —CH₂— or two or more nonadjacent —CH₂—'s are optionally substituted with —O—),
(b) a 1,4-phenylene group (in which one —CH═ or two or more nonadjacent —CH═'s are optionally substituted with —N═), and
(c) a naphthalene-2,6-diyl group, a 1,2,3,4-tetrahydronaphthalene-2,6-diyl group, or a decahydronaphthalene-2,6-diyl group (one —CH═ or two or more nonadjacent —CH═'s present in the naphthalene-2,6-diyl group or the 1,2,3,4-tetrahydronaphthalene-2,6-diyl group are optionally substituted with —N═),
the group (a), the group (b), and the group (c) are each independently optionally substituted with a cyano group, a fluorine atom, or a chlorine atom,
Z^{II1} represents a single bond, —CH₂CH₂—, —(CH₂)₄—, —OCH₂—, —CH₂O—, —COO—, —OCO—, —OCF₂—, —CF₂O—, —CH═N—N═CH—, —CH═CH—, —CF═CF—, or —C≡C—,
Y^{II1} represents a hydrogen atom, a fluorine atom, a chlorine atom, a cyano group, or an alkyl group having 1 to 10 carbon atoms, one or two or more nonadjacent —CH₂—'s in the alkyl group are each independently optionally substituted with —CH═CH—, —O—, —CO—, —COO—, or —OCO—, and one or two or more hydrogen atoms in the alkyl group are optionally substituted with a fluorine atom, and
m^{II1} represents 1, 2, 3, or 4, wherein when m^{II1} represents 2, 3, or 4, a plurality of A^{II1}s and a plurality of Z^{II1}s are optionally same or different).

7. The liquid crystal device according to claim 1, wherein a maximum absorption wavelength of the dichroic dye is 600 nm or more and 750 nm or less.

8. The liquid crystal device according to claim 1, wherein the dye-containing liquid crystal composition contains two or more dichroic dyes.

9. The liquid crystal device according to claim 1, wherein the liquid crystal device is driven by a rectangular wave having a frequency of 30 to 300 Hz.

10. A liquid crystal display apparatus, a light control apparatus, or a light transmitting apparatus comprising the liquid crystal device according to claim 1.
